(19) United States
(12) Patent Application Publication
(10) Pub. No.: US 2003/0061225 A1
(43) Pub. Date: Mar. 27, 2003

(54) Hierarchical hybrid OLAP scenario management system

(76) Inventors: David M. Bowman, Salem, MA (US); Diar Ahmed, Walpole, MA (US); Ryan Fuller, Boston, MA (US); Jason De Veau, Framingham, MA (US); Nicholas DiPasquale, Boston, MA (US)

Correspondence Address: CHARLES G. CALL, 68 HORSE POND ROAD, WEST YARMOUTH, MA, 02673-2516, US

(21) Appl. No.: 10/254,897

(22) Filed: Sep. 25, 2002

Related U.S. Application Data
(60) Provisional application No. 60/324,638, filed on Sep. 25, 2001.

(51) Int. Cl. G06F 7/00

(52) U.S. Cl. 707/100

(57) ABSTRACT

A data storage and analysis system for modeling complex systems and the outcome of decisions and potential alternatives. The system employs a hierarchical hybrid data model with high volumes of data organized in many dimensions, such as models of organization and business operations. A “wizard-based” data loader handles imperfect data and supports multiple servers and data sources. The structures that represent the hierarchical model for the data are defined and created as the backbone for the model using spreadsheets, multiple relational database tables, and other sources of data that may reside on one or more servers. The hierarchical hybrid data model that is built also supports the linking of many different sources of data to the model's hierarchies. Analytics generators called “microCubes™” generate answers to ‘questions’ based on the server model as they are requested. Scenario management tools are provided for creating alternate scenarios linked to hierarchical hybrid data model to provide ‘what if’ analysis.

### CROSS-REFERENCE TO RELATED APPLICATION

This application claims the benefit of the filing date of the copending U.S. Provisional Patent Application Serial No. 60/324,638 filed on Sep. 25, 2001.

### FIELD OF THE INVENTION

This invention relates to electronic data processing systems and more particularly, although in its broader aspects not exclusively, to methods and apparatus for providing enterprise business intelligence, data analysis and data warehousing services.

### BACKGROUND OF THE INVENTION

Existing data warehouse technologies (MOLAP, ROLAP, HOLAP) have technical limitations that significantly limit their ability to construct a complete model of a business, organization or other complex system. These limitations include the use of data models of limited size and scale organized as fixed data structures. As a result, the size, complexity and utility of data and information warehouses have been greatly restricted and the cost of implementation has been high. Because these systems employ a static data model, they are incapable of performing complex ‘what if’ scenario processing.

In addition, very large databases, data warehousing systems and custom solutions frequently cost millions of dollars and require a period of two to three years to build, often resulting in failure due to changing business conditions. Moreover, the capabilities of such systems are often limited to providing departmental rather than the needed enterprise-wide reporting tools. Available Business intelligence solutions are frequently limited to predefined reports, without scenario management, and require an ETL tool for extracting data from multiple data sources. These systems commonly operate on stale, latent, monthly data organized in a fixed, multidimensional data structure and, in order to provide useful results, typically require advanced programming of business objectives

### SUMMARY OF INVENTION

It is an object of the invention to provide a complete model of complex systems capable of modeling the outcome of decisions and potential alternatives at any level before resources are committed, and to do so while reducing the cost and time expended in implementing and maintaining the system.

The preferred embodiment of the present invention takes the form of a data storage and analysis system which employs tools that make it possible to create alternate scenarios linked to an underlying hierarchical hybrid data model in order to provide true enterprise and extranet based scenario management (‘what if’ analysis). The data model maps ‘business and operations’ concepts into a hierarchical object-oriented data model that focuses on the ‘problems’ being solved rather than on the technical details based on the limitations of underlying technology.

The structures that represent the hierarchical data model (e.g. organization structure, product structure, financial reporting structure, customer segments, etc.) are defined and created as the backbone for the model using spreadsheets, relational database tables, and other sources that may reside on one or more servers. The hierarchical hybrid data model imposes no limits on the size and number of dimensions or the complexity of the structures which are implemented in order to provide virtually unlimited scalability. The hierarchical data model built by the system's data model manager also supports the linking of many different sources of data to the model's hierarchies. For example, general ledger data may be associated with chart of accounts information which may in turn be associated with business units, products, customers, etc. The hierarchies can be incrementally built and changed at anytime using a drag and drop interface without the need to delete and reload the model or to perform lengthy consolidations. The model supports multiple scenarios through links to the data model. Any number of alternate models can be supported by replacing portions of the ‘link’ models with alternate assumptions and data. This enables the server to rapidly compare one model alternative to another.

The system further several scenario based management tools, including a strategy view for creating, reviewing and exploring multiple scenarios and designer tools which provide wizards that create and manage and scenario criteria and scenario reporting mechanisms including scoreboards and scorecards. All of these scenario management and reporting tools are available to users using conventional client access devices, such as a PC based Web browser, a personal data assistant (PDA), a mobile device such a cellular phone, or a WAP enabled device.

The strategy view provides a platform for viewing and customizing different projects/initiatives, which are organized by scenario. The strategy view enables users to manage projects/initiatives and scenarios, change the properties of individual scenarios, and view scoreboards using a “Strategy Centre” tool.

The Strategy Centre allows the user to view several different scoreboards simultaneously, including the following types of scoreboards: Indicators & Risks scoreboards which allow the user to analyze a project by its indicator or risk values, Resource Demand scoreboards which display the resource allocation for the projects/initiatives in a scenario, Scorecards which allow the user to view data from the data model in a neat, customizable format., and Strategic Matrices which allow the user to compare different indicators and risks for each project/initiative in a scenario.

These and other features and advantages of the invention may be more clearly understood by considering the following detailed description of a specific embodiment of the invention. In the course of that description, frequent reference will be made to the attached drawings.

### BRIEF DESCRIPTION OF THE DRAWINGS

FIG. 1 is a block diagram illustrating the principle functional components of the preferred embodiment of the invention;

FIG. 2 shows a window displayed to introduce the data loader wizard;

FIG. 3 shows a select script screen displayed by the data loader wizard;

FIG. 4 shows a column matching screen displayed by the data loader wizard;

FIG. 5 shows an attribute customizing screen displayed by the data loader wizard;

FIG. 6 shows a data linking screen displayed by the data loader wizard;

FIG. 7 shows a level definition screen displayed by the data loader wizard;

FIG. 8 shows a level setup screen displayed by the data loader wizard;

FIG. 9 shows a screen for establishing parent—child relationships in system's data model;

FIG. 10 shows a further screen used to define hierarchies in the data model;

FIG. 11 shows a parent—child column screens used to define hierarchies;

FIG. 12 shows a screen for assigning object names in the hierarchy;

FIG. 13 shows a screen for selecting options in the data loader;

FIGS. 14-16 shows screens displayed for controlling data updating;

FIG. 17 shows a screen summarizing a data loading operation;

FIG. 18 shows a screen listing data that failed to match correctly during a linking operation;

FIG. 19 shows a confirmation screen displayed prior to a linking operation;

FIGS. 20-21 show screens for controlling automatic data loading operations;

FIG. 22 shows the screen displayed by a data model explorer tool;

FIG. 23 shows a project assessment screen;

FIGS. 24-25 show tabbed views of an objects properties;

FIG. 26 shows a tabular listings of an objects properties;

FIG. 27 shows a tabular list of an object's children;

FIGS. 28-37 shows screens which are displayed during the creation of a data series template for loading data via a microCube™

FIGS. 38-39 show screen displays of a main report created by the system's analysis workbook;

FIG. 40 shows a screen for controlling the order in which data is displays;

FIG. 41 shows a decomposition properties screen created by the analysis workbook;

FIG. 42 shows a model properties screen created by the analysis workbook;

FIG. 43 shows a influences properties selection screen used by the criterion wizard;

FIGS. 44-45 shows screen for controlling indicators

FIG. 46 shows a flags view screen in the analysis workbook;

FIGS. 47-49 show a search criteria selection screens;

FIG. 50 shows a Baseline Strategy's starting point view in Strategy View;

FIG. 51 shows a project/initiatives properties screen;

FIG. 52 shows a screen for converting ideas into projects/initiatives;

FIG. 53 shows a filtering options selection screen;

FIGS. 54-56 show project assessment screens;

FIG. 57 shows the navigation screen for the project/initiative configuration wizard;

FIGS. 58-59 show screens for defining risks in risk categories;

FIG. 60 shows a project assessment screen displayed by the project configuration wizard;

FIG. 61 shows a screen for defining indicators;

FIG. 62 shows a risk categories selection screen;

FIG. 63 shows a screen for entering resources;

FIG. 64 shows a scorecard view;

FIG. 65 shows a scorecard designer screen;

FIG. 66 shows a group of scoreboard charts displayed by the Strategy Centre reflecting the state of the current project/initiative portfolio (state of a scenario);

FIG. 67 shows a display control screen for the Strategy Centre; and

FIGS. 68-74 show screens for controlling different scoreboards displayed by the Strategy Centre.

### DETAILED DESCRIPTION

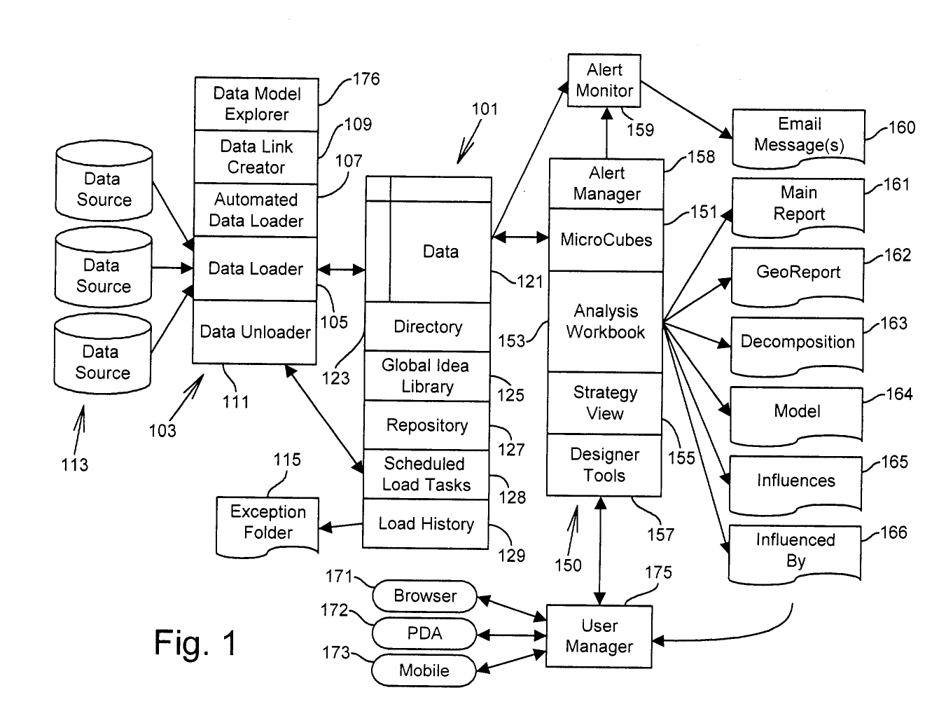

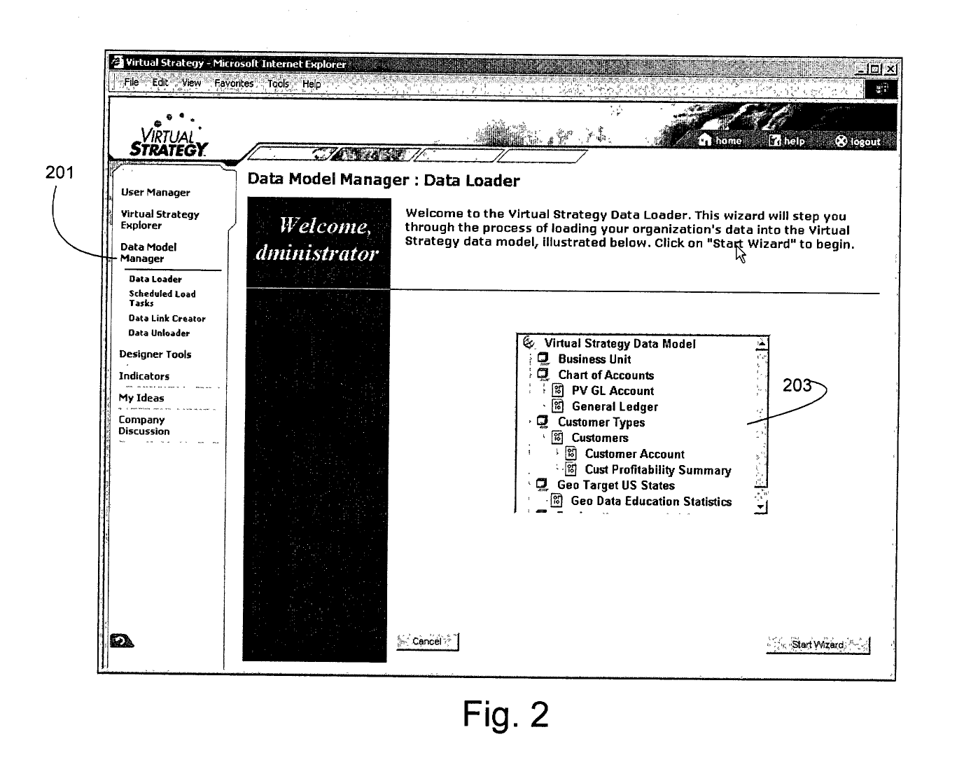

The architecture of the preferred embodiment of the invention is illustrated in FIG. 1. The invention provides a unique environment for building complex business, operations and other models using large amounts of data from multiple sources and a user's ordinary understanding of how the system is constructed. The server takes the unique approach of mapping ‘business and operations’ concepts into a hierarchical object oriented data model indicated generally at 101 that focuses on the ‘problems’ being solved rather than on the technical details based on the limitations of underlying technology.

The data model 101 is created, maintained and managed using a data model manager indicated generally at 103. The data model manager contains four different tools for administering the data that resides inside of the data model: a wizard-based data loader 105, an automated data load manager 107, a data link creator 109, and a data unloader 111.

The wizard-based data loader 105 is a tool that permits ordinary business or domain experts to create templates that load data from existing sources of data indicated generally at 113 that are both internal and external to an organization. The data loading wizards have three fundamental capabilities: the creation of structural hierarchies, the loading of information into those hierarchies, and the linking of data across hierarchies. The primary purpose of the data loader 105 is to capture data in its native form and to create the powerful scenario management enabled data model 101. As part of this process the data loader 105 verifies the validity of critical data that links members of the data to the structure defined for the data model 101.

The data model 101 comprises of information loaded by the user's organization as well as system information. The data model organizes this information into six important folders: a data folder 121, a directory folder 123, a global idea library folder 125, a repository folder 127, a scheduled load tasks folder 128 and a load history folder 129.

Any data loaded into the data model will be loaded into the data folder 121. Individual hierarchies appear as children of the data folder. Any flat data tables are loaded into those hierarchies.

The directory folder 123 stores information describing the users of the system. Each user has folders that pertain to their activity as a user of the system. For example, their projects would appear in the “My Scenario Projects” folder.

The global idea library 125 contains all project ideas submitted by users of the system.

The repository folder 127 includes all of the system information. Although users may access this information, it is recommended that they not make any manual changes to the system-maintained information in the repository folder since careless changes may corrupt the whole system.

The scheduled load tasks folder 128 contains task information about scheduled data loads carried out by the automated data loader 111. Data loads can be scheduled to take place at specific times.

When data is loaded into the data model 101, a record of that load is maintained in the load history folder 129. These objects have exception folders 115 associated with them that include any objects loaded during the session that could not be linked into the hierarchy established for the data at 121. Importantly, data need not be ‘perfect’ to be captured and used. Data that does not perfectly match predetermined criteria is placed in an exception folder seen at 115 (a folder within the load history folder 129) with appropriate missing data created so that it can be reviewed by the owner of the data. For example, if employee data is loaded into a business unit structure and some of the employee data contains codes for business units that do not exist in the “Unresolved Data Errors” folder, a business unit is created called “Unknown Business Unit xxxx” with the appropriate employee data linked to the business unit object. This means that the all data is actually loaded and the user can then call up the Unknown Business Unit, change its name, drag and drop it to where it belongs in the structure or simply delete it. This method preserves the ability to load data in near real-time, in contrast to existing systems in which all data errors must be resolved before the data can be successfully loaded. This data loading mechanism enables the user to obtain value from imperfect data and to make the associations that make sense based on the imperfect data.

The structures that represent the hierarchical model for the data 121 (e.g. organization structure, product structure, financial reporting structure, customer segments, etc.) are defined and created as the backbone for the model using spreadsheets and other sources a data depicted generally at 113. There are no limits to the size and number of dimensions or the complexity of the structures which are implemented efficiently using data sources 113 such as multiple relational database tables that may reside on one or more servers in order to provide virtually unlimited scalability.

The hierarchical data model built by the data model manager 103 also supports the linking of many different sources of data to the model's hierarchies. For example, general ledger data may be associated with chart of accounts information which may in turn be associated with business units, products, customers, etc. The model is unique in that hierarchies can be incrementally built and changed at anytime using a drag and drop interface without the need to delete and reload the model or to perform lengthy consolidations. The model supports multiple scenarios through a sophisticated set of ‘links’ to the existing model. Any number of alternate models can be supported by replacing portions of the ‘link’ models with alternate assumptions and data. This enables the server to rapidly compare one model alternative to another. Typically the assessment of the impact of one scenario vs. another can occur within a few seconds.

The hierarchal object oriented relational data model employed by the invention makes it possible to load data rapidly and incrementally whereas other technologies require that models be predefined and static, expending significant amounts of disk space and processing power and leading to significant delays in implementation.

The data model constructed and maintained by the data model manager 103 is utilized by a group of analytics generators indicated generally at 150 in FIG. 1 including microCubes™ 151, analysis workbook 153, strategy view 155, and designer tools 157.

An alert manager 158, which operates as a component of the analysis workbook 151, is used to define conditions which, if satisfied, should be brought to the attention of one or more users. The alert manager 158 is used to specify the conditions which are then monitored by the alert monitor 159 and, if the condition is satisfied, the alert monitor transmits an email or other message, and sets a visual flag in the main report 161 to the user(s) to be notified.

In contrast to existing data analysis technologies that focus on building multidimensional arrays or consolidation tables that can answer every theoretical question that users might ask given a static set of information, the preferred embodiment of the present invention employs analytics generators called “microCubes™” that generate only the answers to questions that are actually asked. The microCubes™, seen at 151 in FIG. 1, are built incrementally based on use and are updated automatically as relevant data comes into the system using an object pointer structure linking them to one or more scenarios stored in the repository 127. This permits the system to provide support for multiple scenarios and personalized ‘what if’ capabilities.

The analysis workbook 153 encapsulates different ways of viewing configured reports in the data model. Each report is customizable and may be constantly updated using the microCubes™ 151. The analysis workbook 153 provides the following six views, each of which is described in more detail later.

1. Main Report 161

2. GeoReport 162

3. Decomposition 163

4. Model 164

5. Influences 165

7. Influenced By 166.

The preferred embodiment of the invention further supports several scenario based management tools, including the designer tools 157 which provide wizards that create and manage program books, scorecards and scenario criteria; as well as the strategy view tool 155 for creating, reviewing and exploring multiple scenarios. These scenario management tools simplify the creation of multiple scenarios and personalized flexible views to the shared data model so that different alternatives can be readily examined.

All of these analysis tools and reports are available to users using conventional client access devices, such as a PC based Web browser seen at 171, a personal data assistant (PDA) seen at 172, a mobile device such a cellular phone or a WAP enabled device seen at 173. A User Manager seen at 175 controls user access to the system and is an administrative tool allows the system administrator to designate what functions a user in a group may access.

The individual components of a preferred embodiment of the invention are described in detail below. This description is organized into separate sections, each of which is devoted to the operation of a portion of the overall system. For ease of reference, these descriptive sections are presented in alphabetical order.

In the course of this description, reference will be made to numerous screen display views which are presented as separate drawing figures and which show the manner in which information is displayed and accepted using a standard Web browser interface. These page displays typically employ a tabbed-notebook metaphor in which major functions are displayed and may be selected in a menu listing at the left of the notebook, and for any given function, different views may be selected by clicking on one of the horizontal notebook tabs which appear over the content viewing window.

Data Model Manager 103

The data model manager indicated generally at 103 contains four different tools for administering the data that resides inside of the data model: the data loader 105, the automated data load manager 107, the data link creator 109 and the data unloader 111. A user may not have access to all of these components concurrently because an administrator can decide who is allowed to use these components using the user manager 175.

Data Loader 105

The user organization's data can be loaded into the data model 101 using the data loader 105, a wizard in the data model manager 103 that will guide the user through the necessary steps for each load. It handles the loading of data as well as hierarchies. The steps that are involved in loading data into the data model include:

1) Define Parameters

2) Collect Source Info

3) Linking

4) Display Options

5) Prepare Data

6) Load Data

7) Summary

Hierarchy loading and Hierarchy updating includes the following steps:

1) Define Parameters

2) Collect Source Info

3) Define Hierarchy

4) Display Options

5) Load Hierarchy

6) Summary

Some of these steps are similar. For example, defining the parameters and collecting the source info is the same for all three processes. However, there are also some major differences between the three types of loading. In the discussion that follows, the three types of data loading are treated separately since the differences are important and need to be stressed. Since the start and end is similar for the three, however, they will be grouped together.

Initialization. The data loader is opened by selecting “Data Model Manager” and “Data Loader” respectively from the menu list seen at 201. A Welcome frame indicated generally at 203 shows the current status of the data model 101. Anything that has been loaded in will be displayed. Hierarchies appear as children of the root “Virtual Strategy Data model” and loaded data appear as children of the hierarchies they are loaded into. Clicking on Start Wizard at 204 begins the user through the process of loading data into the data model.

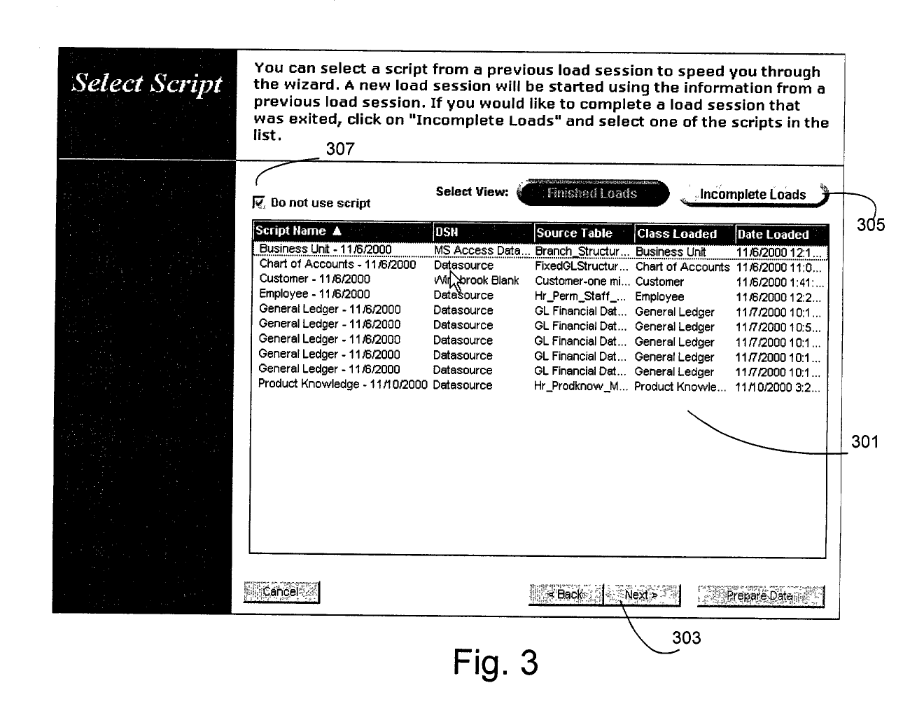

Select a Script. If the user has already loaded data into the data model, the user can use the script from a previous load session to fill in the steps in the wizard. To select a script, the either double-clicks on one of the scripts listed by name at 301 on the Select a Script screen seen in FIG. 3, or select one of the listed scripts and clicks Next at 303. If there are load sessions that were canceled out of or erroneously exited, they can be resumed here by clicking on the Incomplete Loads button at 305 and selecting a script. If the user does not want to use a script, the user can click on the check box 307 next to “Do not use script.” The user can sort the scripts by the different columns by clicking on the column header.

Loading Options. The data loader handles the loading of new hierarchies, loading flat data, and updating existing hierarchies. The user needs to tell the data loader what kind of data the user plans on loading. If nothing has been loaded into the system, the user will only be given the option of loading a new hierarchy. Flat data can be loaded and linked to other flat data, but at least one hierarchy has to be loaded because flat data cannot reside by itself in the data model. Note: “flat data” refers to any set of data that has no hierarchal relationship defined within it. The data loader presents a dialog box (not shown) that requests the user to select between creating a new hierarchy, loading data into the data model, or updating and existing hierarchy.

Choose the Data Source. The data loader relies on properly configured ODBC data sources. The user is accordingly next presented with a dialog box (not shown) which includes drop down list boxes that enable the user to specify an OBDC data source by data set name (DSN) and, within that data source, a particular data table. The drop down list boxes automatically list each DSN configured on the user system and the table(s) associated with it. The table within the DSN that the user selects table is hereinafter referred to as “the source table.”

If the user is loading data, the user will next be requested to specify the period information before moving onto “Import to Class.”

Import to Class. The user can either load data into an existing class in the data model or create a new one. A dialog box (not shown) includes a check box that allows the user to specify when a new class is being created in which case the user specifies a name for the new class; otherwise a drop down list box presents a list of existing classes from which the user selects the class into which the data is to be loaded. If the user try to create a class name that already exists in the system, the user will be given an error message from the data loader and forced to change the name before continuing. The same applies if the user selects a name that exists as an internal system table.

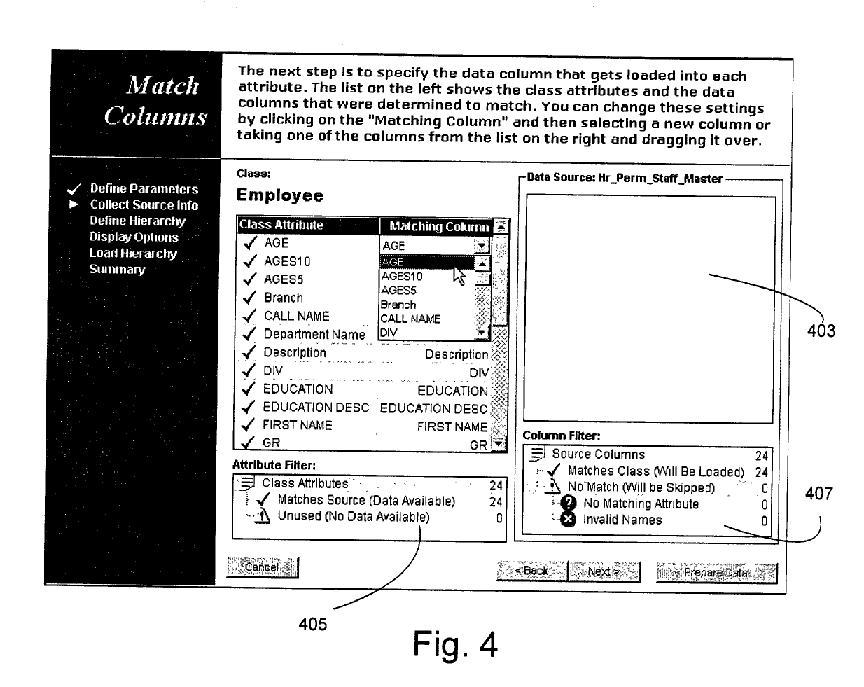

Loading to an Existing Class. When loading into an existing class, it is necessary to match the columns from the source table with the attributes of the existing class. The data loader wizard thus presents the user with “Match Columns” listing of the attributes of the selected class and, for each attribute, a drop down list box from which a corresponding column of the selected source table can be selected, as seen in FIG. 4. When the attribute name matches the column name, that column name is automatically selected as the default. The user can select a column name for any listed attribute. If the user selects a column name that has been assigned to another attribute, the other attribute will be assigned “(None),” meaning it has no match.

Alternatively, the user man select a column name from a displayed list of columns in the source table as seen at 403 and drag it to the attribute list. The drag-and-drop selection will be handled as if it were selected from the drop down list.

An “Attribute Filter” seen at 405 tells the user how many attributes exist in the class and then breaks down how many currently have a match and how many do not have a match. A “Column Filter” 407 has the same purpose. It has a more extensive list because a column may not match with an attribute for two reasons. The obvious reason is summed in “No Matching Attribute.” This simply means that the name of the column does not match an attribute in the existing class or that it has not been matched to an attribute. The other reason involves the source column having a name that matches a system column. This makes the name invalid. Therefore, it has to be manually assigned to an attribute in the class. “No Match” is simply a sum of these two.

The user will notice that the icon next to each item in the filters matches with the items in the list above it. The user can change the view in the list by clicking on one of the items in the filter. For example, if the user wanted to just see the “Unused” attributes, then click on “Unused” in the filter. Note: When an item no longer fits a selected filter, it will not be displayed there anymore. For example, if the user is viewing “Unused” attributes and assign a column to it, the attribute will disappear from the list. It will then appear if the user clicks “Matches Source” in the filter. By default, the attribute list displays “Class Attributes” and source list displays “No Match.”

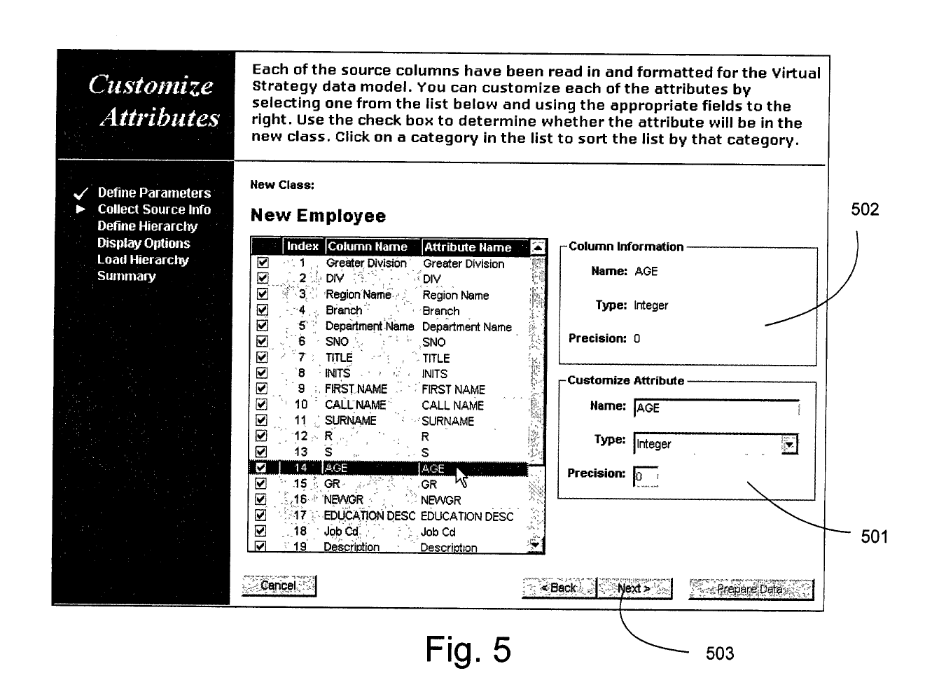

Creating a New Class. Creating a new class involves two steps: defining the attributes and checking the class, as it will be defined upon creation. When a new class is to be created, the data loader wizard displays the “Customize Attributes” screen seen in FIG. 5. First, each of the source columns is read and formatted for the data model. The user can arrange the user columns according to “Index,” “Column Name,” or “Attribute Name” by clicking on any of these headings. For this example seen in FIG. 5, the columns are arranged according to the Index.

The user can customize each of the attributes by selecting it and making changes in the area 501 that appears on the right titled “Customize Attribute.” The user can change the name, data type, and precision of each attribute. The user will not be allowed to assign a name to a column that matches that of a system column. In the case that this happens, the attribute name will have the word “Source” added to the beginning of the name the user enter. The precision cannot be adjusted for data types where it does not make sense. For example, if the user designates an attribute as an integer, its precision will be set to zero and can't be changed.

Above the “Customize Attribute” area, the user will see another area at 502 called “Column Information.” This non-editable area tells the user how the Data loader originally recognized the data.

The check box to the left of each attribute lets the user customize which of the source columns will be placed into the new class. If the user unchecks one of the boxes it will not be added as an attribute into the new class.

Once the user has finished customizing the source table for the new class, the user clicks Next at 503 to see a listing (not shown) of the attributes of the class as it will be created in the data model. If the user needs to make any changes, the user can click on a Back button to go to return to the screen shown in FIG. 5. If the user confirms the accuracy of the listed class structure, the new class will be created when the data is loaded.

Loading Data into the Data model. If the user selects the option to load data into the data model, the system will load a flat data table. Flat tables can include, for example, the user organization's financial data, employee lists, or customer information. In order to perform accurate analysis on data loaded into the system, it is necessary to associate a time period to the data. This involves setting a period type and designating the time the period begins. The data loading wizard presents a date period specification dialog box that allows the user to enter the type of time period (year, month or day), and a calendar that is used to specify the start date of the period type selected. This step will appear in the wizard after the user has set the data source. It will not appear for hierarchal loads, since time is not applicable in those instances. The user will only be able to set the date applicable to the period type. For example, if the user selects “Month” for the period type, then the user can only select the year and month for everything else will be defaulted to the first of the month. The Data loader only handles one period type per load.

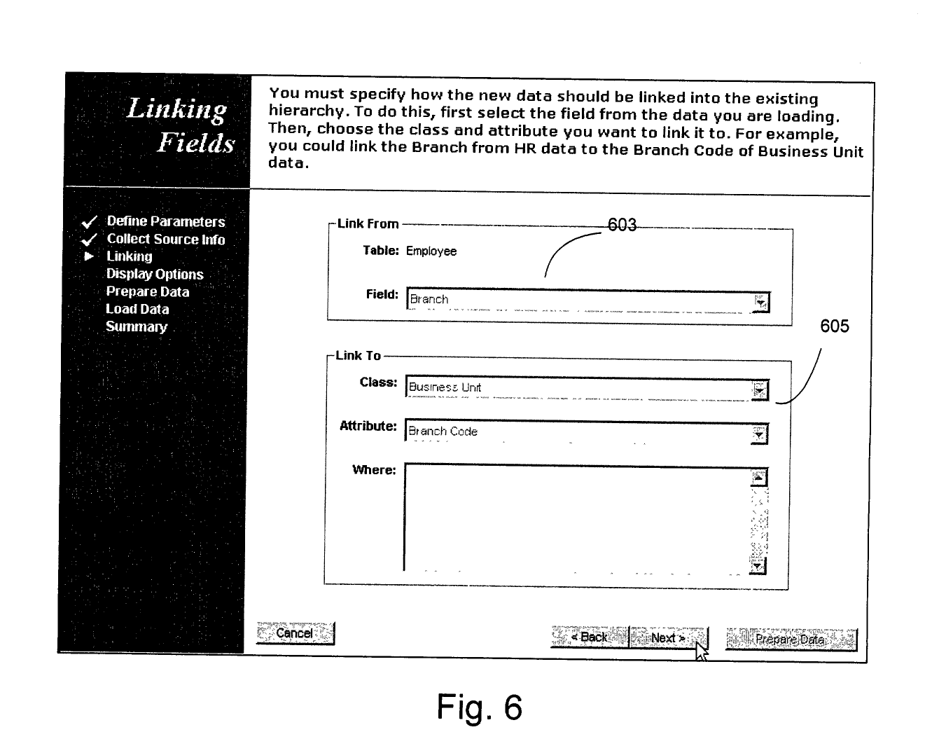

Linking. When a flat table is loaded into the data model, it has to be converted to objects and linked to another object in the system. This table can either be a hierarchy or another flat table. Linking is very important for generating reports and using other features provided by the system, and is accomplished using the “Linking Fields” wizard screen seen in FIG. 6. If the user is loading a new class into the system, the user will have to specify which attribute from the new class is linked to an attribute of another class. The drop down list 603 next to “Field” displays the attributes from the class, as it will be created. Under “Link To” at 605, the user select the class and its attribute that the user desires to link to from the drop down lists. For example, if the user were loading employees into the system, the user would want to link their “Branch Code” with the “Branch Code” in the “Business Unit” class. This tells the data loader where to load the employees into the system. Each employee will be loaded as a child of the “Business Unit” they work for.

The “Where” text field in the “Link to” area 605 is used to specify conditions for linking. For example, if the user only wanted to load Employees for a specific “Business Unit,” the user could specify the “Branch Code” here. The user would write something to the affect of “[Branch Code]=‘100’.” These entries may be made in a format compliant with the SQL database language.

Folder Options. Data objects can be loaded into a folder if the user enables that option. For example, if the user loads Employees into “Business Units,” the user can create Employee folders into the Branch hierarchy where the objects are loaded. This is simply a housekeeping issue that keeps the information neat. If the user wishes to load the data into a folder, a checkbox on a “Folder Options” dialog box (not shown) is displayed next to the label “Place data objects into folder.” If the box is checked, the user will be expected to enter a name for the folder. By default, the name of the source table is displayed as a potential name for the folders. If the user tries to leave the folder name field blank, the data loader will assume the user does not want to create a folder, and message will be displayed asking the user to either enter a name or not create folders. A further check box on the Folders Options dialog box controls how folders are created. The user checks this box if the data loader should not check for existing folders and instead always create them. Folders will be created when needed by the data loader and, since it does not look for the folder, data loading is much faster.

Loading New Hierarchies into the Data model. If the user decided to load a hierarchy into the data model, the user will be brought to this step after the user has either matched the source columns to an existing class or defined a new class. The user organization stores its hierarchal information in one of two ways: defined levels and parent-child. A dialog box (not shown) is thus presented to the user requesting the designation that (A) each level is identified in a different column in the source data (defined levels), or (B) the user hierarchal source data has a parent column and a child column (parent-child relationship).

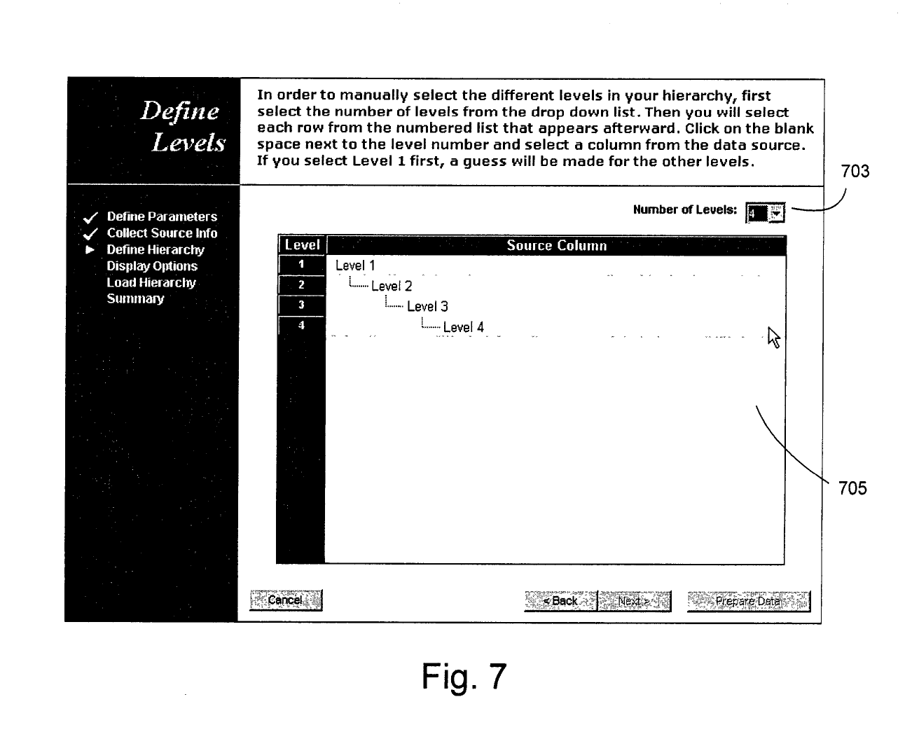

Defined Level Hierarchies. If the user organization uses different columns in the source data to identify each level in the hierarchy, the user will need to specify which columns respond to which levels and does this using the “Define Levels” screen seen in FIG. 7. Before the user can select the levels, the user need to specify how many levels there are in the hierarchy from the drop down list at 703. The list below at 705 will immediately show the number of levels in a hierarchal display with each level numbered. For example, if the user select four levels, the user will see four indented rows in the list, labeled “Level 1,” “Level 2,” etc.

The user needs to manually select the levels. When the user clicks on “Level 1,” a drop down list will appear with the names of the source columns and the user selects the column that applies to the first level. When the user does this, the data loader will make a guess at what the remaining levels. The user can edit the guess by selecting each level and choosing an item from the drop down list. A selection in a specific level will not appear as an option in the levels below it. For example, the user selection for “Level 1” does not appear in any of the other levels. However, the selection for “Level 2” does appear in the list for “Level 1.” Selecting a column that is currently used in a lower level sets that level where it was used back to the default of “Level” and the level number. To avoid confusion, if the user organization uses the values “Level 1,” etc. in its source columns, column values are bolded in the tree.

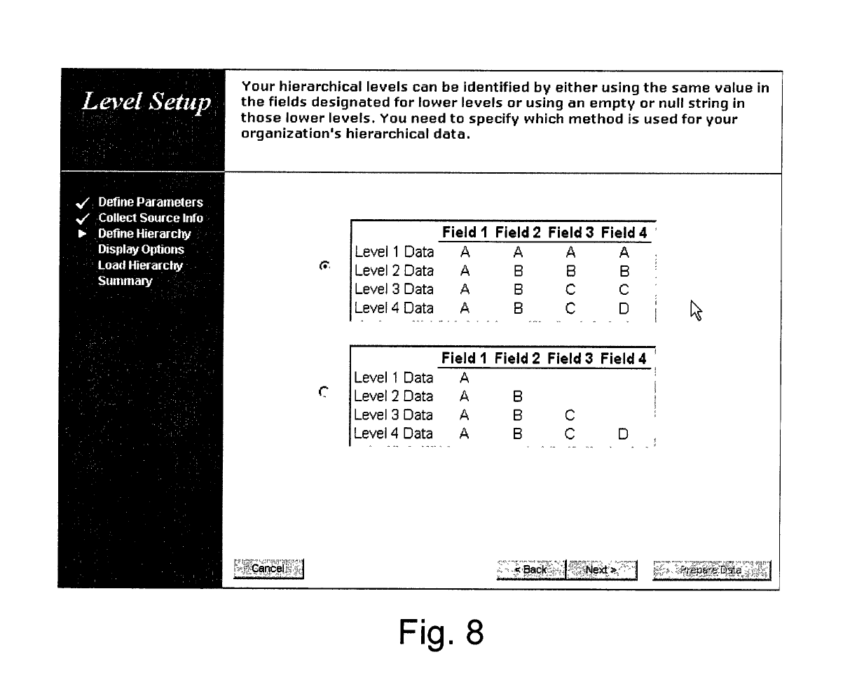

Once the user has defined the individual levels, the user will need to identify the level setup using the “Level Setup” screen seen in FIG. 8. The user's hierarchical value can be identified by either using the same value in the fields designated for lower levels or by using an empty or null string in these lower levels as shown by the two displayed examples in FIG. 8. It is recommended that the user look at the data in the data source before deciding which option to pick using FIG. 8.

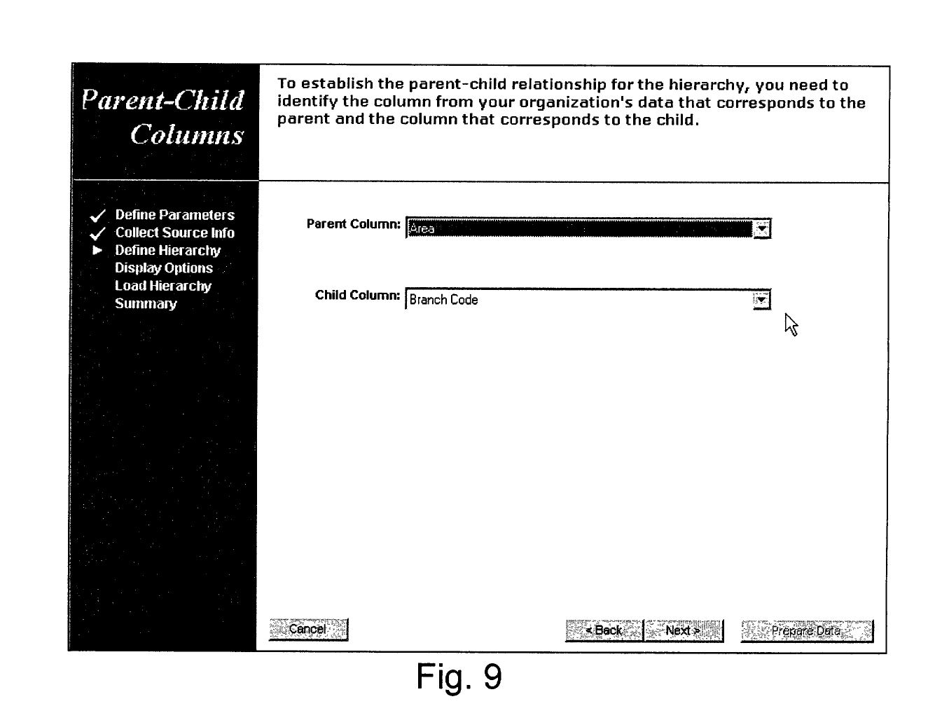

Parent-Child Hierarchies. If the user's organization uses a parent-child hierarchy structure, the user will need to identify which column in the source data contains the parent information, and which column contains the child information, using the “Parent-Child Columns” screen shown in FIG. 9. Note: The child column must contain all unique values or the data loader will be unable to load the hierarchy.

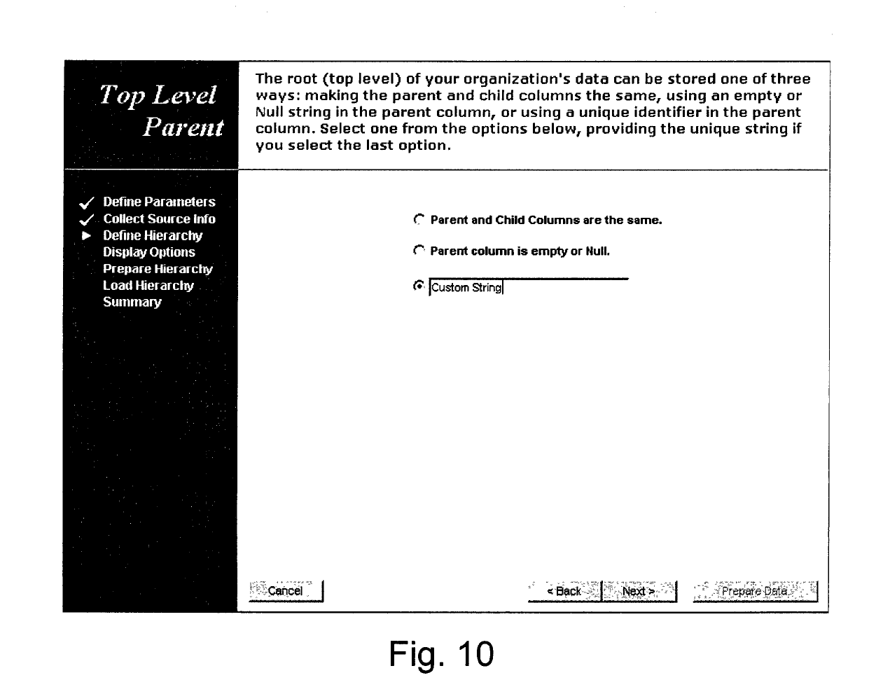

Once the user identified the parent and child columns, the user need to tell the Data loader what the top level looks like using the “37 Top Level Parent” screen, FIG. 10. The top level (root) of the user organization's data can be stored one of three ways: making the parent and child column the same, using an empty or null string in the parent column, or using unique identifier in the parent column. A text field input box is positioned next to the last option so that the user can enter the unique identifier.

Hierarchies are loaded into a folder as a child of the Data folder in the Virtual Strategy data model. The name will be made to match the name of the hierarchy the user are creating, and cannot be edited. Just click Next to continue.

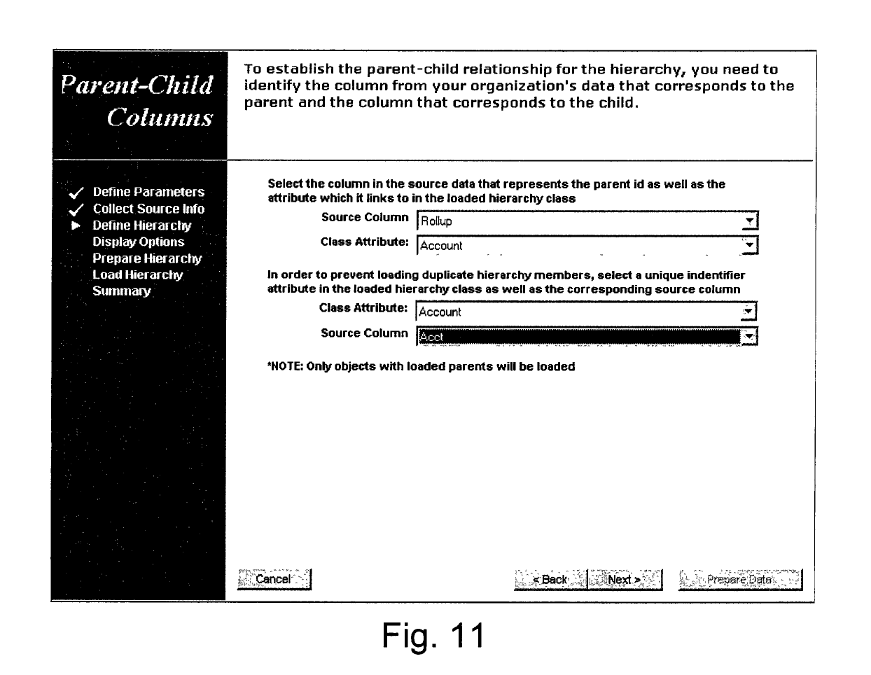

Updating an Existing Hierarchy. If the user decided to update an existing hierarchy, the user will be brought to this step after the user has matched the source columns. The user organization stores its hierarchal information in one of two ways: defined levels and parent-child. However, in order to update an existing hierarchy, the user must have the source data defined as a parent-child relationship, and will need to specify the column that identifies the parent and the column that identifies the child. The user will also need to identify the corresponding attributes in the loaded hierarchy class. This is accomplished using the “Parent-Child Columns” screen seen in FIG. 11 which requires the user to enter, in order:

1. The name of the source column that contains the id of the parent hierarchy object.

2. The attribute name in the hierarchy class that the previously described source column links to.

3. The attribute name in the hierarchy class that acts as a unique identifier for each hierarchy object.

4. The corresponding source column that acts as a unique identifier for each source record.

The data loader will not load hierarchy members that are already present in the hierarchy. Also, only source records that have a valid parent in the existing hierarchy will be loaded.

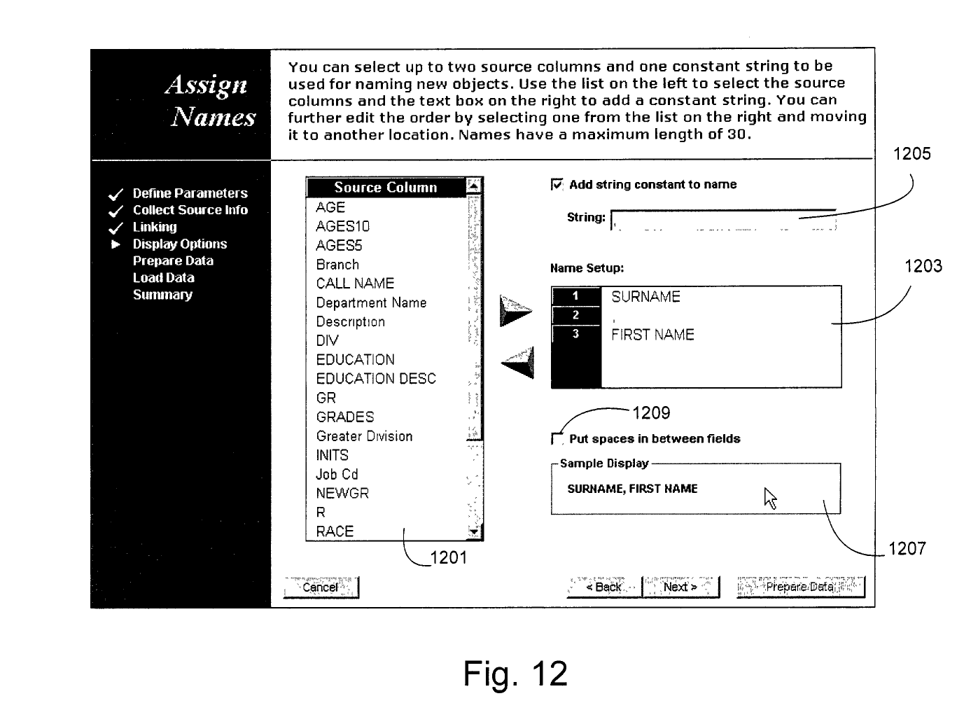

Preparation and Loading. There is one last step before the data can be prepared and loaded into the system. The user needs to specify how the objects will be named in the data model, a function performed using the “Assign Names” screen FIG. 12. The user can select up to two source columns and one constant string to be used for the naming of new objects. Use the “Source Column” list on the left at 1201 to select any source columns for the naming of objects. Either click on a column and then the right arrow to add it to the “Name Setup” list 1203 or drag a column over to the list manually. If the user would like to add a constant string in the name, check off “Add string constant to names” and enter a string in the text field at 1205. The user can further change the order by selecting an item on the name setup list 1203 and dragging it to a different location. As the user changes the name setup, the user will notice that the “Sample Display” at 1207 is updated to match the current setup. By default spaces are added in between the fields. To remove them, uncheck the box at 1209 next to “Put spaces in between fields.”

An example that will tie this all together is loading employees. If there is a column in the source data with the last name and one with the first name, the user would add those. The user would then add the string constant “,” (enter a space after the comma). Adjust the order so that it goes last name, string constant, and then first name. The user would then uncheck the box to put spaces in between the fields. In the end the user would get names for the employees like “Doe, John.”

Prepare Data. Before hierarchal data or flat data can be loaded into the system, it has to be prepared for the data model.

In all three instances, the data is tested for validity. In the case of a new hierarchy, the data loader checks the levels to make sure that each new object fits into the hierarchy properly. For flat data, the linking information is analyzed for each object to see how many objects can be properly loaded into the system, whether it is a hierarchy or another flat table.

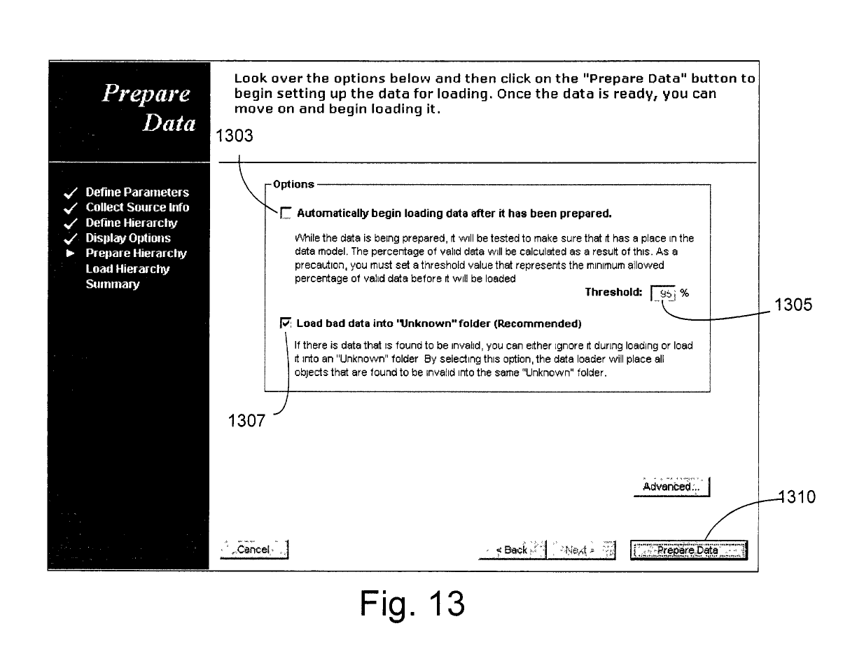

The data loader calculates a percentage of valid data as it prepares the data. The first option seen at 1303 in FIG. 13 if selected lets the user set a threshold to allow the data to automatically begin loading after it has been prepared. Check the option and set a threshold percentage at 1305.

If the percentage of valid data lies above the threshold, the data will automatically begin loading. If it fails to meet the threshold value, a message will be displayed on the screen telling the user that the threshold was not met and the data will not be loaded automatically.

When the data is loaded into the system, the user can either skip the data that was found to be invalid or the user can load it into an “Unknown” exception folder. This folder is shown at 115 in FIG. 1 and is a child of the Load History objects 129 pertaining to the current data loading session. By checking the second option at 1307, “Load bad data into ‘Unknown’ folder,” the user elects not to ignore the data.

After the user click Prepare Data at 1310, a progress frame (not shown) is displayed while the data is being prepared. The user can cancel out of the preparation when the frame is visible. The progress frame allows the user to see the job currently being handled, the amount of time that has elapsed in the preparation and the amount of time that is remaining, the records being prepared per second, and a status bar.

If the user is not automatically loading the data or if the percentage of valid data fails to meet the threshold, the data loader will display the status of the data after it has been prepared. It tells the user if the data is ready for loading and what percentage of the data is valid. If there is an error in the way the data has been defined, the user will see an error message saying, “The data cannot be loaded.” The user will need to go back and correct the errors before the data can be loaded into the system. This only happens when zero percent of the data is found to be valid. After loading is completed, the user may create advanced updates on the data.

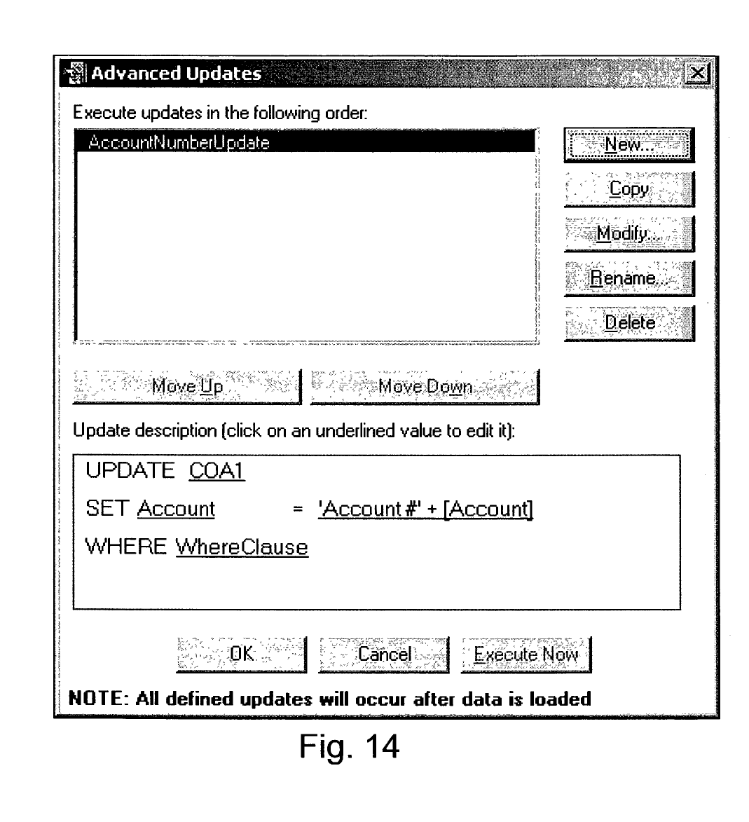

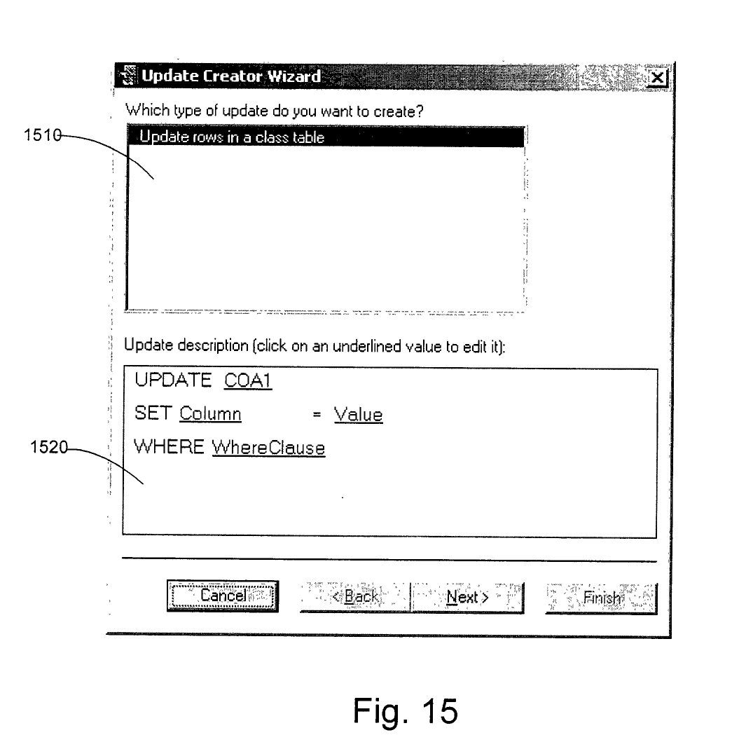

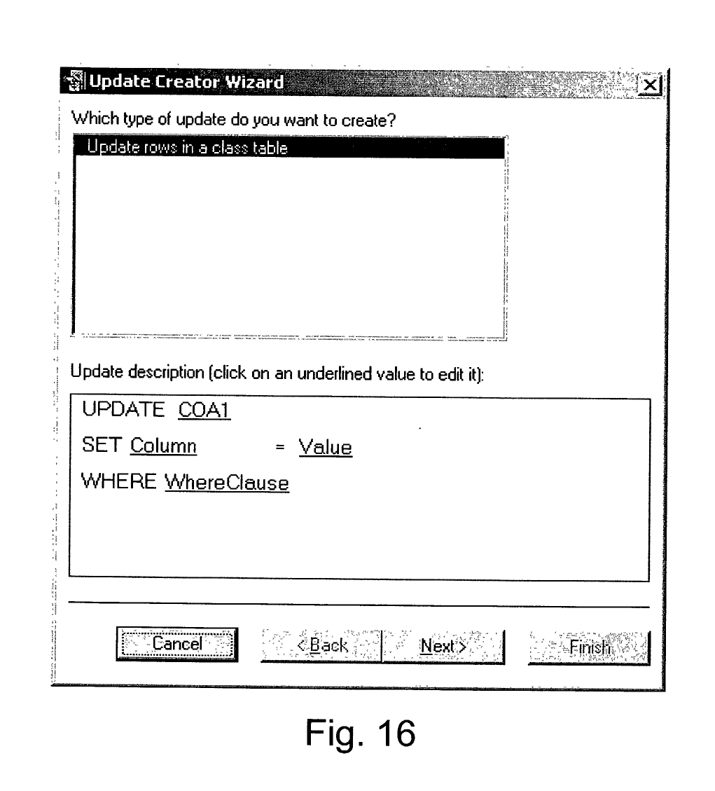

Advanced Updates. The Advanced Updates interface seen at FIG. 14 allows the user to define custom SQL statements that will be executed immediately after the load completes. All customizable fields in the SQL Update statement are underlined. To edit any of these fields, simply click on it and a window will pop up allowing the user to enter the new value. To add a new update or modify an existing update, the user clicks the New or Modify button and Update Creator Wizard shown in FIG. 15 will pop up. Using the Creator Wizard, the user selects the type of update that the user wants to create at 1510, and then edits any of the customizable fields in the SQL statement at 1520 by simply clicking on it and a window will pop up allowing the user to enter the new value. Note: In order for the update(s) to execute properly, all standard SQL delimiters must be used (i.e. the Value field must contain a new value within single quotes if it is a string field). Finally, the user must enter a name for the update as shown at 1620 in FIG. 16 and click Finish.

Load Data. The user will be prompted to load the data once the user has finished the setup process for the virtual strategy data loader. As the data is being loaded, a progress display screen (not shown) shows the status of the loading operation. While the data is being loaded, the user will notice a counter for the “Number of Errors Inserting.” This occurs whenever there is an error writing a record to the database. In the case of an error, the SQL statement that caused the error is written to a text file called “Data Loading Error Log. If the user decides in the middle of data loading a flat data file that the user would like to cancel, the user will be given the option to continue or to end loading all together. If the user decides to end the data load process by clicking Yes, the user will be then given the option to save what has been loaded or undo what has been loaded. If the user decides to save what has been loaded so far, select the option. The user will be able to go back and finish the data load session at a later time. The user can also delete everything that has been loaded in the current session by selecting the other option. All the new objects will be deleted and the loading session will be removed from memory.

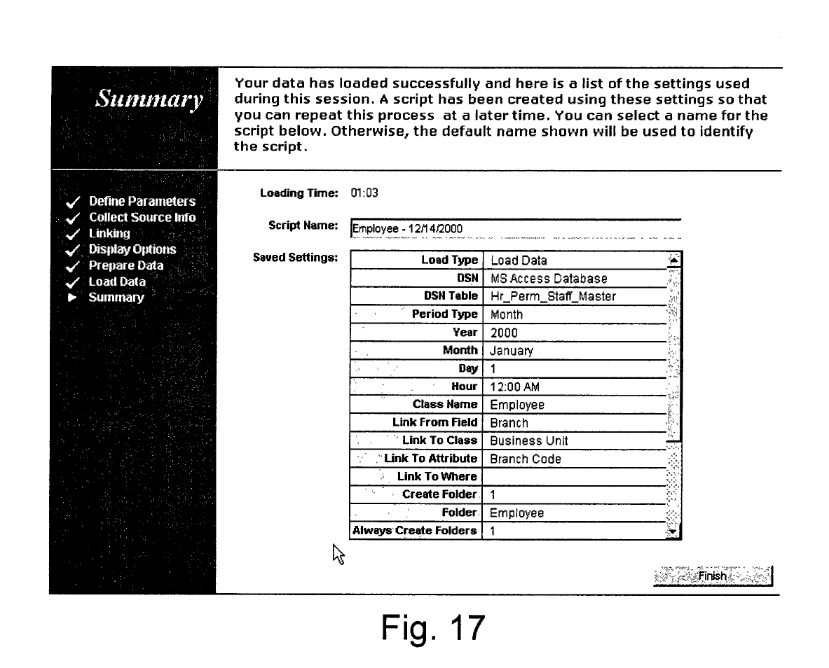

Summary. After the data has been successfully loaded into the data model the user will be shown the summary screen seen in FIG. 17. The summary displays a list of settings used during the session. A script is created using these settings so that the user can repeat this process at a later date. To assign a custom name to the script, enter a name in the text field next to “Script Name.” Otherwise a default name is assigned consisting of class name and the date of the load. The user then clicks Finish to exit the data loader.

Data Link Creator 109

In order to optimize the model and make the report creation process easier, the user needs to explicitly define relationships between different types of data that the user loaded into the system. In other words, the user needs to link the two different types of data. The data link creator seen at 109 in FIG. 1 is a tool for creating data relationships.

The data link creator 109 is a wizard in the data model manager 103. The steps that are involved in linking data are:

1) Data Table Selection

2) Parent Table Selection

3) Linked Data Selection

4) Confirmation

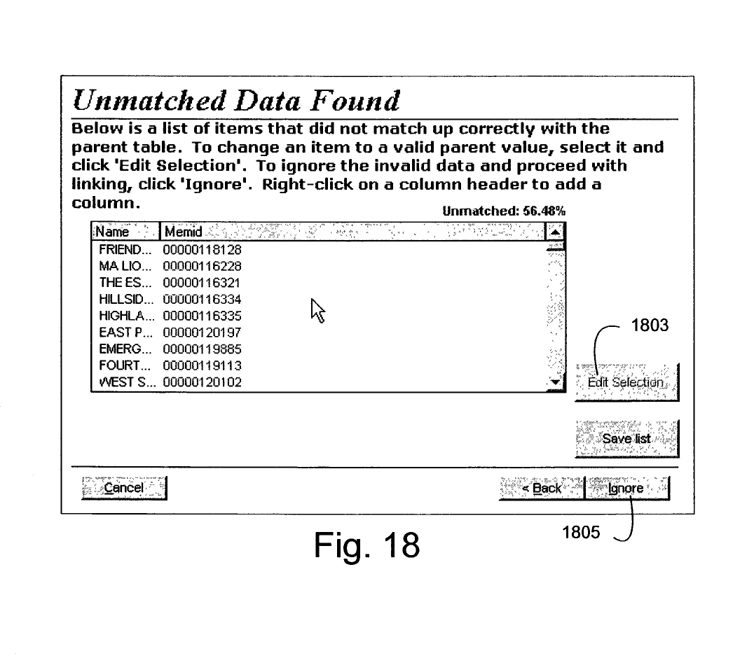

Data Table Selection. The user need to first determine what is to be linked. The first part of this involves selecting the data (child) table to be used in the linking. After selecting the table to perform the linking on, the user will have to select what the user would like to link it to. The data link creator wizard displays a list of classes the selected child table data is already linked to. Data can be linked to either a hierarchy class or another data class. Third, the user makes selects the attributes in each of the tables to use as the linked data as shown in FIG. 18. For example, if the “Customer” table was selected as the child, and the customers will usually pertain to a certain business or branch, so both a “Customer” table and “Business Unit” table would have something like a “Branch Code.”

When the user clicks Next on the Linked Data Selection screen seen in FIG. 18, the suggested link will be checked for validity. It is important that the link make sense since erroneous links will harm the data inside the data model. The proposed link is analyzed by making sure that the selected fields pertain to the same attribute. Once the data has been analyzed, the user will be able to see the percentage of data that was unmatched. A list will be displayed with the items from the data table that do not have a match in the parent table. The list displays the name of the item from the table and the proposed link value that did not correspond to any of the values in the parent table. The user can manually match the data by selecting an item from the list and clicking the Edit Selection button at 1803. Either a list of potential matches will be displayed or a search wizard will appear to help narrow the search. The search wizard is used when the user is linking to another data table. Once the user wishes to proceed with the linking, the Ignore button at 1805. Usually, if there is a lot of unmatched data, the user should go back and reconsider the link. It is recommended that the user rectify any unmatched links before continuing with linking. This provides for more accurate data in the user reports.

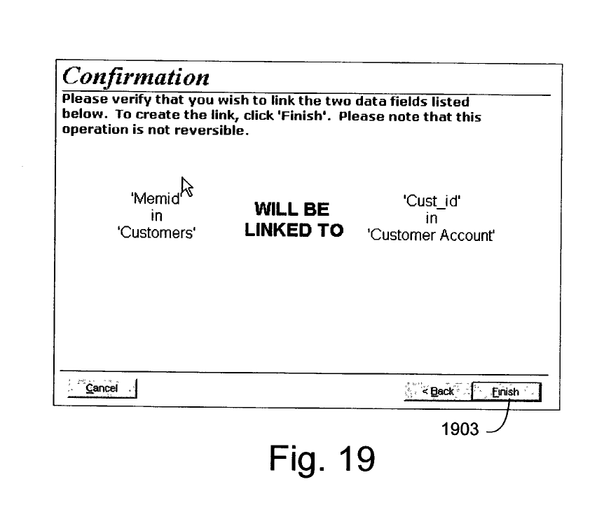

Once the user has completed the steps presented by the data link creator wizard, a final “Confirmation” screen seen in FIG. 19 is presented to show what will be linked. To process the linking, the user presses the Finish button 1903. Since these changes are irreversible, the user has the option to cancel or modify the linking criteria.

Automated Data Loader 107

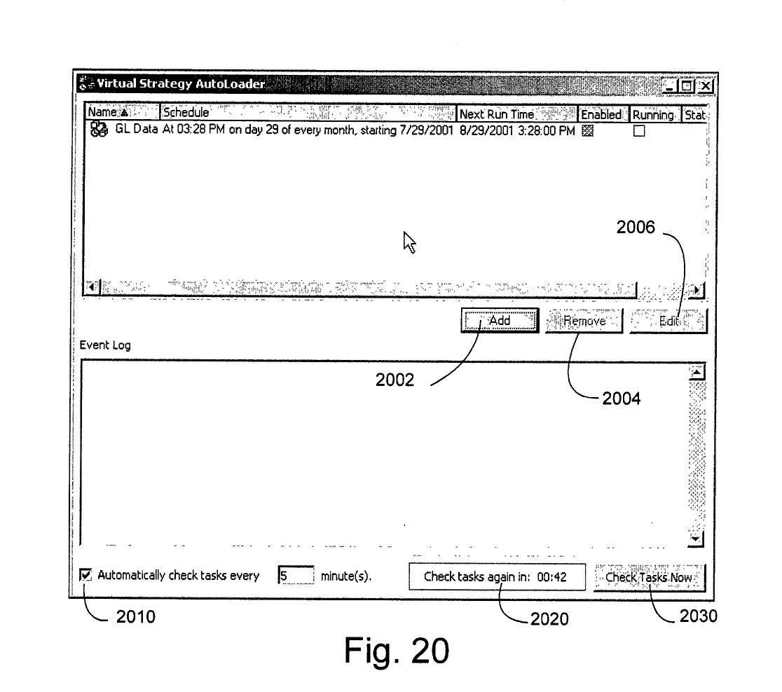

The automated data loader shown at 107 in FIG. 1 allows the user to automate data loads. Data loading tasks can be scheduled to run automatically at a regular interval. The loads are configured using the automated data loader screen seen in FIG. 20. The automated data loader 107 allows the user to manage scheduled loads and process scheduled load tasks.

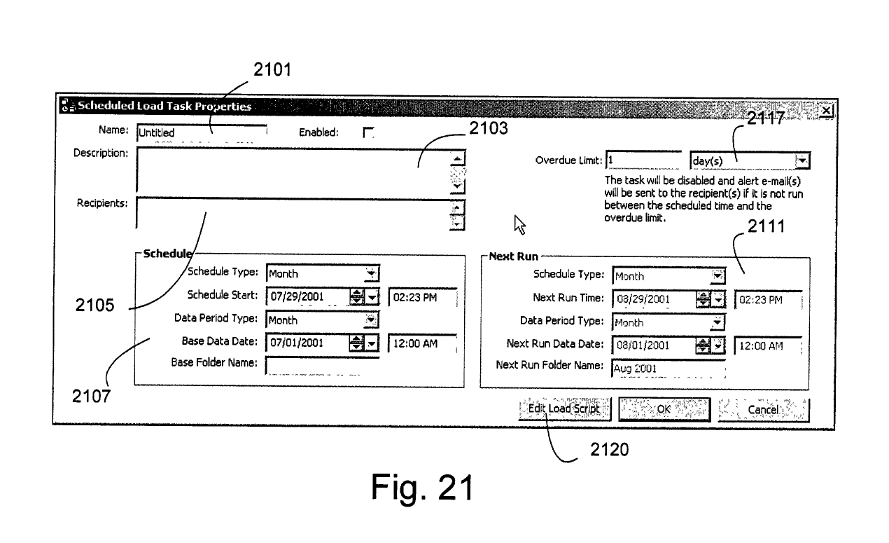

Managing automated data loads. When the user wants to create a new load task, the Add button 2002 is clicked to display the Scheduled Load Task Properties dialog shown in FIG. 21, allowing the user to configure the task. The user gives each load task a distinctive name at 2101 so that the user will be able to identify it. The user may also enter a more detailed description for the task in the “Description” box at 2103. The “Recipients” box at 2105 allows the user to specify a list of e-mail addresses to which any alert emails vill be sent. An alert email is sent to all recipients every time the task is run notifying them of a successful completion of the load, or of any errors encountered.

The “Schedule” area 2107 allows the user to set the interval and start date for load. The user sets the interval using the “Schedule Type” drop-down list and specifies the start date in the “Schedule Start” menu. A task can be scheduled to run at any one of the following intervals:

1) Annual—run once every year on the specified date

2) Quarter—run once every quarter on the specified date (i.e. the 1st day of the 2nd month)

3) Month—run once every month on the specified date

4) Week—run once every week on the specified day of the week

5) Day—run once every day at the specified time

6) Hour—run once every hour at the specified minute

Once the user specifies a “Schedule Type” and a “Schedule Start” for the load task, the “Next Run Time” will be shown below in the “Next Run” area 2111.

Loaded data must pertain to a particular time period. The user can specify the interval for the time period (i.e. month, day, year . . . ) using the “Data Period Type” menu. The user can specify “Base Data Date” to set the date which determines the beginning of the time period. In general, the “Data Period Type” interval should be the same as that set in the “Schedule Type,” so that if, for example, the user runs a schedule every month, the user loads monthly data. The “Base Data Date” must correspond to the start of a period. For example, if the “Data Period Type” is Month, the “Base Data Date” must be the first of a month. The user can see the date that will be used to run the next load in the “Next Run Data Date” in the “Next Run” area. The “Base Folder Name” is used to determine the name of the folder(s) that will store the loaded data. The actual name of the folder used for a given load session will be the “Base Folder Name”+the “Base Data Date.” For example, if the “Base Folder Name” is “Employees−”, and monthly data is being loaded for January, 2001, then “Employees−January, 2001” will be the folder name. The name that will be used for the next scheduled load appears in by “Next Run Folder Name” in the “Next Run” area.

At the top right of the window at 2117 the user can set when a task will be considered overdue. When it is time for a given task to be run, it is possible that the automatic data loader will not be available because it is running another task. Thus, a scheduled load task may be processed after it was scheduled to be run. If the difference between the time when a task is actually processed and the time when it was scheduled to run is greater the value set in the “Overdue Limit” the task considered overdue; it will be disabled and an alert email sent to “Recipients” of the task. The default overdue time is one day.

The remaining properties of a scheduled load are stored in the Load Script for the load task. The Load Script can be configured by clicking the Edit Load Script button 2120. The Edit Load Script dialog will appear and allow the user to use the data loader wizard (described above) to configure the script.

Scheduled tasks may be removed by selecting the task to be deleted on the automated data loader screen seen in FIG. 20 and pressing the Remove button 2004. Existing tasks may be edited by pressing the Edit button 2006 to bring up the Scheduled Load Task Properties screen (FIG. 21) and editing the changes.

Processing Load Tasks. If the automatic data loader application is running and the “Automatically check tasks” option is checked at 2010, all scheduled load tasks will be checked at a regular interval to see they should be run. The user can control the number of minutes between these checks by changing the number in the “minute(s)” text box. The default amount of time between processing tasks is five minutes.

Between checks, the amount of time remaining (in minutes and seconds) will be displayed at 2020 next to “Check tasks again in.” The user can also choose to check tasks immediately by clicking the Check Tasks Now button 2030. While a scheduled load task is being run, the user will not be able to add, remove, or edit other tasks until the load session is finished. Note: Clicking Cancel or closing the “Run Scheduled Load” dialog box (not shown) will cause the task to be disabled and an alert email to be sent to the “Recipients” associated with the task.

Data Unloader 111

It is important to keep the most accurate and relevant data in the data model. The data unloader shown at 111 in FIG. 1 allows the user to clean up any old or unwanted data without compromising the integrity of the data model. The data unloader 111 s part of the data model manager 103 and is a wizard that will step the user through the necessary steps for unloading data: Viewing the loaded data model, selecting the data to delete, confirming the selection, and unloading the data. At first, the user will see a graphical view of the classes currently loaded in the data model. Classes where data can be removed are displayed in blue, and ones that cannot be removed from are in gray. Hierarchies cannot be removed; only data. Since data is loaded in sessions, it can be removed it in the same fashion by selecting data to remove from a list of “Existing Loads” (not shown). In this listing, the user can also see data loads that have already been deleted from the data model. In order to continue, the user selects a load from the “Existing Loads” list, and then confirms the selection before continuing. A checkbox option on the confirmation screen allows the user to select a “Remove Empty Folders (Recommended)” to indicate whether or not the user would like the data unloader to remove the empty folders that the user data was loaded into.

Once the data unloader begins deleting the data, a status summary (not shown) will appear and indicate the progress of the unloading session. When unloading has completed, the summary will indicate how many records were removed from the data model.

Data Model Explorer 176

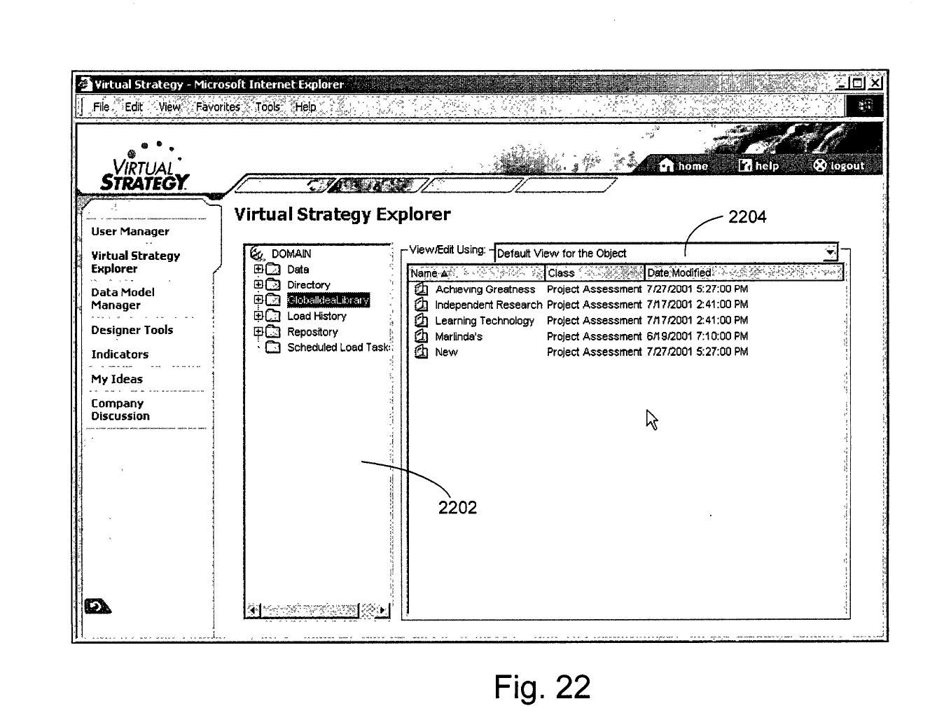

Using the data model explorer seen at 176, illustrated in FIGS. 22-27, an administrator can access and view the all of the objects included in the data model 101. The explorer ties together system and loaded information into a single interface and its functionality is similar to that of Windows Explorer™. The data model explorer provides a visual representation of the data model and different display options for viewing an object's properties.

The data model comprises of information loaded by the user organization as well as system information. There are five important folders under the Domain that stores most of the relevant information used to implement the system as illustrated in FIG. 1: data 121, a directory 123, a global idea library 125, a repository 127, a scheduled load tasks folder 128, and load history folder 129.

Any data loaded into the data model will be loaded into the data folder 121. Individual hierarchies appear as children of the data folder 121. Any flat data tables are loaded into those hierarchies.

The directory folder 123 stores information describing system users. Each user has folders that pertain to their activity as a user of the system. For example, their projects would appear in the “My Scenario Projects” folder.

All project ideas submitted by users of the system reside in the global idea library folder 125.

When data is loaded into the data model as described above, a record of that load is maintained in the load history folder. These objects have folders associated with them that include any objects loaded during the session that could not be linked into the hierarchy.

The repository folder 127 includes all of the system information. It is recommended that the user do not make any manual changes to this folder. Any careless changes may corrupt the whole system.

When the user select an item from the hierarchy seen at 2202 in FIG. 22 in the data model explorer, the user will see information on the object displayed to the right. The user will notice a drop-down list at 2204 containing different view options

1) Default View for the Object

2) Tabbed View of the Object's Properties

3) List of the Object's Properties

4) List of the Object's Children

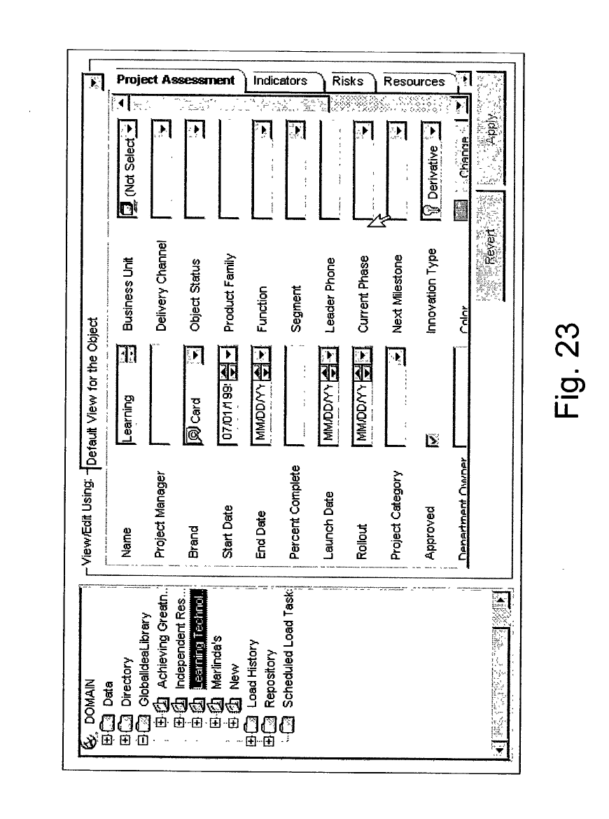

Default View for the Object. Each object has a default view associated with it based on what class it is. If the user clicks on a folder in the hierarchy 2202, the window at the right shows a list of its children by default as illustrated in FIG. 22. If, for example, the user clicks on a project, the user will see a Project Assessment Form (PAF)—to be described below—displayed as a default as illustrated in FIG. 23.

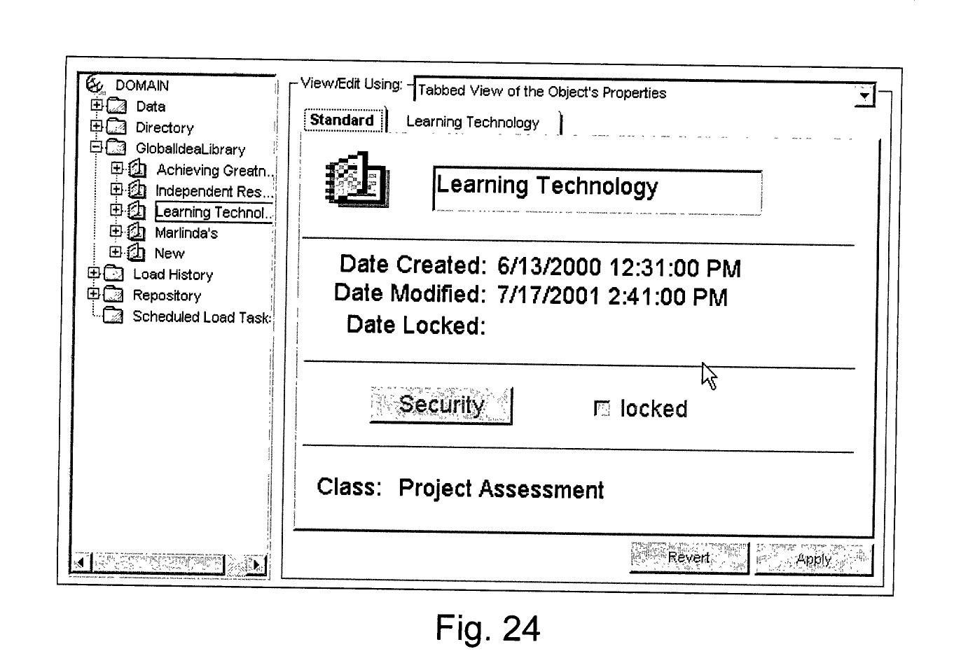

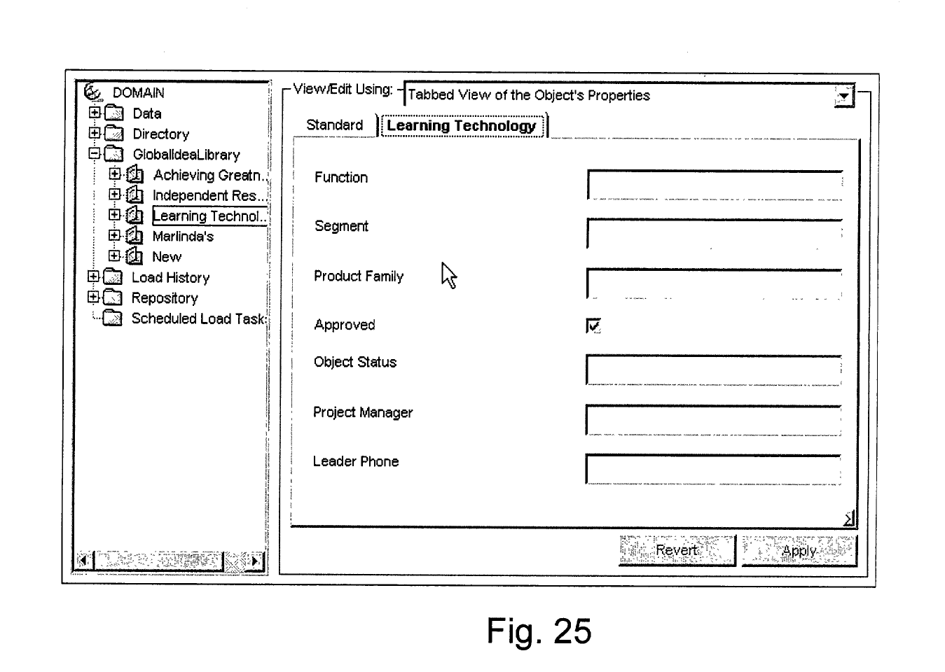

Tabbed View of the Object's Properties. In order to just view the properties of an object, the user can select the tabbed view shown in FIG. 24. The user will see two tabs associated with each object. The first one, “Standard,” tells the user what class the object is as well when it was created and last modified. The user can receive this information on all objects. The second tab, illustrated in FIG. 25, is named based on the name of the object. It includes a list of the attributes of the object and their current values. This is unique for each object.

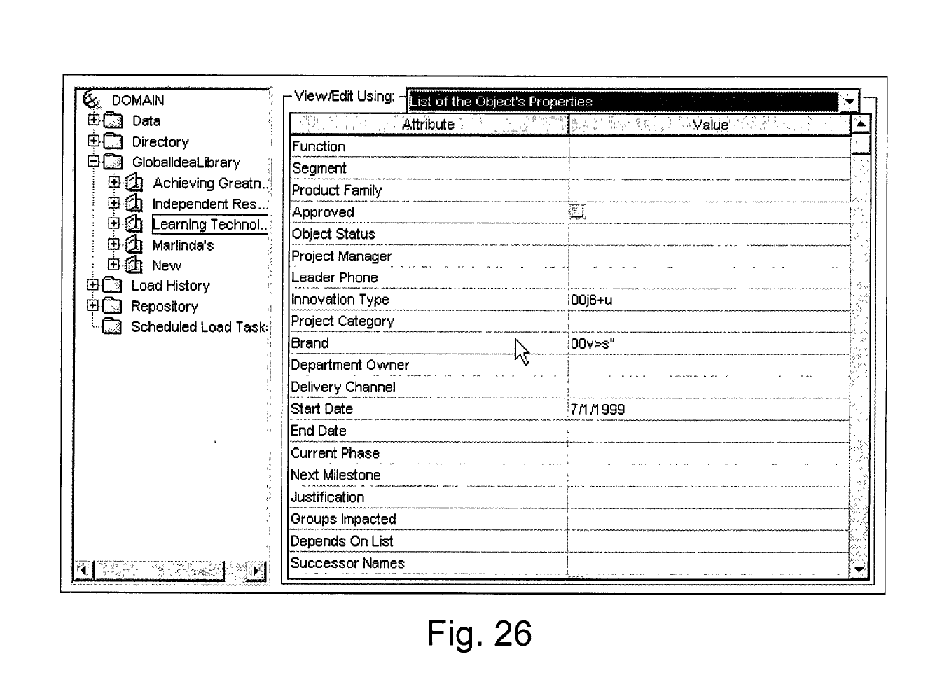

List of the Object's Properties. If the user wants to just see a straightforward list of an object's properties along with the current values, the object properties view shown in FIG. 26 may be selected.

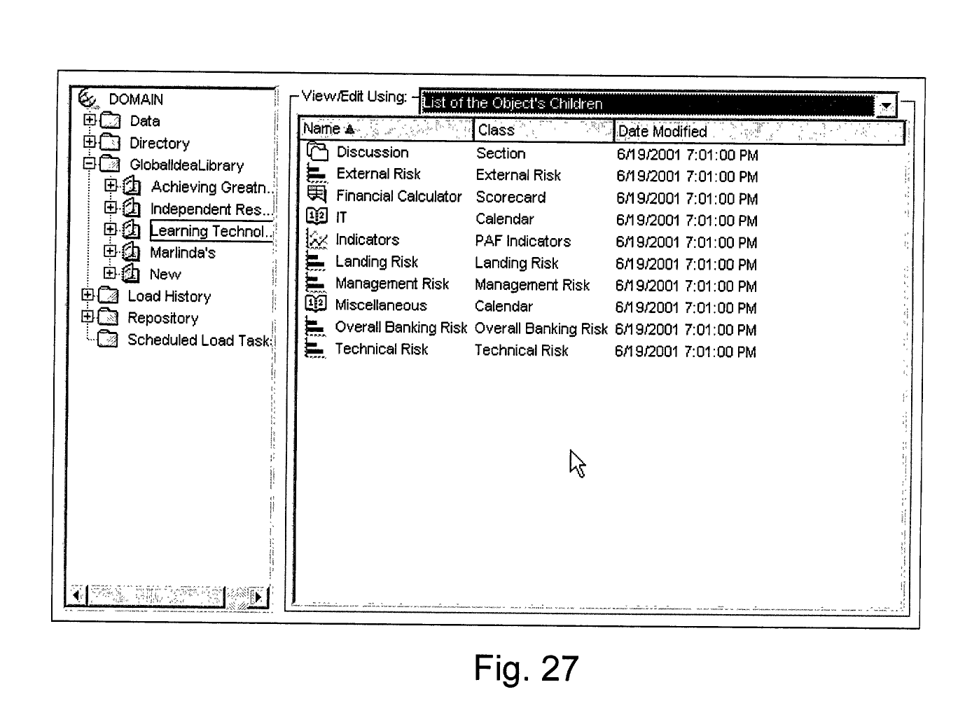

List of Object's Children. Finally, the user can also view the children of the objects in the hierarchy by selecting the object's children view shown in FIG. 27 from the drop-down list. Each of the child objects for the selected item will be listed.

microCubes™ 151

The present invention employs “microCubes™”, seen at 151 which provide answers to questions that are actually asked. microCubes™ are built incrementally based on use and are updated automatically as relevant data comes into the system. microCubes™ also have a unique object pointer structure linking them to one or more scenarios stored in the repository 127, permitting the system to provide support for multiple scenarios and personalized ‘what if’ statements.

Templates called “data series” are used to get data from microCubes™. These templates, which are used for configuring user reports, performing microCube™ searches and to obtain data for scorecards, are created using a data series generator wizard. The important things a user will need to do when configuring data series are:

1) select the data table to get data from;

2) choose the data column and the function to perform on that data;

3) configure the labels for the data returned;

4) add any extra criteria on the data; and

5) name and describe the data series.

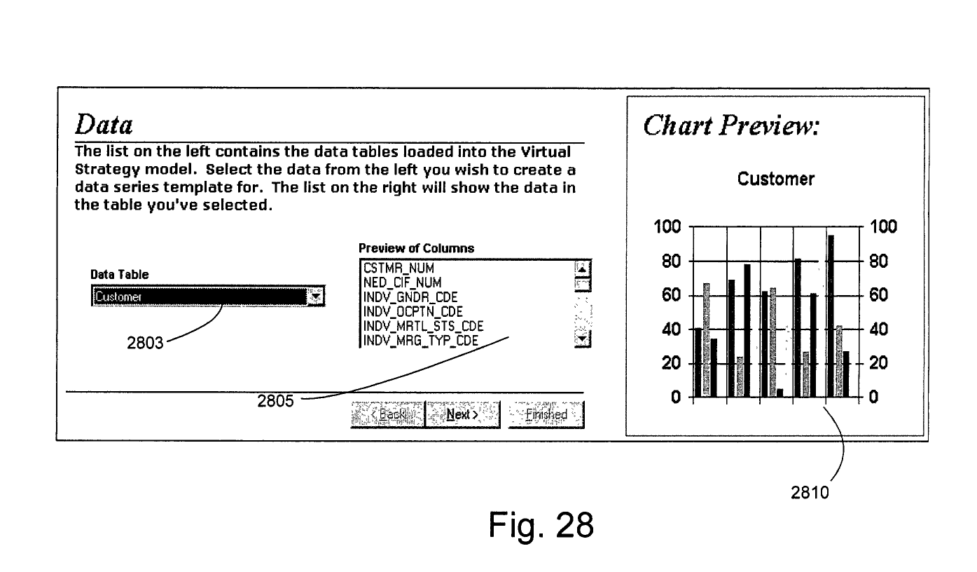

Select Data Table. First, the user selects the type of data that the user desires to plot by identifying a data table in the drop down list 2803 seen in the dialog box seen in FIG. 28 presented by the data series wizard. The wizard then displays the data columns available in that table at 2805 and the user selects one of the displayed columns. A chart seen at 2810 is displayed on the right and is configured by the settings the user chooses using the data series wizard to show the user how the changes will look when completed.

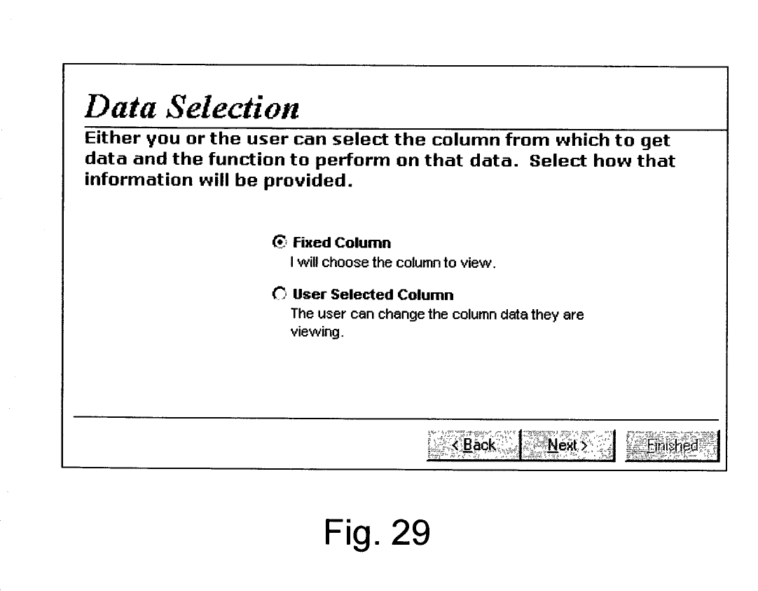

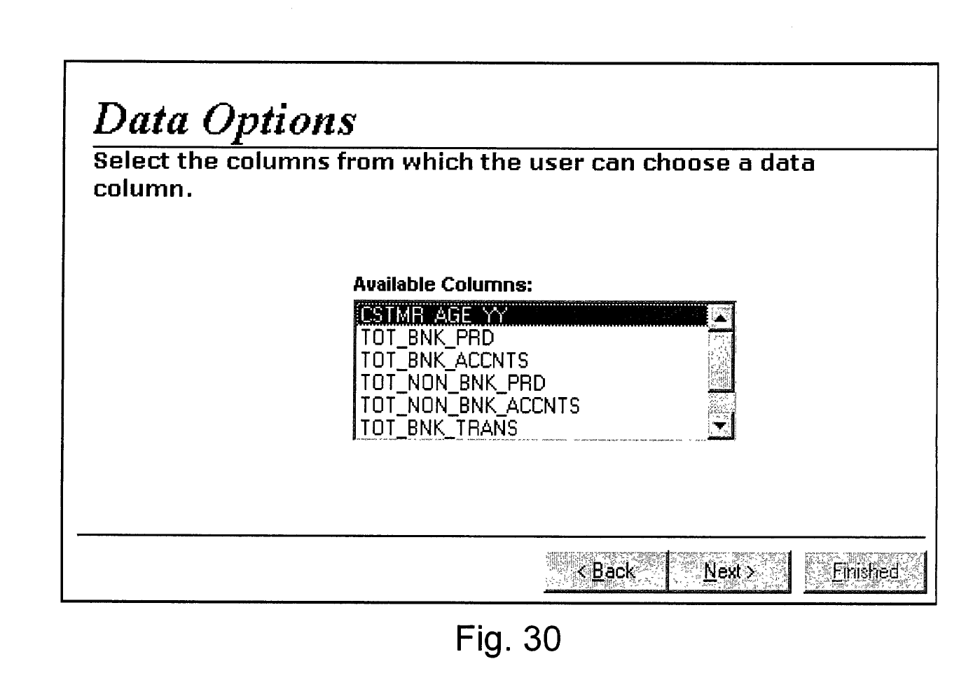

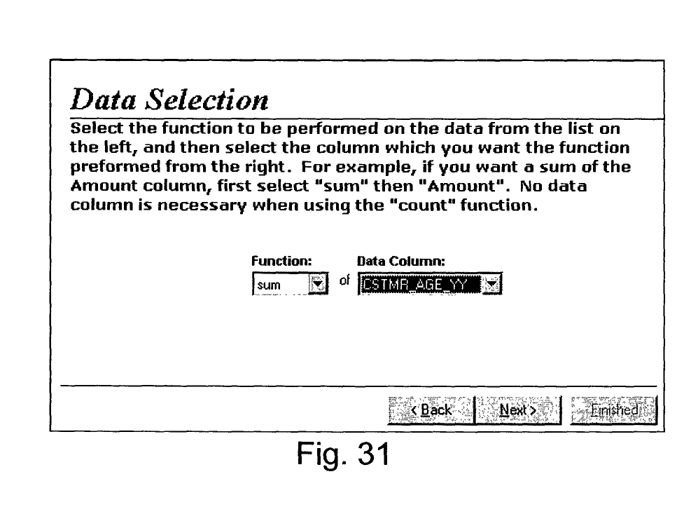

The user next decides who will select the data to plot using the screen seen in FIG. 29. If the user selects “Fixed Column,” the user will have to select the column from which to get the data to be plotted as well as the function to perform on that data. By choosing the “User Selected” option, the ultimate user of the data series will be allowed to configure that information when needed. If the data is configured to be “user selected,” the columns that the ultimate user will be permitted to choose from may be specified using the screen seen in FIG. 30. If the “fixed column” option is chosen, then the user needs to select the data column and further specify the function to perform on that data using the screen seen in FIG. 31. The functions that can be preformed on the data are: sum, count, average, minimum and maximum. If the user selects “count,” then no column needs to be selected.

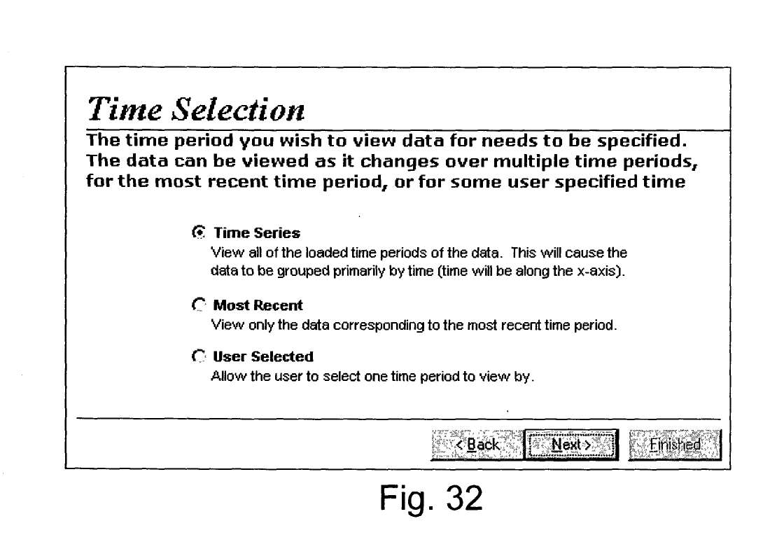

Select Data Labels. All data that is loaded into the system has time associated with it, and the screen seen in FIG. 32 is used to specify how time will impact this data series. The first option for a data series is that it can be a “Time Series”; that is, all time periods are shown and time is the primary data grouping (data grouping is discussed below). Second, the data series can return the “Most Recent” data, or the data loaded into the system with the greatest associated time period. Finally, time can be “User Selected;” allowing the ultimate user to show only the time period that he or she is interested in viewing.

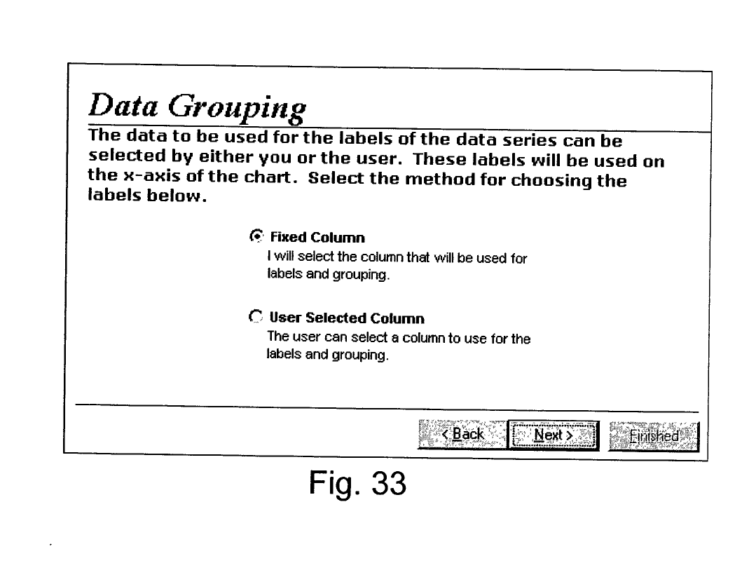

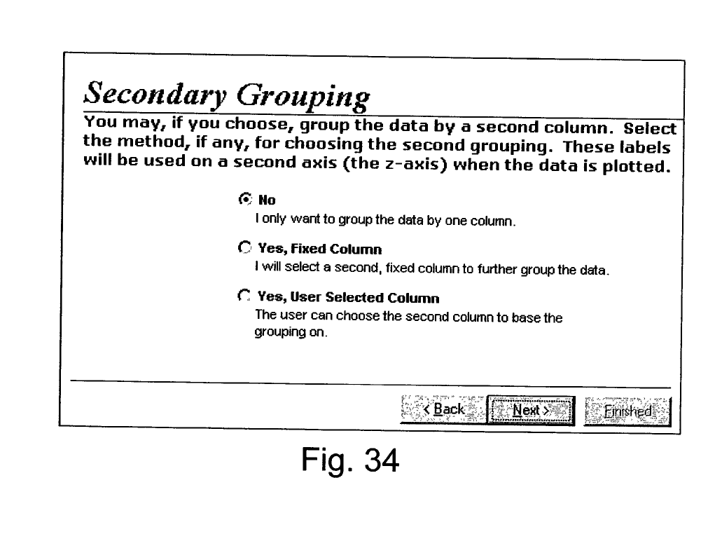

As an alternative for viewing straight data for each time period, values for time periods can be summed or averaged up to the given period. For example, using the screen seen in FIG. 33, the user can view year-to-date sums for each month of loaded data if the user had monthly data.

If the data series is configured for either the most recent time period or user selected time period, then something other than time must be selected to group and label the data. For example, one may want to view customer counts by their age group. Grouping, like the actual data that is being plotted, can be either fixed or user selected as specified by a selection screen (not shown) like that shown in FIG. 29. If the grouping is fixed, then a column for grouping the data must be selected using a drop down list (not shown) presented by the data series wizard. If the grouping is “user selected,” then the names of the columns to make visible to the ultimate user are presented on a screen like that shown in FIG. 30.

After the primary data grouping is configured, the secondary data grouping needs to be configured using the screen seen in Fig. For example, if the data series is configured to look at customer counts by age groups and gender. This is done just as it is with the primary grouping. If the data is to be grouped in only one way, “No” grouping should be selected.

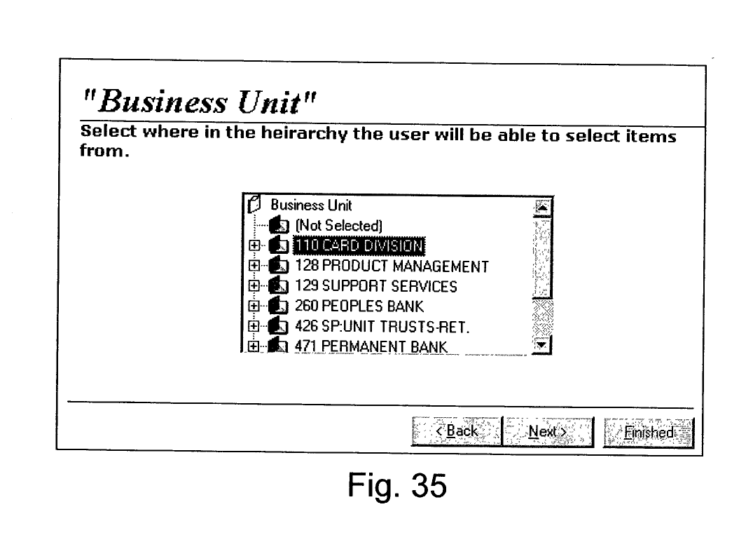

Data Criteria. Linked Hierarchies. All data that is loaded into the system and useable with microCubes™ is linked to some other data. For example, customers and employees may be linked to business units. With this example, a user viewing a report on customers would need to select a business unit to view customer data for the screen seen in FIG. 35 to select where in the data hierarchy the user will be able data from. Note that not all of the linked data may be appropriate for the user to be able to select. The highest-level business units may not have customers to view, or this report may be for a user in a specific branch of the organization and doesn't need to see other business unit's information. Using the screen of FIG. 35, the user selects that item that will be the root of the user's possible selection.

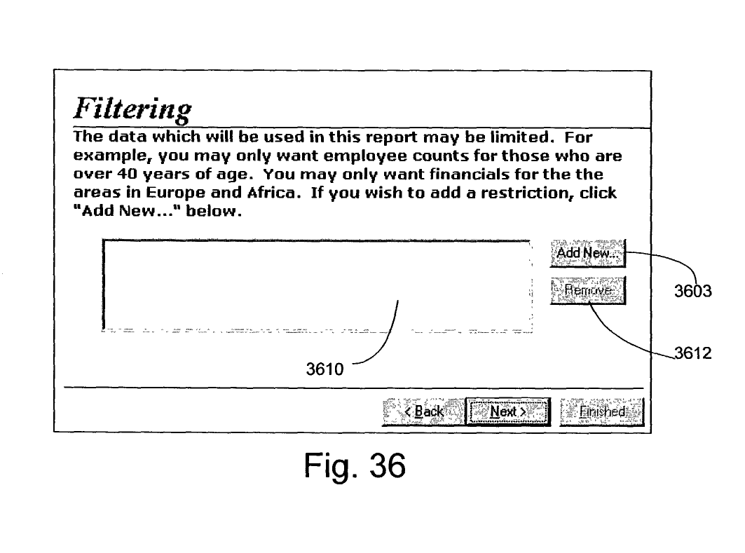

Filtering. It may be appropriate to further limit the data that is used in data series calculations. For example, if the data series is configured for customer counts by age group, the user may want to limit the data series so it views only unmarried customers, or male customers, or even minority customers. To add a new filter, the user clicks “Add New” at 3603 on the Filtering screen shown in FIG. 36. and employs the “Criterion Wizard” (described in detail later) which will appear. To remove a filter, the user highlight that filter in the listing at 3610 and clicks Remove at 3612.

Name the Data Series. Finally, the Data Series needs to be named. After typing in the data series' name in a dialog box (not shown) presented by the data series wizard, the user may also enter a detailed description of the data series, and the text of description will be visible to the ultimate user when selecting a data series to use.

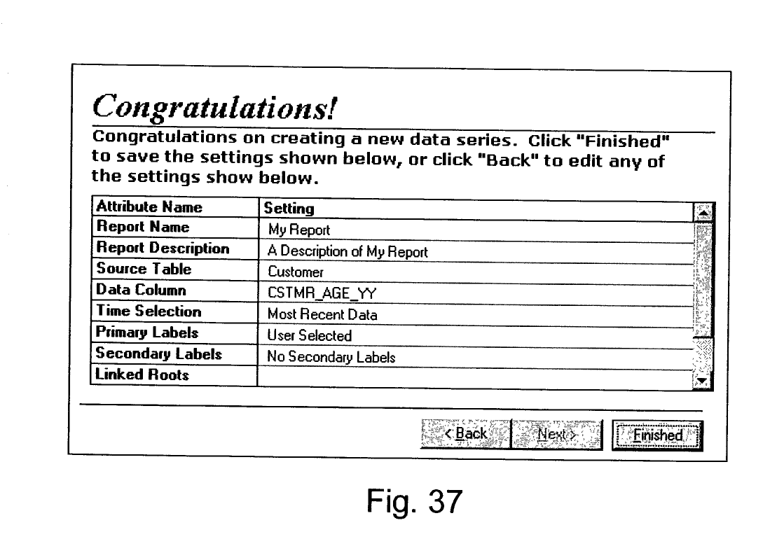

When the configuration information prompted by the data series wizard is complete, a review screen seen in FIG. 37 will appear, allowing the user to confirm that all of the settings are correct.

Report Wizard

The Report Wizard is a tool for creating reports from the data series templates used to obtain information from microCubes™. To create a report from a data series, the user needs to specify: the report type, the data to be plotted, the manner in which the data is to be grouped, the criteria used, and a report name.

Report Type. The Report Wizard begins by displaying a list (not shown) of the available data series previously created. When a listed data series is selected from the list, the description of that data series is displayed.

The Report Wizard then follows a series of steps which correspond to the options previously set for the selected data series. If the data series specifies “user selected” data, the user is presented with a drop down list of available data and a second drop down list of the function to be applied (like the screen seen in FIG. 31 presented by the data series wizard). The user can then group the data using different categories defined in the data series template by selecting from the drop down list the attribute of the data to use to label the data. It specified by the data series template, a “Secondary Data Grouping” window will appear and is used in the same way that primary data grouping is selected.

The data being viewed will be associated with at least one hierarchy in the database, and a screen like that shown in FIG. 35 for the data series wizard is presented by the report wizard to permit the user to select the objects for which data is to be viewed. Note: If the user is creating a scorecard report, the user will see a checkbox for making the hierarchy unit user selectable. If the user checks this box, the user will not be able to select a unit from the drop list, since it will become invisible.

Grouping. The user then selects a time period for which to view data. If the user is creating a scorecard report, the user will see a checkbox for using a relative time series if desired. If the report the user is creating includes a user-defined time series the user will see a screen allowing the user to specify that values for time periods can be summed or averaged up to the given period. For example, instead of viewing only the data for one month, the user can view the average of all the months in the year to that month. If the administrator has configured additional constraints for the data series, the user will be presented with a screen allowing the user to select those constraints. For example, if the data series is configured for customer counts, a constraint may be on customer age, such as “customer age<40” in which case the data returned can be for only customers under 40 years old.

Report Name. The Report Wizard concludes by presenting a screen (not shown) which requests the user to enter a name for the report. This is the report name that will appear in the analysis workbook described next.

Analysis Workbook

The analysis workbook seen at 38 in FIG. 1 encapsulates different ways of viewing configured reports in data model. Each report is customizable and is constantly updated through the microCubes™ 151. The following views shown in FIG. 1 are available from the analysis workbook: the main report 161, the GeoReport 162, the decomposition view 163, the model view 164, the influences view 165 and the “influenced by” view 166. The analysis workbook 153 also provides access to the alert manager 158 for configuring alerts, and a mechanism for performing searches using criteria specified by a “criteria wizard” (to be described).

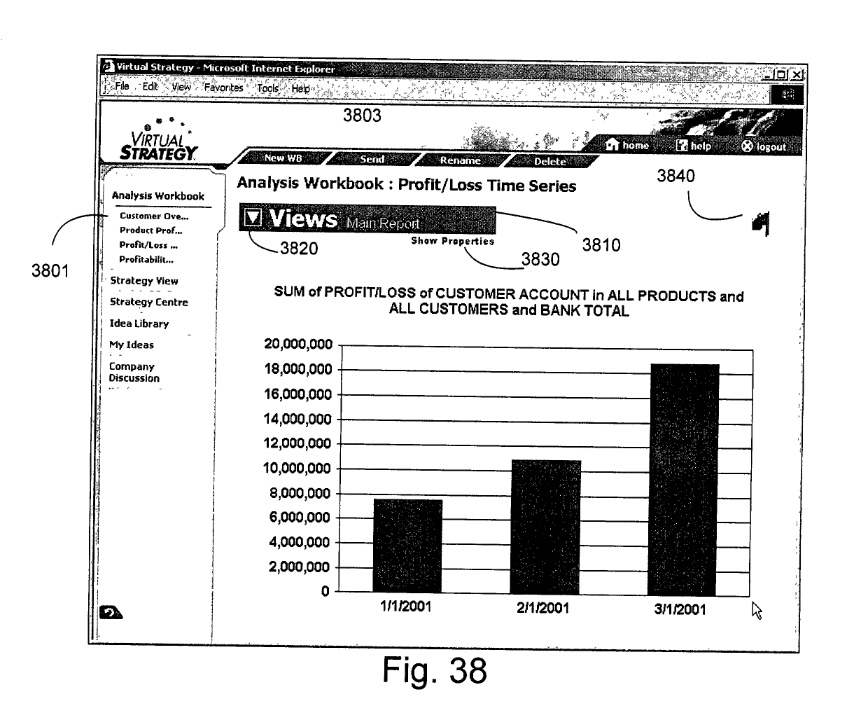

A user's saved reports are listed underneath the Analysis Workbook link when selected as seen at 3801 in FIG. 38. To view a report, one only needs to select a report from the list and click on it. Selecting “New WB” at 3803 will launch the Report Wizard discussed above to create a new report using a data series template for obtaining data from a microCube™.

By default, the “main report” is displayed in the analysis workbook. In the top left corner of the plot the user will see an area 3810 with the word “Views,” followed by the text “Main Report.” To change the current view, click anywhere within the button at 3820 to bring up a drop down list of the views available for the current report. In order to customize any of the reports, the user clicks on the “Show Properties” 3830 button underneath the “Views” box. If the properties are already being displayed, then the button will say “Hide Properties” and may be clicked to hide the properties.

Main report. The user can configure the main report to show a graphical or spreadsheet representation of the desired data. The user can configure and view reports on any of the data that has been loaded into the data model. For example, the user can view financial data by Business Unit and Chart of Accounts, if that is how the user organization stores its financial information. Note: When the user has a spreadsheet report, the user will only be able to view the Main report and perform a Search.

If a red flag appears in the top right-hand corner of the report as seen at 3840, an alert has been fired for this report by the alert monitor 159 described below.

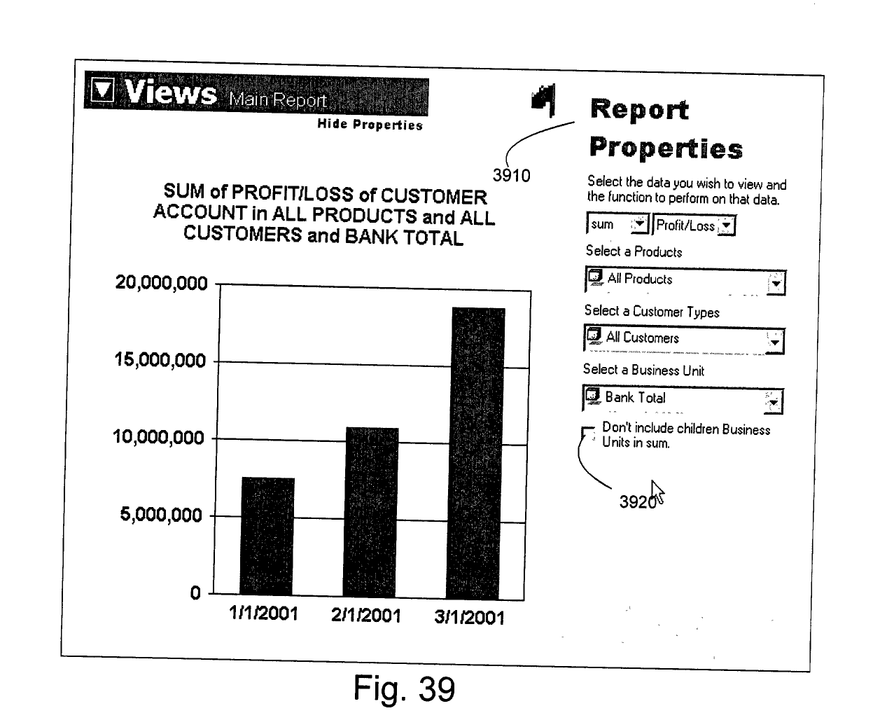

After clicking Show Properties at 3830, the user can use the “Report Properties” work area seen in FIG. 39 at 3910 to change what is being plotted in the graph. “Report Properties” will show the user those parameters of the report that are configurable. Changing parameters of the report from the drop down lists will affect all of the views for this report, since, in essence, the user is changing the report.

Part of the “Report Properties” that is visible when the data being plotted is associated with a business hierarchy is a check box seen at 3920 with the caption, “Don't include children Business Units in sum.” When this is checked, the data that is plotted is only relative to the selected Business Unit selected and not a rollup of the values of children Business Units. If this box is not checked, then a sum is performed for the selected Business Unit as well as all of its children.

Whenever the user changes the parameters in “Report Properties,” the changes are made to the report immediately.

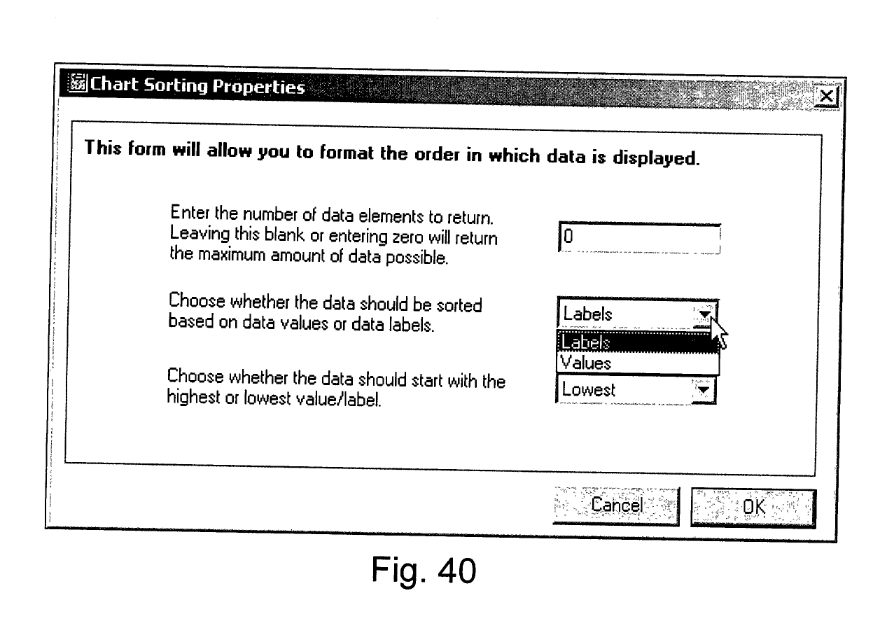

If viewing a chart, the user can sort the main report by either the labels on the horizontal axis (date values for a time series) or the values in the chart. The sorting can either be performed ascending (lowest to highest) or descending (highest to lowest). To do so, the user clicks on the “Report Properties” title that appears when the user is viewing the properties to display the Chart Sorting Properties dialog box seen in FIG. 40. Along with setting how the user wants to sort the data, the user can also decide how many data elements are to be plotted. For example, in the “Chart Sorting Properties,” the user can set the report to show the ten highest values from the database, ultimately providing a snapshot of the user's data.

GeoReport View. The user can examine a geographical representation of the main report through the GeoReport view seen at 162 in FIG. 1. GeoReports provide a geographical representation of organizational units and use standard native MapInfo files and mapping functions available from MapInfo Corporation, Troy, N.Y. for plotting data obtained from microCubes™. A GeoReport is a map version of the Main report, and uses the same properties bar to plot the units that appear.

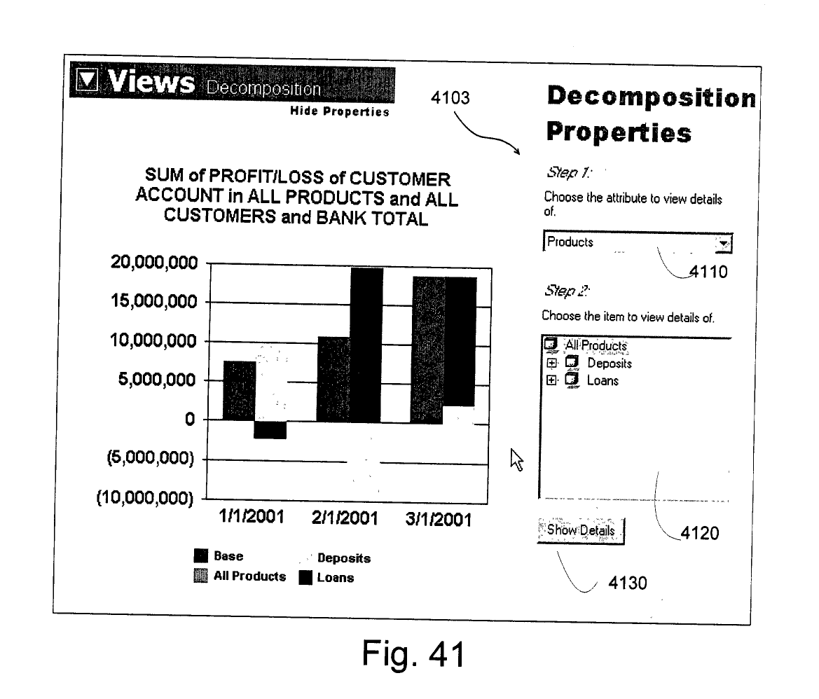

Decomposition View. The decomposition view seen at 163 in FIG. 1 allows the user to see how different hierarchal items contribute to the overall picture in the main report. For example, the user could see how each child Business Unit contributes to the total assets of the user selected Business Unit Like a Main report view, Decomposition also has a properties bar if the user clicks on Show Properties. However, the decomposition view allows the user to perform different tasks. There are three different things that the user can do from the “Decomposition Properties” area seen at 4103 in FIG. 41. First, the user can use a drop down list at 4110 to select the hierarchy to perform the decomposition by. When the user selects a hierarchy type, a list will be displayed at 4120 consisting of the item that is selected in the main report of that type and its children. For example, if the user selects Products, the product the user was viewing in the main report will be displayed as well as its immediate children.

The user can click on an item in the list 4120 and the plot will change to reflect the decomposition of the selected item and its children compared to the baseline as setup from the main report. The baseline is the sum of all of the units underneath (and including) the item selected.

The third piece of functionality that is allowed here is exhibited when the user clicks on the Show Details button 4130 which displays a window (not shown) showing a numerical decomposition of the item selected in the list and its children in tabular. The data will be shown compared to the baseline. Note: The Show Details button 4130 is only relevant for reports that are time series. The mathematical analysis presented in the tabular listing shows the current value, the predicted value for next time period, the predicted value for the second and the third time periods, the correlation, historical impact, and present contribution.

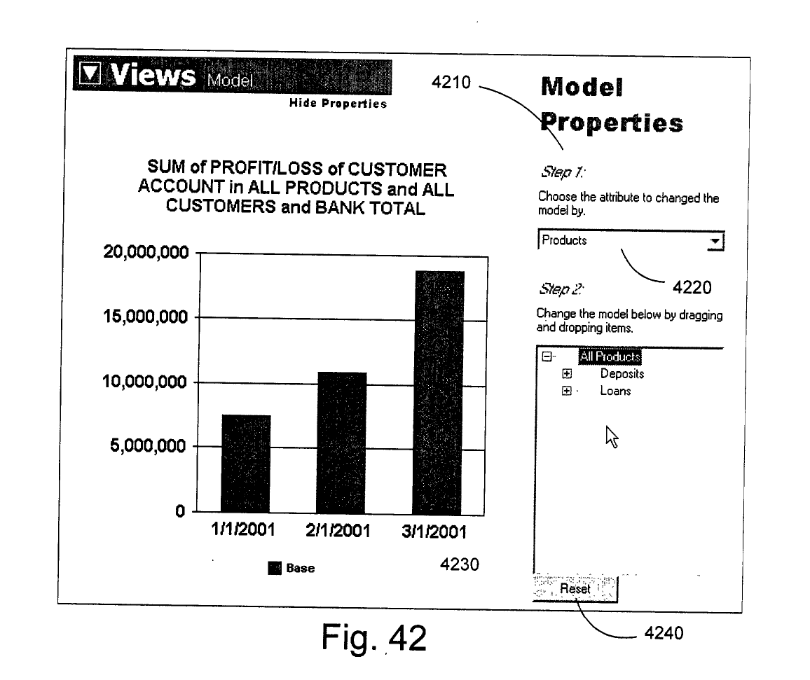

Model View. The Analysis workbook provides a forum for trying different “What If” scenarios within the current report to see how cha the baseline report. This capability is embodied in the model view. If the user would like to try and adjust one of the user hierarchal units within a given report without affecting the actual structure within the data model, the user can do so with the model view. On the model view screen illustrated in FIG. 42, the user clicks on “Show Properties” to show the “Model Properties” area seen at 4210. The user then selects the hierarchal unit to adjust using the drop down list at 4220. In the example seen in FIG. 42, the user can adjust the Products and see how it affects the model. When the model is in its original state (before making any changes or by clicking the Reset button 4240), the plot on the graph will correspond to the baseline that has been established in the Main report. The second step involves adjusting the hierarchal unit the user has selected in the first step. Moving the units within the hierarchy at 4230 using drag and drop will change the model. Any changes will be reflected in the plot immediately. If the user does not see any changes, the user may return to the main report and change the baseline and then return to the model view. Any alterations to the hierarchy will remain and the user can see if the baseline is affected by the changes.

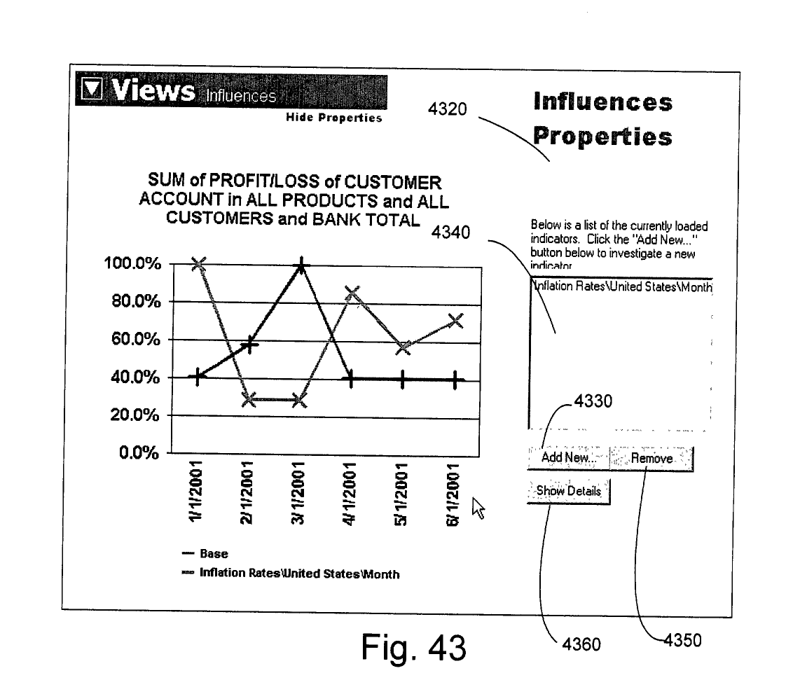

Influences View. From the analysis workbook, the user can see how different indicators are affected by the values that have been configured with a given report. In contrast to the other plots that have been discussed, the “Influences” plot illustrated in FIG. 43 is broken into a percentage to stress correlation. Items that are highly correlated will have similar lines on the graph. Unlike the other plots, the influences view also provides a forecast—the baseline is projected using linear progression over a three-month period. Any assumptions that are associated with the indicator data are included in the plot as well. Using the “Influences Properties” area at 4320, the user may add and remove indicators to be viewed on the plot.

Indicator Manager. Indicators are created by the indicator manager which build “indicator sets,” sets of data that cover a certain span of time for a certain period type. Indicator sets are organized into a hierarchy (or tree) of indicator categories. For example, an organization may desire to maintain an indicator set for United States inflation rates by month. Indicators can be used in scorecards (to be described) as well as in the analysis workbook when analyzing influences. Maintaining indicator sets involves:

1) Managing the Indicator Categories Hierarchy

2) Creating Indicator Sets

3) Editing Indicator Sets

4) Editing Indicator Category Descriptions

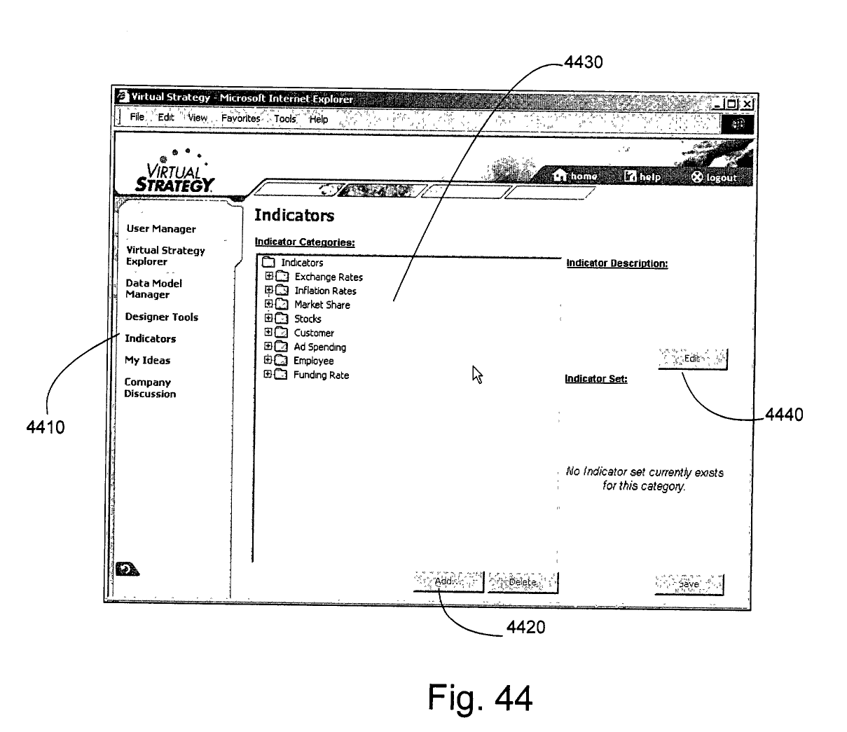

Managing the Indicator Categories Hierarchy. The indicator manager can be accessed from the web screen as seen in FIG. 44 by selecting Indicators at 4410 from the navigation bar. To create a new category, the user selects the location in the hierarchy where the user would like to add the new category, and then clicks Add . . . at 4420. The user will be prompted to specify whether the user want to create a new indicator category or a new indicator set for that category. If the user wants to add a new category, the user will only need to specify a name and description on a displayed dialog box (not shown). The description that can be specified for a category will be used when users are later prompted to select the type of indicator they would like to use. For example, the user might specify “type of currency conversion” for the category description of an “Exchange Rates” indicator category. When a user selects the Exchange Rates category, he or she will then be prompted: “Select the type of currency conversion the user would like to use for influence analysis.”

Creating an Indicator Set. To create an indicator set for a given indicator category, select the category in the hierarchy and click the Add . . . button 4420. The user will be prompted to select whether to add an indicator category or an indicator set and, in this case, will select new indicator set. The indicator edit wizard will then present a drop down list (not shown) allowing the user to choose which type of indicator the user would like to create. After the user selects an indicator type, the user will be presented with a list of period types that is used to select the period type for the indicator. The period type will determine the interval for which the indicator set will be incremented. After choosing the desired period type, the user will then be asked to define the period dates for this indicator set. The appropriate information will be asked according to which period type the user has chosen. The user then selects the desired start and end dates for the period.

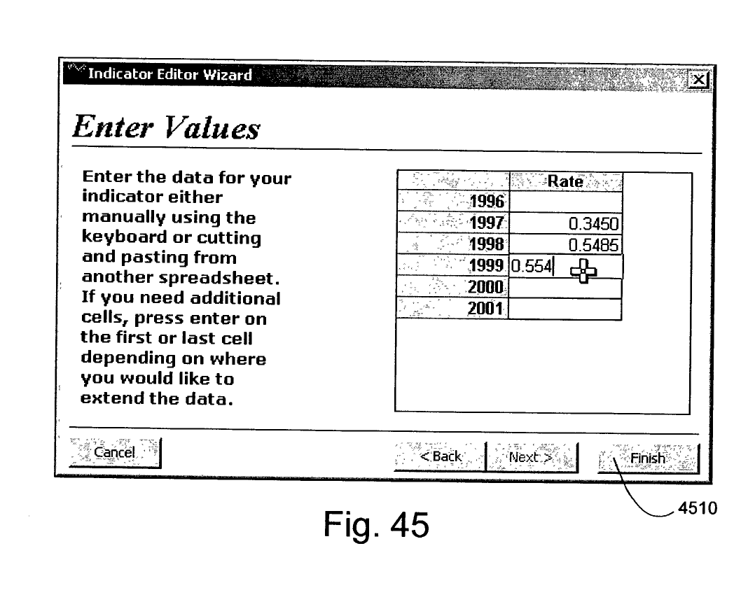

The indicator edit wizard will then create the indicator set according to the user's previous inputs. As shown in FIG. 45, a small spreadsheet will be generated to allow the user to enter the user's indicator values. The user can manually type the values or the user can cut and paste the data from another source. If the user would like the period start to be earlier, select the first cell and press enter. Likewise with lengthening the period end, select the last cell and press enter. The user may also go back a step and choose new starting and ending dates.

To complete the creation of the user indicator set, the user presses Finish at 4510. This will save the user's indicator set to the database and return the user to the main indicator screen shown in FIG. 44, where the user's new indicator set will be displayed in the bottom right corner. To edit an indicator set, the user finds the corresponding category in the hierarchy on the left at 4430. When selected, that indicator set will be displayed on the right had side where the user can enter or delete values, and extend the time period. If the user would like to change the description of an indicator category, double click the description on the right side, or click the Edit button at 4440. This will bring up a screen (not shown) with the category name in light gray and the description beneath it, permitting the user only edit the description field.

In order to add an indicator, the user clicks on the Add New . . . button 4330 on the influences view screen seen in FIG. 43, and uses an “indicator wizard” to add an indicator. The Indicator Wizard lets the user easily add an indicator to the list. The user can either add indicator data or another type of data. Note: If the user selects “Other Data,” the user will be brought to the report wizard described above for obtaining data from a data series (microCube™). If the user elects to add an indicator, the user needs to select the indicator type to use. A list of the different indicatory types (not shown) is presented and the user selects one from the list. The user will then be able to modify the type of indicator by selecting an indicator type from the list the user selected. For example, if the user selects “Inflation Rates,” the user can choose the region from which to get the inflation rates from. Depending on how the indicators have been defined by the system administrator, the user may be able to further narrow the type of indicator the user are adding. For example, the user may be able to select a type of time period for the indicator. Once the user have specified the indicator, it will be added to the list 4340 on the right in FIG. 43. Removing indicators can be done by selecting an indicator and clicking Remove at 4350. The user will notice that there is also a button called Show Details at 4360. If the user clicks on this button, the user will be shown the mathematical analysis window described above for the decomposition view.

Influenced By View. The “influenced by” view is very similar to the influences view shown in FIG. 43, except that the influenced by view displays how different indicators influence the values that have been configured with a given report. Again, percentages are used to show correlation between the values. The “Influences By Properties” works the same as “Influenced Properties” shown at 4320.

Alert Manager

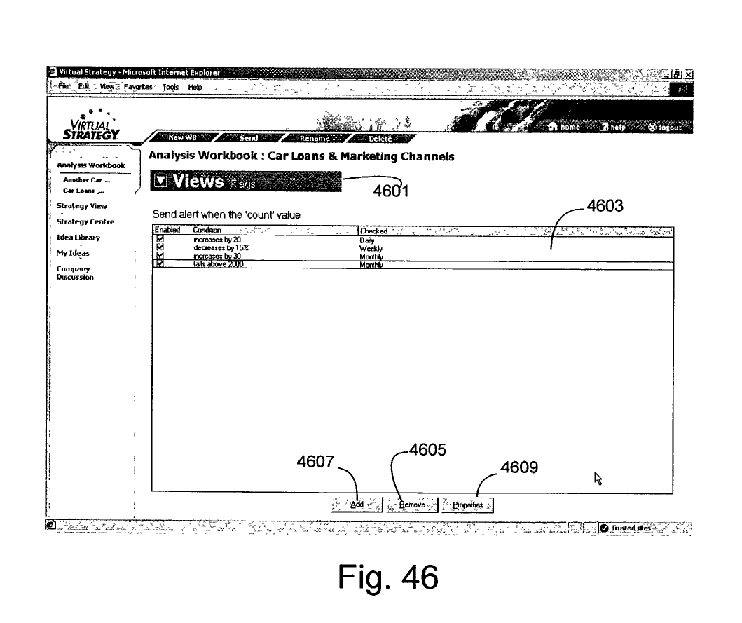

The interface for the alert manager 158 is accessed inside of the analysis workbook. Alerts are part of a report workbook. After opening a particular report by first selecting “Analysis Workbook” on the navigation bar at the left as seen in the screen display of FIG. 46, and then selecting a desired report form those listed below “Analysis Workbook,” the user can access the alert manager 158 by clicking on Flags at 4601 in the Views drop down menu. The user will see a list of the configured alerts for the report being viewed at 4603.

The alert manager gives the user the ability to view and edit existing alerts and to create new alerts. The alerts that are listed within a report are particular to that report. Each time the report is opened, the alert conditions are checked. However, the user does not have to open a report to know when one is triggered. The alert monitor at 159 in FIG. 1 keeps track of all alerts configured within the data model 101 and emails the user when an alert the user have configured has been fired. A red flag will appear on the “main report” at 3840 (FIG. 38) if any alerts are fired. The user may click on the flag 3840 to see a list of alerts fired for that report.

The user can delete an alert by selecting it from the list and clicking on the Remove button 4605. From the list 4603 the user can enable and disable alerts. An alert is enabled if there is a check in the box preceding the alert condition.

The user may click on the Add button 4607 to create a new alert in the report. The user will create the alert condition using an Alert Wizard (not shown). A similar Alert Wizard is displayed when the user clicks on Properties at 4609 to edit an existing alert. The Alert Wizard allows the user to specify the type of alert, the direction of the trigger, the trigger value, and the interval at which the alert condition should be checked. There are four different types of alerts that can be created: (1) when the value is above or below a specified value; (2) when the value changes by a specified percentage; (3) when the value is above or below the total percentage; and (4) when the value increases or decreases by a specified amount. Once the user has selected what kind of alert the user are configuring, the user needs to decide whether the alert is to be triggered when there is an increase or decrease in the value. The trigger value refers to the value that will cause the alert to fire. For example, the user can set an alert to fire when the balance increases by 5%. The “5%” is the trigger value. Alert conditions can be checked by the Alert monitor daily, weekly, or monthly as specified by the user. Note that the flags in the analysis workbook (to be described) are analyzed each time the user opens the report. This does not interfere with the user-configured alerts that are checked by alert monitor 159 each specified time interval.

After the user have finished these steps, a confirmation will be displayed showing the alert the user have just configured and the users e-mail address so the user can be notified if the alert condition is met when checked by the Alert monitor. If the user specifying the alert does not have an e-mail configured in the system, the user will be asked to supply one.

Criteria Wizard

The criteria wizard is used to step a user through the process of either setting a criteria to be used for searching the data model or setting a filter for report creation. As noted earlier, the criteria wizard is encountered in both the analysis workbook and the data series generator. The analysis workbook uses the criterion wizard to set the criteria for a search. The data series generator uses it to set up customizable reports for users of the system. The wizard offers different fuctionality in each case.

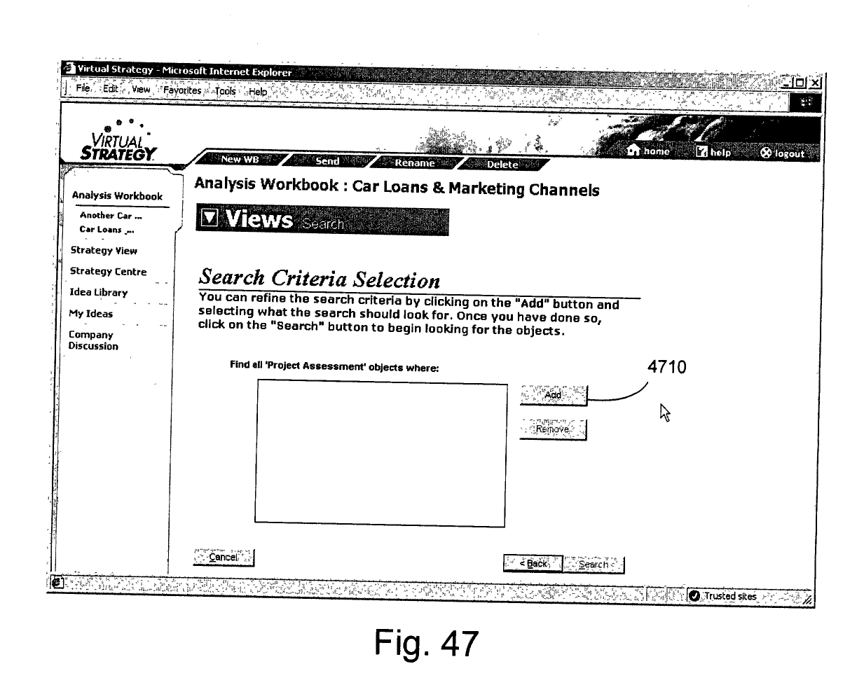

Criteria wizard in the analysis workbook. In the analysis workbook the user can search for objects of a given class based on data stored in the class, data stored in linked classes, or data from microCubes™. The searches are based on criteria set in the wizard. The user clicks on the Search from the Views menu list presented when the button 3820 (seen in FIG. 38) is pressed. The user selects a class to search from the list, and the user will then see a blank list at 4700 where criteria can be added as seen in FIG. 47. The use presses the Add button 4710 to launch the criteria wizard.

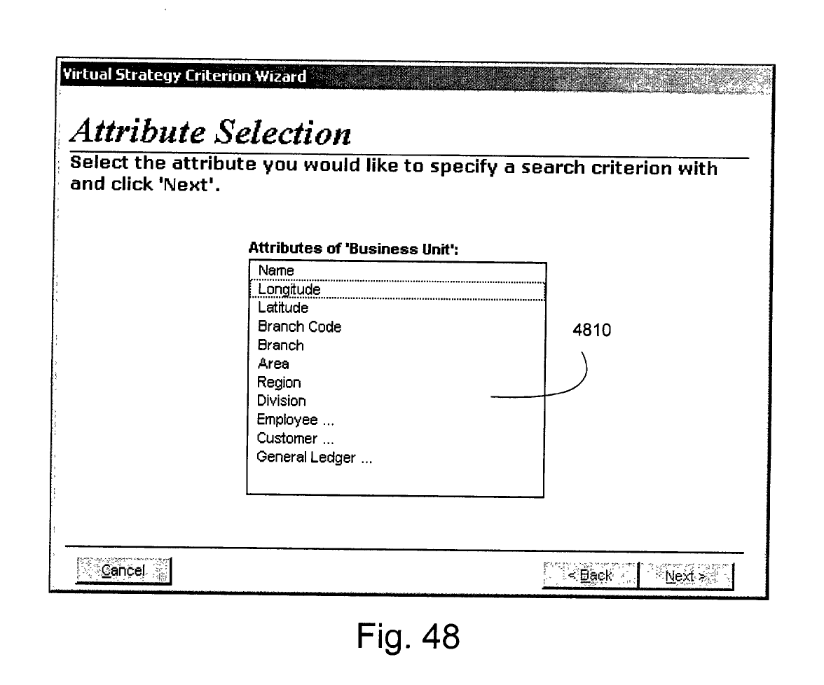

As shown in FIG. 48, the criteria wizard first displays the attributes of the class that is being searched in a list at 4810. In addition, it also lists classes that the selected class is linked to. These items are displayed suffixed with an ellipsis ( . . . ). For example, if the user is searching for business units (branches), then the user will see the attributes listed for the business unit class as well as the names of linked classes, like customers, financials, or employees.

If the user selects one of the attributes of the class, then the user will move on to the next step. However, selecting a linked class brings the user to the same screen but with the attributes of the selected linked class displayed as well as classes linked to the selected class. For example, if the user selects employees, then the user will see the attributes listed for employees. Added to the list may be an item called “Data Series . . . ” which appears at the end of the listing. The user can select one of the attributes and move to the next step or select one of the linked classes and repeat what the user just did. If the user select “Data Series . . . ” from the list, the user will also be able to move onto the next step.

The user has selected an “attribute” to be searched when the user has selected an attribute of the class being searched or an attribute of one the classes linked to it. “Data Series” also counts as an “attribute,” but will take the user through a different process since such a selection means the user is going to perform a microCube™ search and needs to provide some extra information.

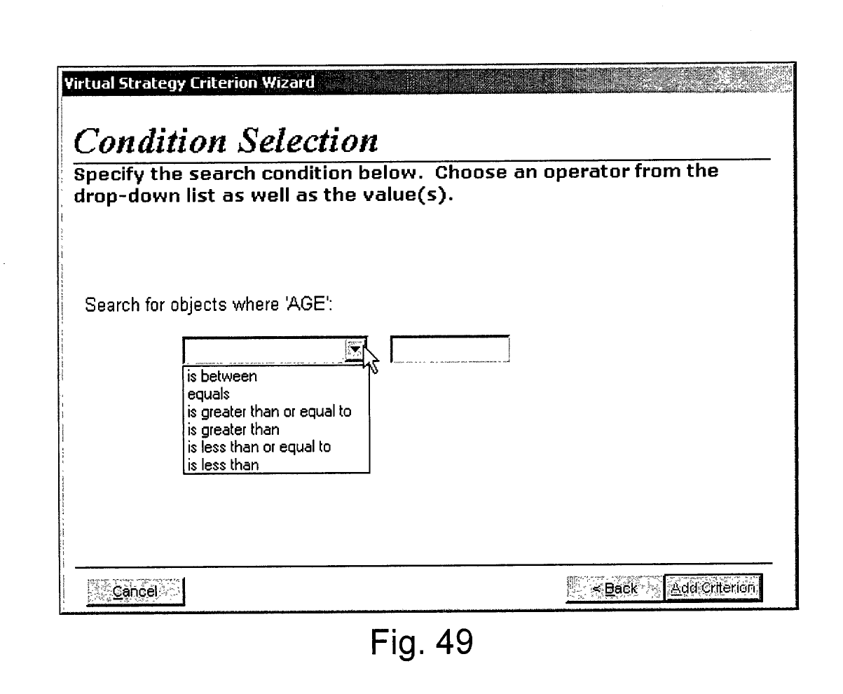

Specifying search conditions. After the user has decided the attribute the user wants to use in the search, the user needs to establish the value used in the search. For example, if the user wants to search for a business unit in a specific division, the user needs to select what division the user wants the search performed on or if the user wants to search for employees in a given age range, the user needs to specify the range. Condition selection is performed using the screen seen in FIG. 49. For criterion to be valid, the user needs to specify the operator and the value. The operators available depend on what kind of attribute the user has selected. If the user chooses a numeric attribute, then the user will be given the following options:

1) is between

2) equals

3) is greater than or equal to

4) is greater than

5) is less than or equal to

6) is less than

The user will be given the following options for text attributes:

1) is between

2) contains

3) equals

The user needs to specify two values if the user selects “is between” in either case.

Not all of the values can be specified in this manner. Some attributes have specific values associated with them. For example, if the user were searching for a project with a certain status, the user will see a drop browser (not shown) listing the different possible values. In this case there is no need to specify an operation since the search will look for that specific value. Once the user has added the new criterion to the search, the user will see it displayed with the parameters set in the wizard.

Specifying Conditions through microCubes™. If the user selects “Data Series . . . ” as the “attribute,” the user will be expected to provide a little more information to be used in the criterion. To provide this, the user will be stepped through a piece of the Report Wizard. The user begins by selecting the kind of search the user would like to perform. A displayed drop down list shows the data series objects in the data model that are applicable to the class the user want to perform the search on. The user then uses the report wizard to a horizontal axis label from the data series to use. “Horizontal axis” is used as terminology since the Data Series identifies these values as so. The user may also need to specify a path in a hierarchy to search. For example, if the user is performing a search on business units and selects “General Ledger” and then “Data Series . . . ” as the “attribute,” the user will need to specify where to look in the “Chart of Accounts.” When the user has completed using the report wizard to pick a data series, the user will be brought back to the criterion wizard to specify the data label to search. For example, the user would need to specify what month to use in the search that used “Period Start” on the horizontal access.

Once all the above has been completed correctly, the user needs to set a condition pertaining to the microCube™ search as described in the previous section. All of the information set for the microCube™ search criteria will be displayed when the criteria is added to the list for the search.

Criteria Wizard in Report Generator. The report (data series) generator uses the criteria wizard to set filtering conditions for the data series created by the administrator. The criteria wizard is launched when the administrator clicks Add New . . . at 3603 in the report generator as seen in FIG. 36. When launched from the data series generator, the administrator will only be able to select an attributes of the current class used in the configuration of the data series. The administrator selects the attribute the user would like to use in the filter from a drop down list (not shown). The administrator will then be prompted to decide whether to allow the user to set the condition. If the administrator selects “Fixed Condition,” the administrator will be expected to enter the search condition. If the administrator selects “User Changeable,” the administrator will only need to enter a prompt that will be displayed to the user when he or she sets the condition themselves. When the criterion is added, the filter will display the selected attribute followed by “is user selected” when the criterion is added.

Strategy View

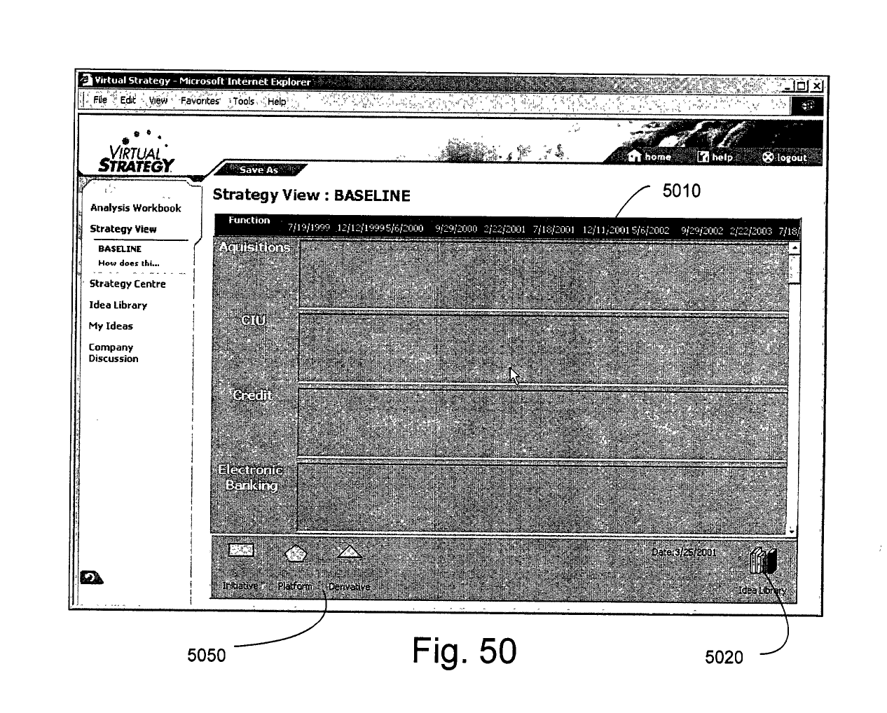

The strategy view indicated at 155 in FIG. 1 provides a platform for viewing and customizing different projects/initiatives, which are organized by scenario. When the user opens the strategy view, the user will be able to view the “baseline scenario” as seen in FIG. 50. The baseline includes all of the user organization's active projects. The user can perform “what if” analysis on scenarios and save versions of the baseline scenario into the user's own “My Scenarios” folder. Once the strategy view is displayed, the user will be able to:

1) Manage Projects/Initiatives and Scenarios

2) Change Scenario Properties

3) View Scoreboards

Managing Projects and Scenarios. Across the top of Strategy View is a customizable timeline seen at 5010. The icon for a project/initiative appears at its start date and a line projects forward from that point until the end date.

Strategy View is customizable to categorize projects/initiatives by certain types of data that pertain to it. The user can:

1) Create Projects/Initiatives

2) Edit Project Properties/Initiatives

3) Save Versions of Projects/Initiatives

4) Save Scenarios

5) View Idea library

Creating Projects/Initiatives. To create a project/initiative in strategy view, the user drags one of the innovation types indicated by the icons from the bottom left-hand corner at 5020 onto the timeline. A new project/initiative will be added at the spot the user drops the icon. Projects/initiatives may be used to represent projects, programs, business plans, initiative's, marketing plans, budgets, etc. The user can move projects/initiatives on the timeline by holding down the Shift key and dragging the project/indicative's icon to its new location. Changing the location of a project/initiative on the timeline will change its start date and end date, thus affecting any data stored with the project/initiative relative to date.

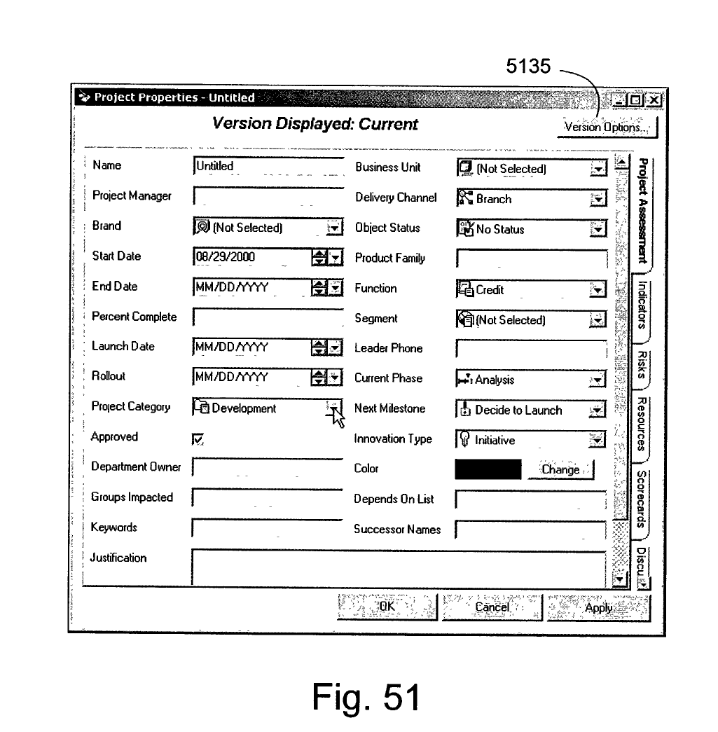

Editing Project/Initiative Properties. The user double-clicks on a project/initiative to edit its properties. The user will see a Project Assessment Form (PAF) displayed on the screen as seen in FIG. 51. The PAF allows the user to explicitly define every aspect of the user project/initiative. This form includes a powerful scorecard template and a tab devoted to threaded discussions and message postings regarding the project/initiative.

Saving Versions of Projects/Initiatives. A button captioned Version Options . . . at 5135 in the top-right corner of the PAF allows the user to archive different versions of a project/initiative. As a project/initiative grows and develops, there may be points when the user wishes to save off its current status before the user make changes so that the user could later go back and refer to it. To this end, Strategy View allows the user to save versions of the user projects/initiatives as often as the user like so that the user can later view previous versions or revert to a prior version. Pressing the version options button 5035 displays a list (not shown) of all of the previously saved versions. If the user wish to view a prior version, simply the version the user wish to view from the list. If the user wish to discard the current version, and revert back to a previous version, simply select the version the user wish to revert to from the list, and then click a button named Revert (not shown) on the list. To save a version of a scenario, click on either the Save or Save As links in the menu bar. After saving a new scenario, it will appear in the user's “My Scenarios” directory.

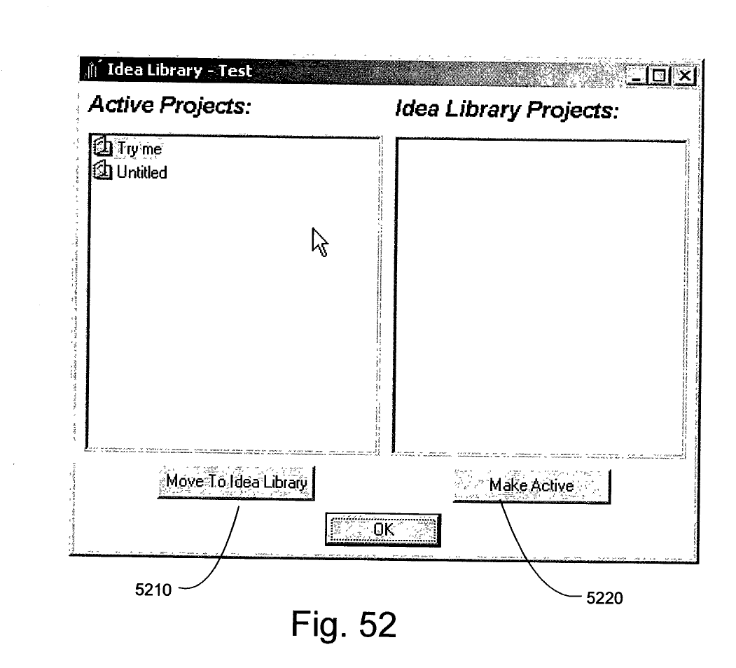

Scenario Idea Library. The system maintains an idea library for each scenario. The user can access this library by double clicking on the idea library icon seen at 5050 in the lower right corner of the strategy view seen in FIG. 50. It will bring up the window shown in FIG. 52. The idea library gives the user the ability to create and define projects/initiatives that are not ready to become active yet. The system may be used to provide a fully automated scenario based program management solution linked dynamically to actuals. These are just ideas or references to other projects/initiative. To change the status of a project/initiative, the user may:

1) Select an idea in either the “Active Projects” or the “Idea library Projects” column and click Move to Ideal Library at 5210 or Make Active at 5220 respectively.

2) Select an object in either column and drag it to the other column.

The user can easily move the user's active project/initiative from the strategy view to the idea library by holding down the shift key and dragging the project/initiative to the idea library icon. Note that the idea library in strategy view lists ideas related to a particular scenario and is separate then the global idea library 125 maintained within data model 103 as seen in FIG. 1.

Changing Scenario Properties. When the user right clicks in the strategy view, a pop-up menu (not shown) will appear, permitting the user to zoom in and out on the scenario. The user can also refresh any scorecards or scoreboards. The last option on the popup menu is Scenario Properties . . . When the user selects this option, the user will be able to change the general settings, filter projects, link to the strategy centre, and set user preferences. The scenario's start and end dates used in the timeline may be changed, and comments for the scenario may be added. The user may see a count indicating how many active projects/initiatives are in the scenario as well as how many projects are in the Idea library. A displayed “Date Last Simulated” refers to the last time the scenario was opened. The user may change the color settings and how the projects/initiatives are organized in Strategy View.

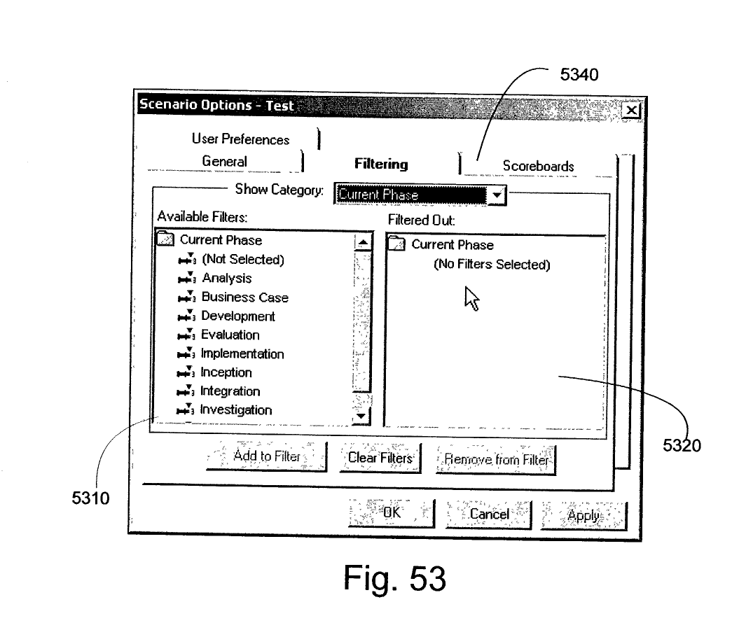

Filtering. The user can customize the projects/initiatives available in a given scenario using the filtering option shown in FIG. 53. Filtering allows the user to set criteria for displaying certain projects/initiatives based on start/end dates, brands, etc. On the left side of the window, all the possible values of each field on which the user can set a filter are presented in a listing 5310. On the right side is the list 5320 of all the filters that the user has already set. The user can add or remove the filters by dragging them from one column to the other, double clicking on them, or by using the buttons at the bottom of the form. After the user saves the changes in the filtering window, any filtered projects/initiatives will disappear while newly unfiltered projects will be made available.

Filtering projects is extremely useful in performing analysis on sub-groups within a scenario. The user can save the set of filters on the user scenario to keep the user filtered settings intact whenever the user come back to the scenario.

Viewing Scoreboards. The scoreboards tab seen at 5340 in “Scenario Options” allows the user to link the scenario to the strategy centre (described below) via a network connection.

Global Idea library

The global idea library houses seen at 125 in FIG. 1 stores all ideas submitted by users of the system. These ideas come in the form of projects and stay in the idea library until they are activated. Within the Idea library, the user can View the properties of a project/initiative idea and activate the project/initiative.

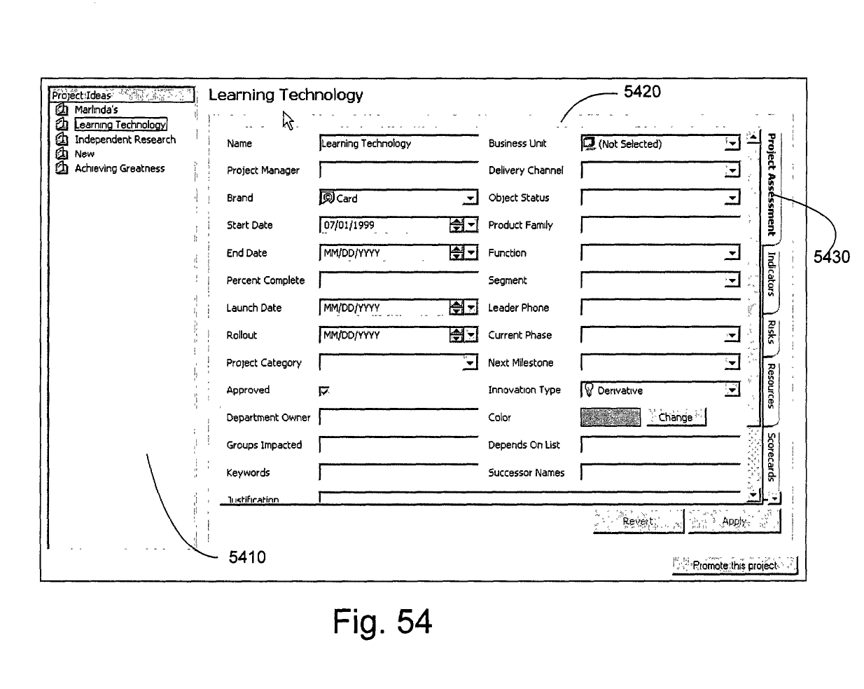

The project/initiative ideas will be listed when the user click on the idea library link from the navigation bar. The user can then click on any of a displayed idea list as seen at 5410 in FIG. 54 to view its properties in the project assessment form 5420 displayed to the right of the list. The user can make changes to the project/initiative idea and save them, or revert to the settings from the last save. The user can also access any indicators, risks, resources, scorecards, and discussions that may be associated with the project idea using the tabs at 5430.

The user can assign resources to a project/initiative and activate it through the idea library by clicking the “Promote this project” button at 5450 below the project/indicative's properties. In order to activate a project/initiative from the idea library, it has to be assigned a manager and a team. By default, there is no one assigned to the project/initiative. The user can select resources for the project/initiative using a project resources form which is presented when the button 5450. Everyone assigned to the project/initiative will be able to access the project/initiative through his or her “My Projects” link on the navigation bar.

My Ideas

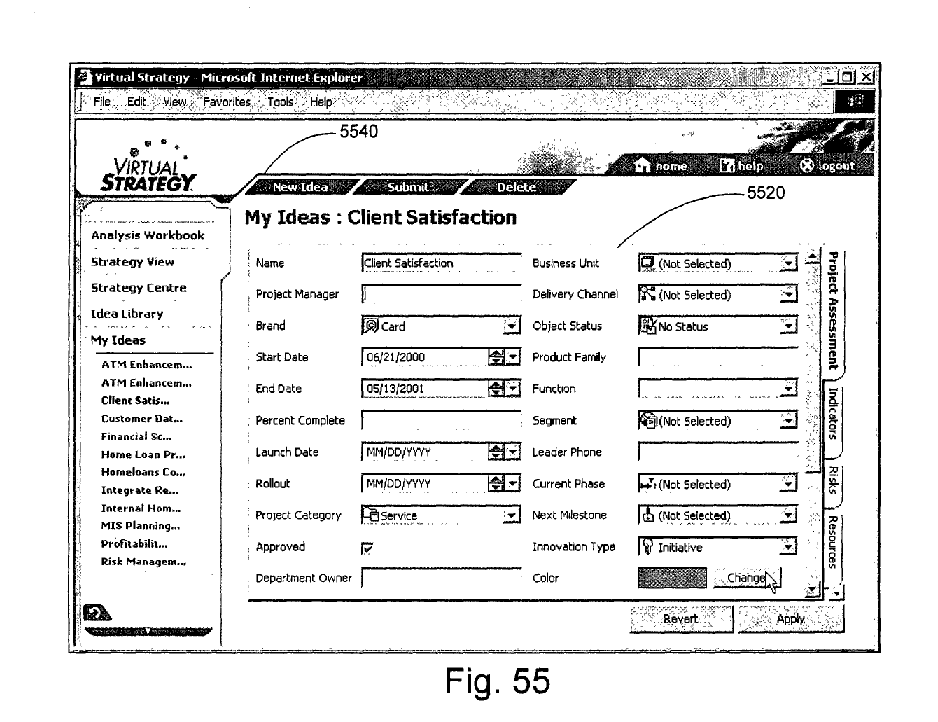

The user may select My Ideas using the navigation bar as shown at 5503 in FIG. 55. The displayed view contains a list of project/initiative ideas that the user has created. When the user first selects My Ideas, the user will only see a list of the ideas. At this point the user can create a new idea by clicking New Idea at 5510 or may select an existing idea to view from the list on the navigation bar. The user will see the properties of the project idea displayed in a Project Assessment Form (PAF) at 5520. By selecting the submit button at 5540, the user may pass the selected the project/initiative idea to the idea library. All submitted ideas reside in there until they are activated. By clicking the delete button at 5550, the user may permanently remove the idea. Once an idea is submitted, the user will not be able to submit (again) or delete the idea since it now resides in the Idea library. The user can, however, still change the properties of the idea at any time before it is activated. These changes will also show in the Idea library.

My Projects

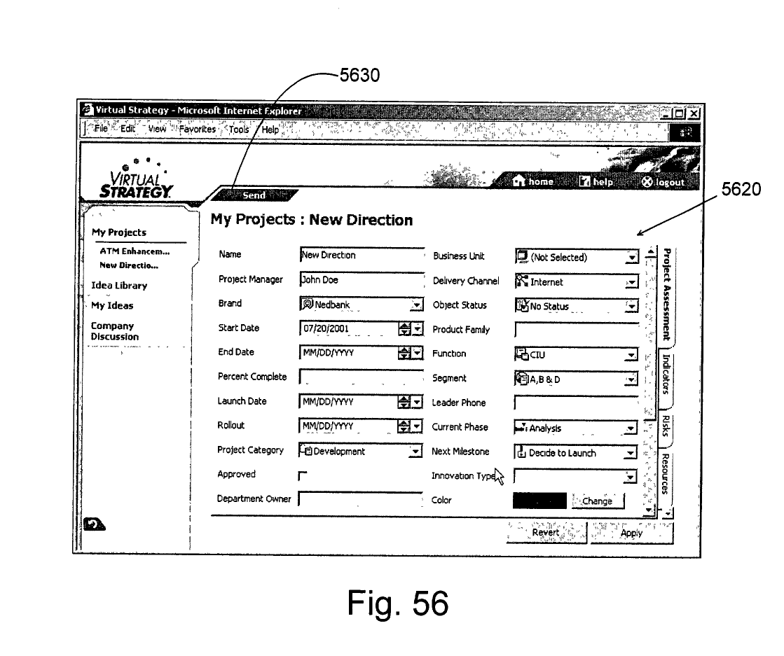

Active projects/initiatives have resources (identified users) assigned to them, whether they are the project manager or a member of the project team. These projects/initiatives can be accessed by each of these users through the navigation bar by clicking on the My Projects link from the navigation bar on the left as seen in FIG. 56. The user selects an available project listed on the navigation bar under “My Projects” to view its properties, which are displayed in a Project Assessment Form (PAF) as seen at 5620. A project/initiative manager will have the option to email their projects to other people. Members of the project/initiative team do not have that option. To email a project/initiative, the project manager clicks Send at 5630.

Project Configuration Wizard

The Project Assessment Form (PAF) described above is used to view projects/initiatives. The user can customize how the user looks at these projects with the Project Configuration Wizard which allows the user to do the following:

1) Customize attribute labels

2) Assign risk categories

3) Define risks

4) Define indicators

5) Create resource types

6) Assign attribute options

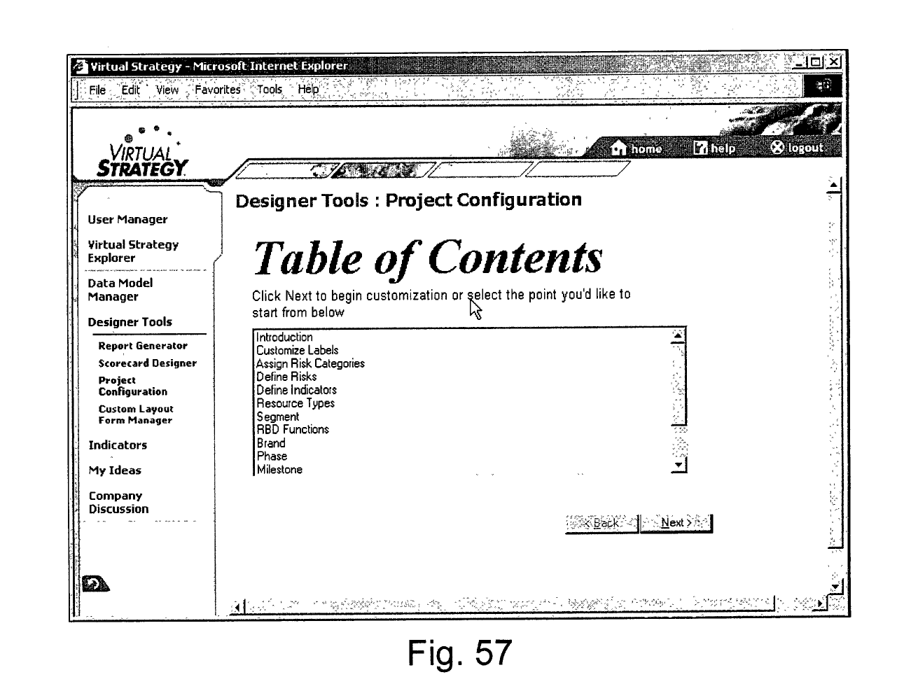

The user can open the project configuration wizard from the “Project Configuration” link under “Designer Tools” on the navigation bar. This wizard can be used to adapt the PAF to virtually any management consulting methodology, marketing campaign management model, or other project/initiative model. Unlike most wizards, the user does not have to step through each step of the wizard. Instead, when the user enters the project configuration wizard, the user will see the Table of Contents as seen in FIG. 57 listing all the changes that the user can make to the PAF. The first time the user goes through the wizard, it is recommended that the user go through all the steps. However, if the user wishes to make changes at a specific step, then double clicking on the item in the list jumps to that location in the wizard.

Customizing Attribute Labels. The labels that appear in the PAF can be customized to better suit the language of the user organization. For example, the user organization may use the term “Risk Value” as opposed to “Risk Index.” The user can modify the labels that appear on the first tab of the PAF by entering a name for the attribute next to the original name of the label on label customization list (not shown). If a field is blank, then it will use the original name.

Assigning Risk Categories. The user can setup the risk categories that are most relevant to the user organization. These are the categories used to group the separate risks that may affect the user organization. A risk category list display (not shown) shows the existing categories and, to add the user's own category, the user may click an Add . . . Button and the user will be prompted to add a name for the new risk category. If the user removes a risk category, the risks that fall under that category will be deleted as well.

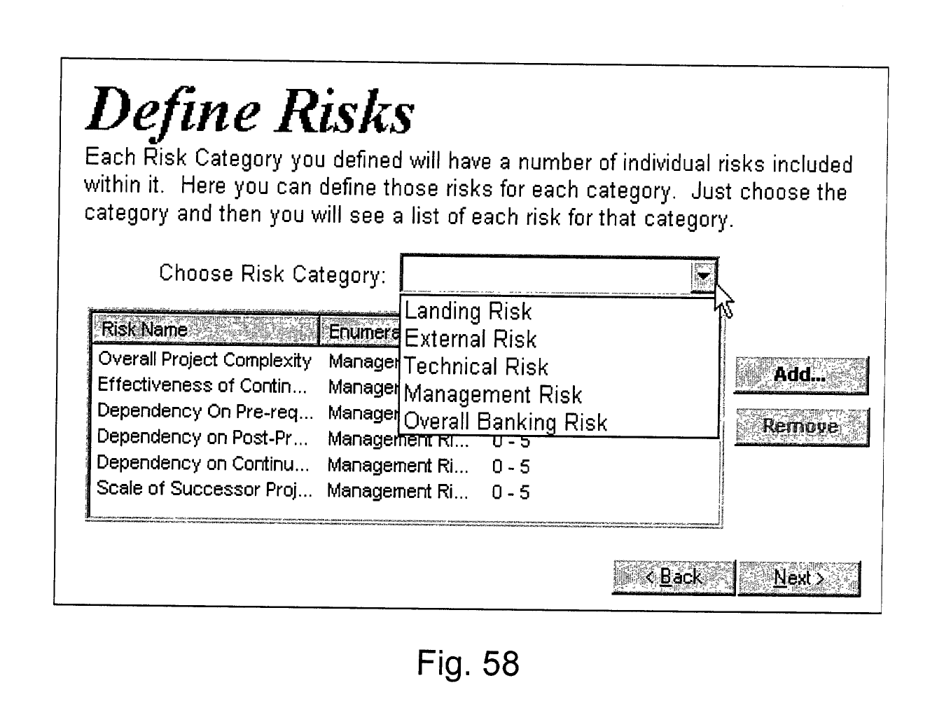

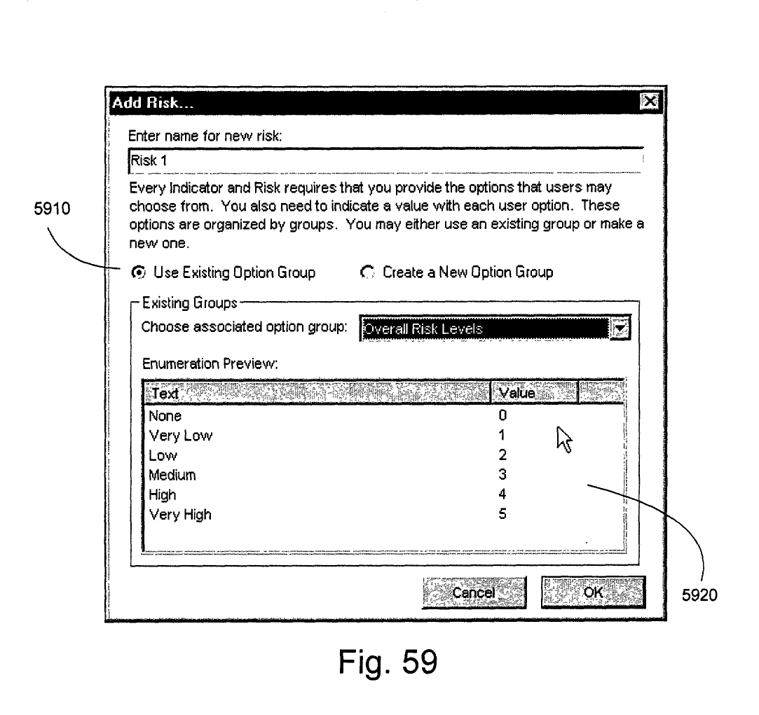

Defining Risks. Once the user has set up the risk categories, the user can define the risks under each category using the define risks view seen in FIG. 58. The user first selects one of the categories from the “Choose Risk Category” drop-down list at 5810. The user will then see a list of the different risks in that category along with the enumeration name and the value range for the risk. Using the view of FIG. 58, the user can remove risks and add new ones, clicking on Add . . . at 5820 to create a risk and providing a name for the new and an enumeration for the new risk using the dialog box 59. If the user selects “Use Existing Option Group” at 5910, the user will get to choose from the existing enumerations listed at 5920 and the values that will be associated with the risk. If the user choose to create his or her own enumeration, the user can create values for the risk. This enumeration will be saved and can be used for other risks.

Defining Indicators. Defining indicators is very similar to defining Risks. The only difference is that the user does not have to define indicator categories. The user assign indicators as the user defined individual risks, including enumerations.

Defining Resource Types. Each organization has its own set of resources for projects. Defining resource types is done the same way as defining risk categories.

Assigning Attribute Options. Projects will have certain attributes that are specific to the user organization. The Project Configuration wizard lets the user predefine what options are available for these attributes. For example, the user organization may have different Customer Segments or Brands. The user could also have certain ways of defining Project Status, etc. An attribute option list may be edit to define new options.

Project Assessment Form

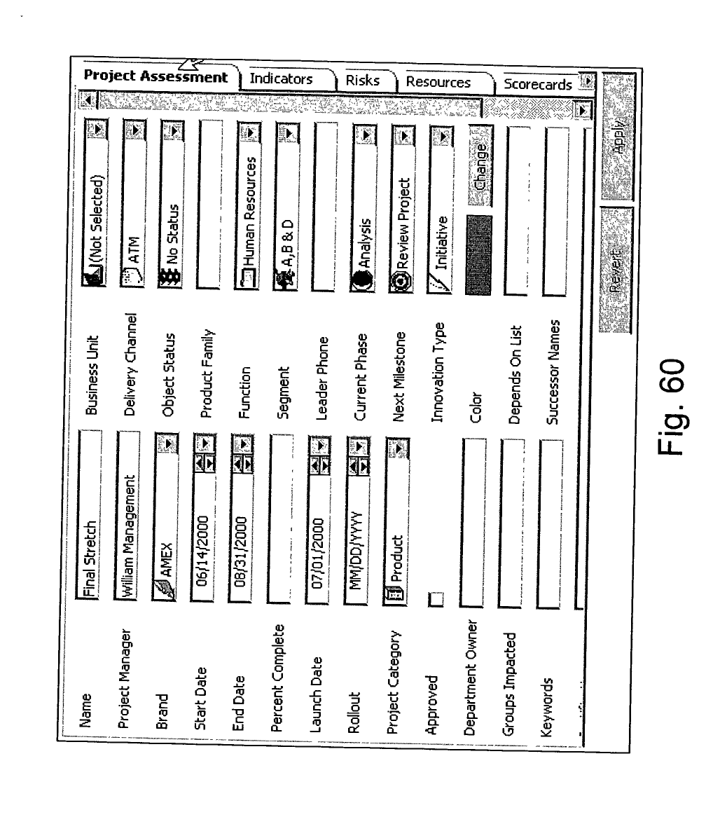

The Project Assessment Form (PAF) is extremely useful when the user need to analyze or edit a project/initiative. Different places where the user can see a PAF within the system include the strategy view, the Idea Library, “My Ideas” and “My Projects. The PAF seen in FIG. 60 includes the following tabs, each pertaining to different attributes for the specified project:

1) Project Assessment

2) Indicators

3) Risks

4) Resources

5) Scorecards

6) Discussions

Project Assessment. The first tab on the PAF is entitled “Project Assessment” and includes an interface seen in FIG. 60 to customize the attributes that directly define the project and how it fits into the data model. This interface is customizable by the system administrator and so the labels for some or all of the fields may be different.

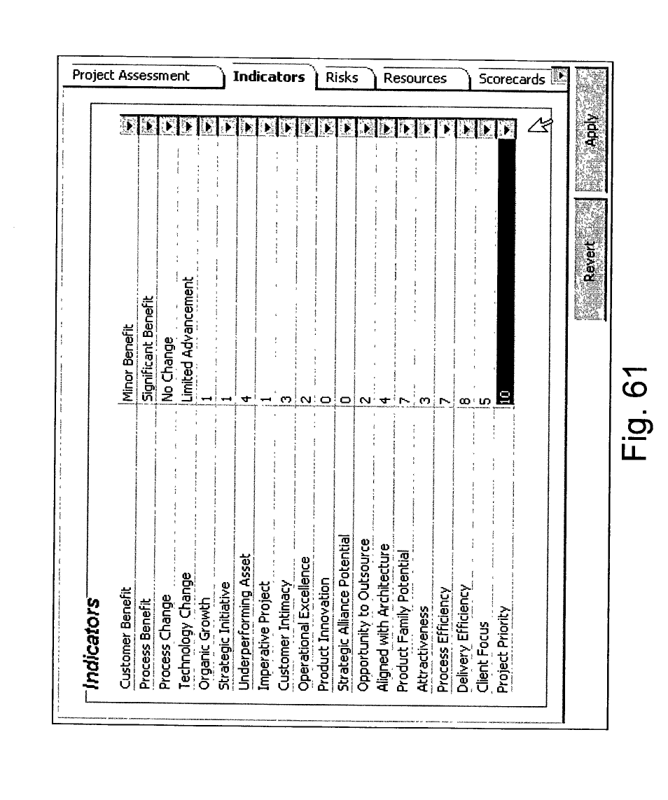

Indicators. Each project/initiative has certain key indicators associated with it. These values are important in understanding the influence a project has on the user organization. It also helps define the project. These indicators are defined by the user organization and set by the system administrator. The user uses the indicators tab of the PAF as shown in FIG. 61 to select a value for each of the indicators from their drop down list. These values can be seen plotted against each other in the Strategic Matrices and the Indicators & Risks scoreboards.

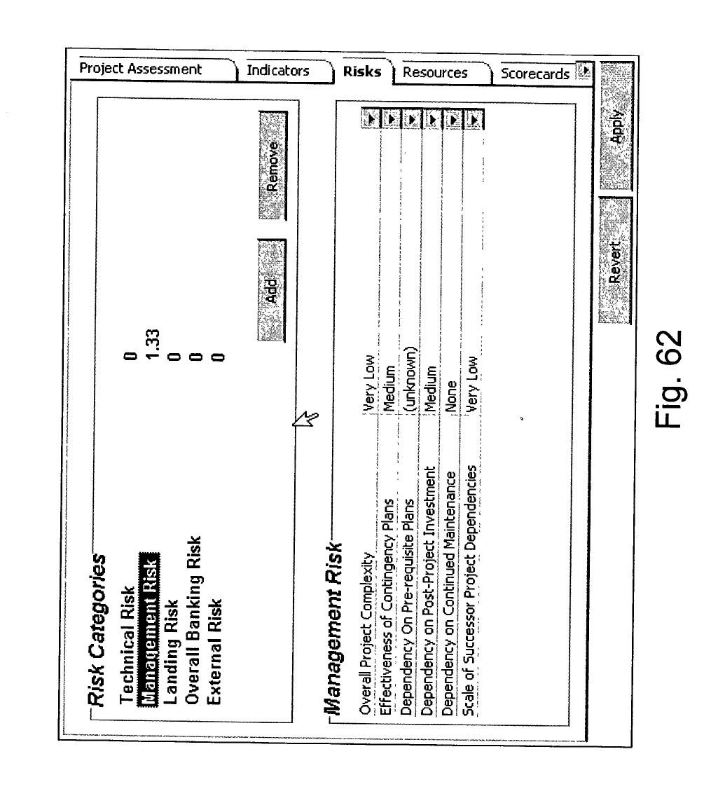

Risks. Each project/initiative has certain risks associated with it. The user can add risk categories that have been configured by the system administrator. To edit the risk values, select a category at the top of the PAD risk tab seen in FIG. 62. The user will see the risk subcategories listed below. The user can assign values to each risk by selecting a value from the drop down list. These values can be plotted in the Indicators & Risks scoreboard.

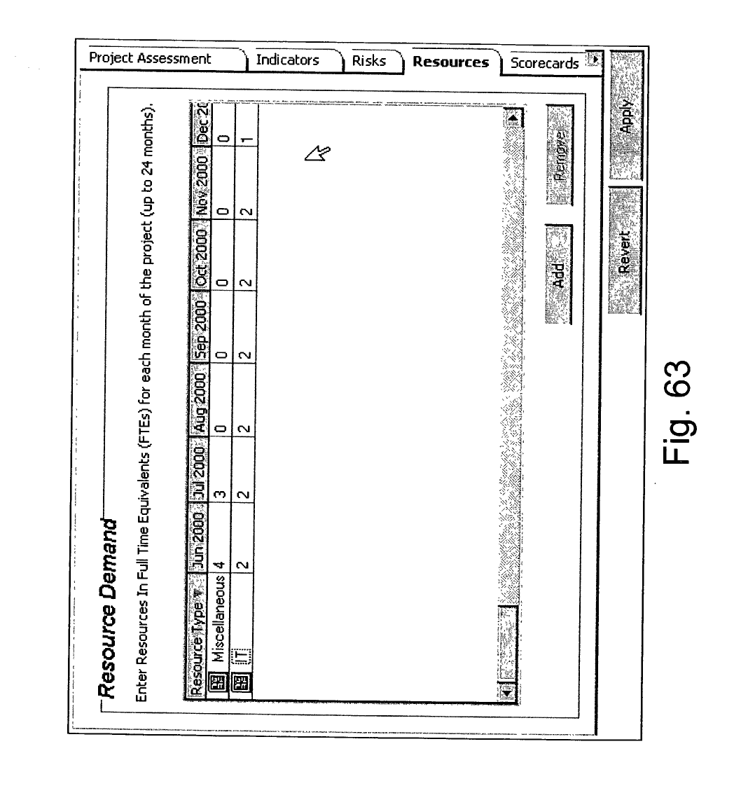

Resources. “Resources” pertain to resources used for the project/initiative being viewed. They are entered as full time equivalents for up to 24 months. The system administrator defines resource types. The user can add resources by clicking on Add on the PAF resources tab as shown in FIG. 63 and selecting a resource type from the drop down list that appears. Once values have been entered for the months applicable to the project/initiative, they can be seen in the Resource scoreboard.

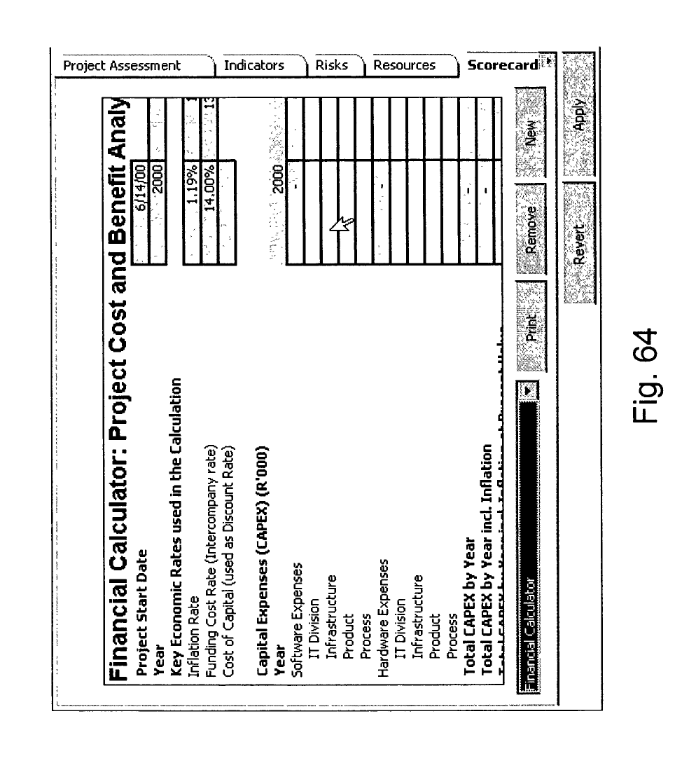

Scorecard. The PAF scorecard tab shown in FIG. 64 applies to different customizable spreadsheets associated with the project/initiative. It uses the Scorecard by default, but the user is not limited to the Scorecard spreadsheet. The user can add new spreadsheets from templates created by the system administrator.

Discussions. The PAF discussions tab (not shown) allows the user to maintain threaded discussions internal to the project/initiative.

Scorecard Designer

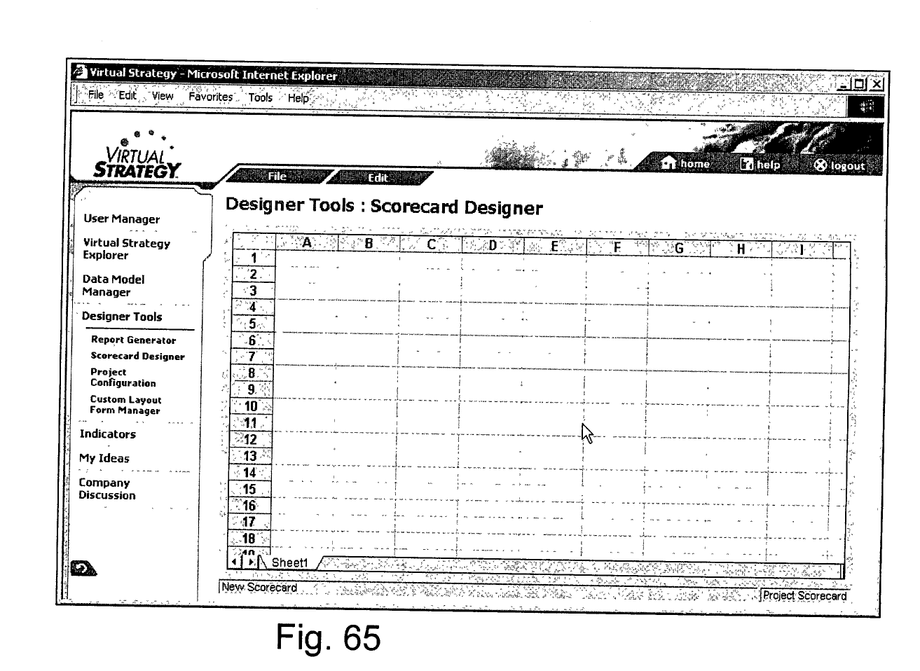

Spreadsheets are a powerful tool that allows the user to view data from the data model in a neat, customizable format. These spreadsheets, called “scorecards,” are Microsoft Excel compatible and can be configured using the scorecard designer shown in FIG. 65. The functionality available in the scorecard designer includes:

1) Creating new Scorecard template

2) Linking to data

3) Configuring scorecard template layout

4) Saving templates to the database

5) Exporting files

New Templates. Scorecards can be created for use in the Project Assessment Form or in the analysis workbook. Project scorecards are closely tied with the information associated with projects; scorecards used in the analysis workbook (report Scorecards) are designed to allow global user-changeable properties to customize these reports. In order to create a new, blank, scorecard, click File from the menu bar at and select “New Scorecard for Projects” from the menu that appears.

The usage of the Scorecard will be displayed in the lower right corner of the scorecard designer. After selecting a usage for the scorecard, the usage cannot be changed. The user may reuse to scorecard formatting by exporting the file to the user's hard drive and importing it for the desired usage. It is recommended that the user re-link the user's cells after doing this. Scorecards can be imported from saved spreadsheet files on the user's computer, such as a Microsoft Excel file. Select “Open file for Projects” from the file menu. Then select the file to open from the open file dialog that appears. The user will then see the user's Scorecard ready for further editing or for saving to the system. To open a scorecard template saved in the system for editing, select “Open Existing Template . . . ” from the file menu, then select the scorecard template to edit from the open template dialog that appears. The user's scorecard template will then appear ready to be edited.

Linking to Data. One of the most useful features of scorecards is the ability to link to data saved in the system. To begin the process of linking cells of the scorecard to stored data, the user selects a cell or a range of cells in the scorecard grid to be linked by right-clicking on the selection and then selecting “Link Cell . . . ” from the menu that appears, or selecting “Link Range . . . ” if the user is linking a range of cells. When linking a range of cells, the user can only select a range of columns or a range of rows, not multiple rows and columns.

The user then selects the type of link to be created from three displayed options: “None” which clears all links in that range; “Internal to Project” which allows the user to link to data of the project that the scorecard is associated with; and “External” links which get data from anywhere in the database, such as microCube™ data or indicators.

Internal Links are used to get data of the project the scorecard will be associated with. The four internal link options correspond to the first four tabs of the Project Assessment Form: Project Assessment, Resource, Indicator, and Risk.

When linking to general internal data, the user simply selects that project data the user wish to get, such as the project's name, manager, or start date.

When linking to resources, the user must first select the type of resource to link to and then select the data of that resource to return. For example, the user may wish this link to get data for the first month.

To link to indicators, select a project's/initiative's indicator from the list of indicators displayed when the link option “Indicators” is selected.

Linking to project risk values requires the user to first select a risk category and then choose the particular risk from that category in the displayed list of risks.

External Links. There are three options to choose from when linking to external data: Absolute Reference; Indicator and Data Series.

Linking to an absolute reference is used to link to any object in the system, such as a name of a loaded object. The user selects the object to link to from the hierarchy representation of the database that appears. Once the user select an object to link to, select the attribute of that object to get data from.

External indicators are used to store information that changes over time, such as interest rates or stock prices. To link to external indicators, select an indicator category from a first displayed list and a second displayed list will give the user a preview of the indicators associated with that category. Once an indicator category is select, choose the attribute of the indicator to get data from, such as rate, value, or price. Next, the user needs to select the period type of the data that the user are viewing and the method for selecting the time period of the data to get. The period type is typically monthly, quarterly or yearly. The actual time period selected can be relative to the project's start data or a fixed time period. Selecting a relative time period will select data some time period after the project's start date. For example, if the indicator period type is monthly and the user wanted the indicator for two months after the project's start date, the user enters “2” for a period offset. Choosing a fixed time period will require the user to enter the time period of the data to return.

The user can also link to data based on a data series. If the data the user wants is not found in one of the data series listed, the user may click on a displayed “Add New . . . ” button and use the data series generator to create a new data series. Once the user has selected a data series, the user will need to go through the steps of the Report Wizard to configure the data series for the user specific needs. After the selected data series is configured, the user will need to choose the specific data from the data series to be used. For example, if the selected data series returns customer counts labeled by customer segments, then the user will need to choose the segment name to place counts for in each cell.

The user may also return lists of data in a scorecard by first selecting the class of data that the list will return and then indicating how the data will be limited. The administrator can permit the user to choose objects from the hierarchy to limit the list by checking the check box “User can limit list with hierarchy selection.” More criteria can be added by clicking an “Add Criteria” button and these criteria can later by removed by clicking the “Remove” button. Next, the user chooses the method by which the data will be ordered by select the column to order the data by, and then indicating if the data will be ascending or descending. Next, the user selects the data of the list to display. The maximum number of data elements the user can display is the size of the data range the user is linking (one if the user is only linking a single cell). The order the data will be displayed can also be selected. Finally, the user enters a limit to the data returned. The number entered as a limit will be the maximum number of elements the list can contain. The smaller this number, the faster the scorecard will display data, but some items may be left off of the list.

Changing Format. The format of the spreadsheets cells can be changed by choosing Launch Designer from the file menu which enables the user to perform tasks such as adding cell borders, cell backgrounds, formulas and cell protection. In the designer, the formulas used for linking will be in linked cells. These formulas are supplied by the system and it is recommended that the user use caution when editing these formulas.

Saving. To save the user's scorecard template to the database for use with projects, the user may select Create/Update Template from the file menu and enter a name for the user's template in the space provided. The user's Scorecard template will be saved to the database. If there is already a template with that name, the previous template will be overwritten, and all existing Scorecards that used that template will now use the new template. If the layout of the data to be entered by users changes, the user's new template may not work.

If the scorecard template has multiple sheets in it, a checkbox labeled “Use current sheet only” will be unchecked by default. If the user would like to remove the extra sheets, the user can check the Use current sheet only option.

Exporting. In order to maintain backups of the user's scorecards, the user may wish to save the scorecard templates to the user's computer. To do this, the user selects “Save . . . ” from the file menu and selects a name and location for the user's template.

Strategy Centre

The Strategy Centre is a tool that allows the user to view several different scoreboards simultaneously. Strategy Centre is customizable for viewing the four different types of scoreboards provided by Virtual Strategy:

1) Indicators & Risks

2) Resource Demand

3) Scorecards

4) Strategic Matrices

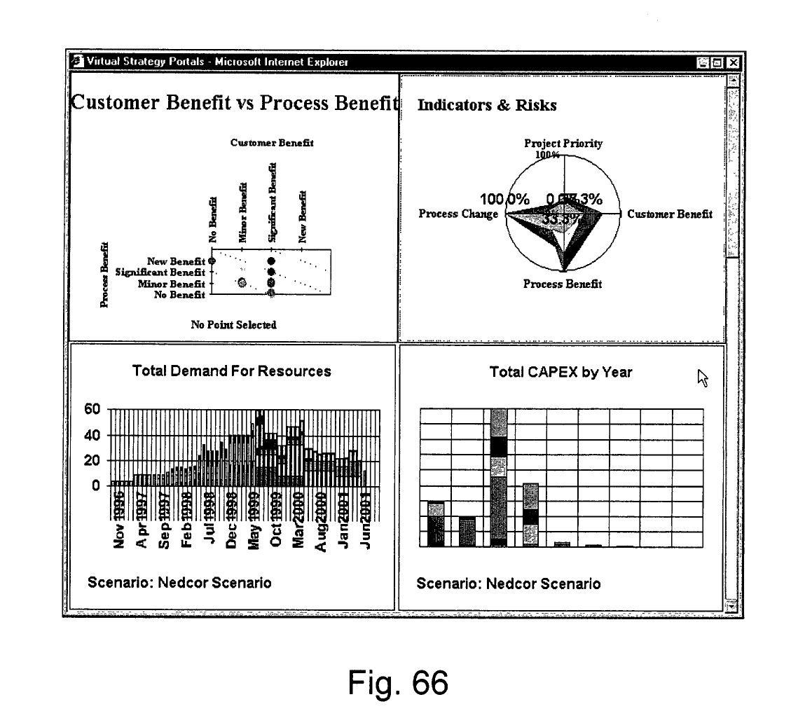

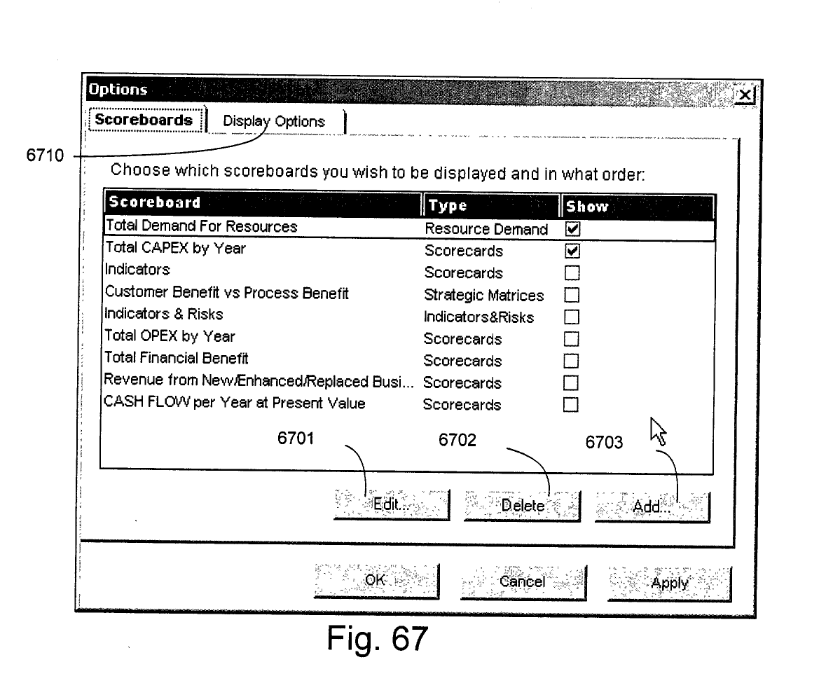

Strategy Centre Options. In order for Strategy Centre to work properly, it has to be linked to a scenario from the Strategy View. The user first clicks on the link in the navigation bar to open the Strategy Centre and then, from Strategy View, the user configures a link to the opened Strategy Centre. Strategy Centre is opened in its own window. While it is waiting to receive a message from Strategy View, it displays “Strategy Centre Ready.” Once it has been linked to a scenario, the user can display the different scoreboards. The user can customize what scoreboards are displayed and how they will be displayed in Strategy Centre through the options window. An example Strategy Centre display is shown in FIG. 66 and the Strategy Centre options window is shown in FIG. 67. The options window presents a list of the different scoreboards that can be displayed in Strategy Centre. The user places a check in the box under “Show” to show the scoreboard in Strategy Centre. The user can edit the individual scoreboards by selecting one from the list and clicking Edit at 6701 and the user can remove a scoreboard by clicking “Delete” at 6702 to take it off of the list. To add a new scoreboard, the user clicks Add . . . at 6703 and chooses the type of scoreboard to add. The scoreboard will be placed at the end of the list. The user can change the order the scoreboards appear in Strategy Centre by moving them around in the list. The change will take place once the user click Apply or OK.

Under the “Display Options” tab at 671 0he user can customize how many scoreboards the user wants displayed on the screen, and whether they are to be displayed one, two or four to a page. The user may further select whether not a scoreboard viewed is the last updated version of the project or the last saved version of the scenario. Select the option from the drop-down list under the description. These can be displayed as either “Checkered” or “Rows.”

To toggle between hiding and showing the legends in a graph displayed in Strategy Centre, the user may right click on the graph.

Indicators & Risks Scoreboard

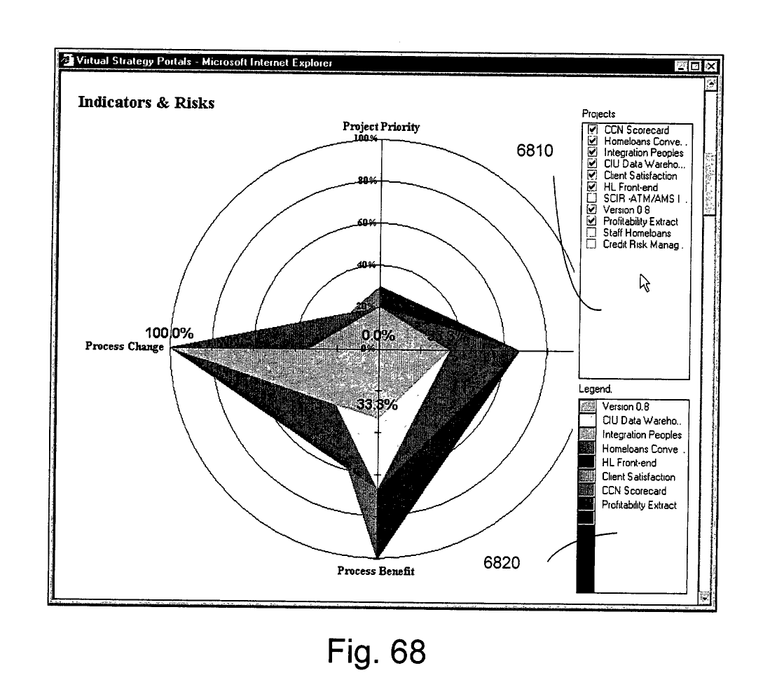

The Indicators & Risks scoreboard illustrated in FIG. 68 allows the user to analyze projects by its indicator or risk values. It provides a generic, customizable platform for looking at these values on a radar or bar graph. The user can either place the individual indicators and risks on the axes of the plot or the projects themselves. The user can also plot customizable weighted averages, and compare them to individual categories. To the top-right of the plot at 6810 is a list of things that can be plotted on the graph. These can either be projects or indicators, depending on the current view settings. Under that list at 6820 is the legend for the graph.

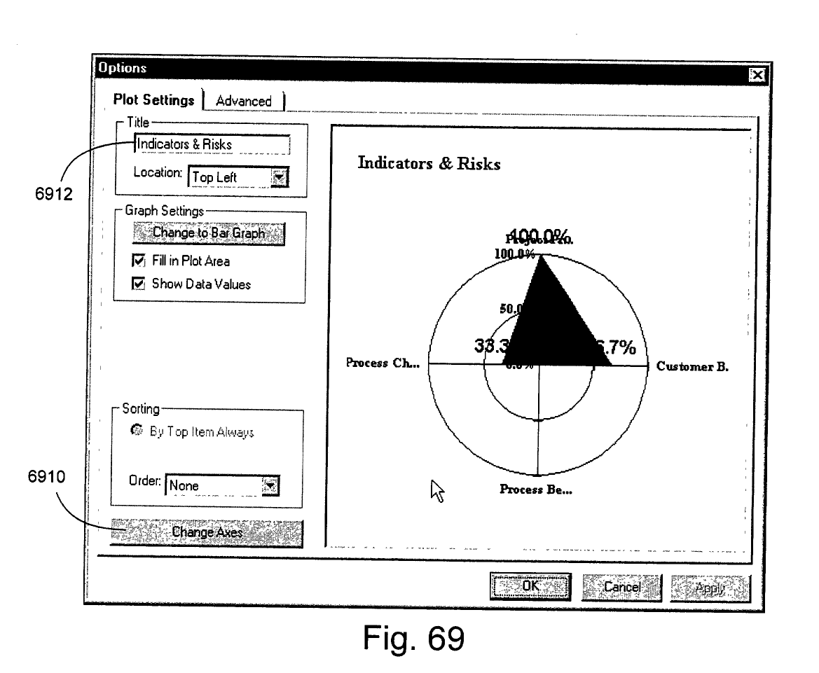

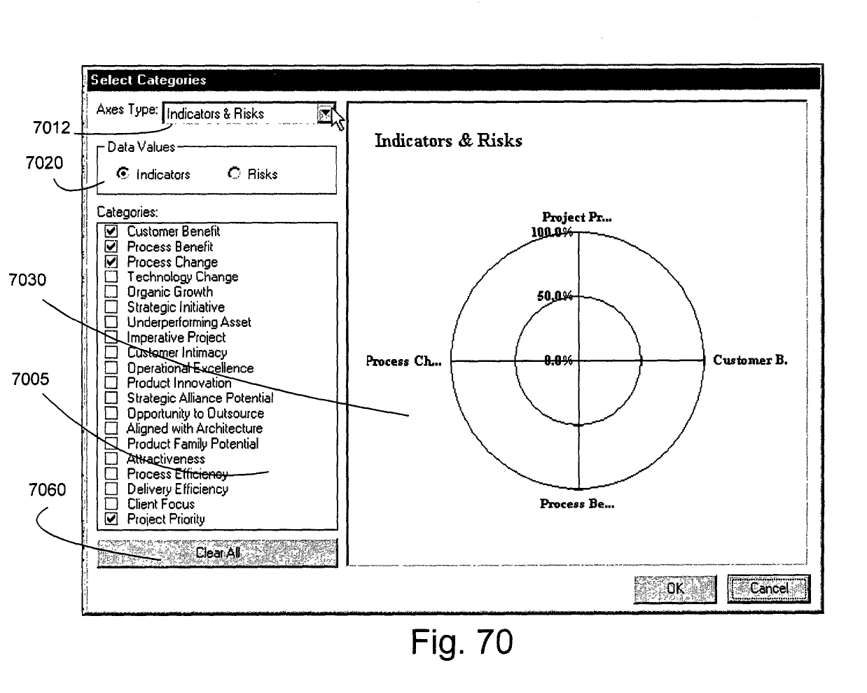

Customizing the Indicators & Risks Scoreboard. The user can customize how the data is plotted on the indicators & risks scorecard graph of FIG. 68 by using the options screens seen in FIGS. 69-71. Click on any of the options and the sample graph to the right will display how the changes will affect the plot. The user can plot either projects or indicators and risks on the axes by clicking on the Change Axes button 6910 located at the bottom left of the window of FIG. 69 to assign what is plotted on the axes. When the drop-down list at 7012 is set to “Indicators & Risks,” the list 7005 on the left in FIG. 70 contains the indicators that are stored in the data model. Switch between indicators and risks using the “Data Value” buttons at the top left of the window at 7020. The user can put both indicators and risks on the axes at the same time. If the user elects to place “Projects” on the axes from the drop-down list, the user will be able to select the projects/initiatives from the scenario to place on the axes. Add or remove axes from the plot by clicking on their names in the list 7005 to the left; the changes will be reflected in the plot to the right seem at 7030. To clear all of the user's selections and start again, click on the Clear All button at 7060.

Viewing Data on the Scoreboard. When viewing the plot, the user can change the order of the layers by selecting an item in the legend 6820 seen in FIG. 68 and moving it to the position the user would like to see it plotted. A radar plot only shows data values for the top item in the legend. In a bar graph, the values are shown for all of the items plotted. This is not done in the radar chart to avoid confusion that would arise with many items being plotted on the graph. To see the values of the different items, use the legend to move the desired project to the top of the radar plot.

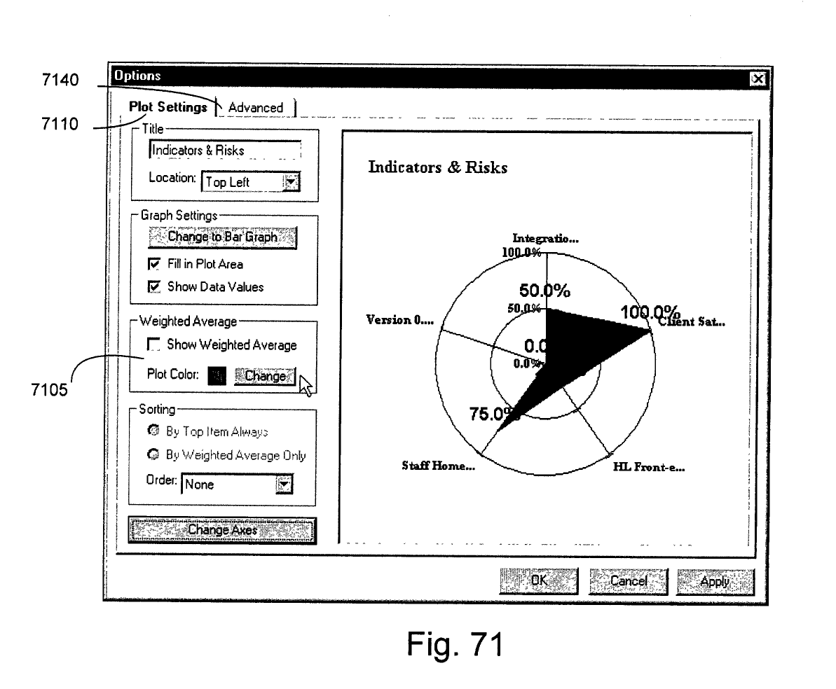

Weighted Averages. When the user places the projects on the axes, the indicators & risks scoreboard allows the user to plot a weighted average. Once the user has gone through the process of assigning projects to the axes, the user will see a new area 7105 on the “Plot Settings” tab 7110 titled “Weighted Average” as shown in FIG. 71. The user checks the box next to “Show Weighted Average” to have it plotted on the graph. Before assigning weighted averages to the different indicators and risks, nothing will be plotted for the weighted average since it uses zero as a default. In order to set them, click on the Advanced tab at 7140 in the Options window. Click on the Changed Averages button (not shown) to customize the weighted averages. The user will see a table listing each of the indicators and risks on the left and showing a value for the weight. If nothing has been set, the user will see all zeros. The user can assign percentages to each one of the indicators and risks. When projects are plotted on the axes, two radio buttons appear on the plot that allow the user to switch between the indicators and risks. The user can plot these on the graph at the same time.

Resource Demand Scoreboard

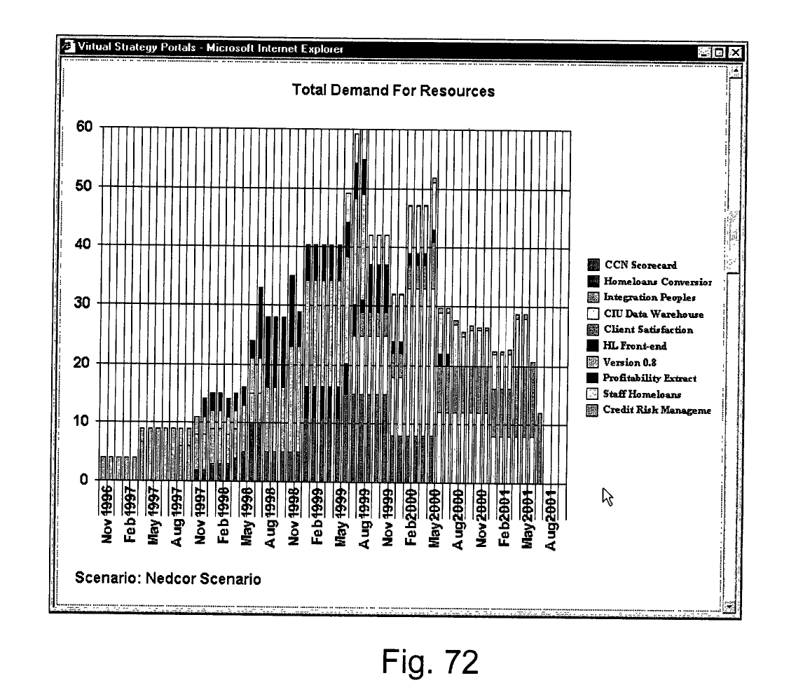

The Resource Demand scoreboard seen in FIG. 72 displays the resource allocation for the projects/initiatives in a scenario. Resource allocation is set using the Project Assessment Form (PAF) for each project/initiative in the scenario. By default, the Resource Demand scoreboard uses a bar graph to display the resources. However, the display is fully customizable and can be changed using the chart options. Within the chart settings the user can customize many different attributes of the chart: chart type, background fill, gridlines, border style and color, and shadow style. The user can select five different chart types: Area, Bar, Horizontal Bar, Line, and Pie. The first three will be plotted using stacking, while the last two will not. The user can also edit the different text objects on the chart, including: title, footnote, legend, and axis labels. A preview screen (not shown) shows the user the current settings of the chart.

Scorecards Scoreboard

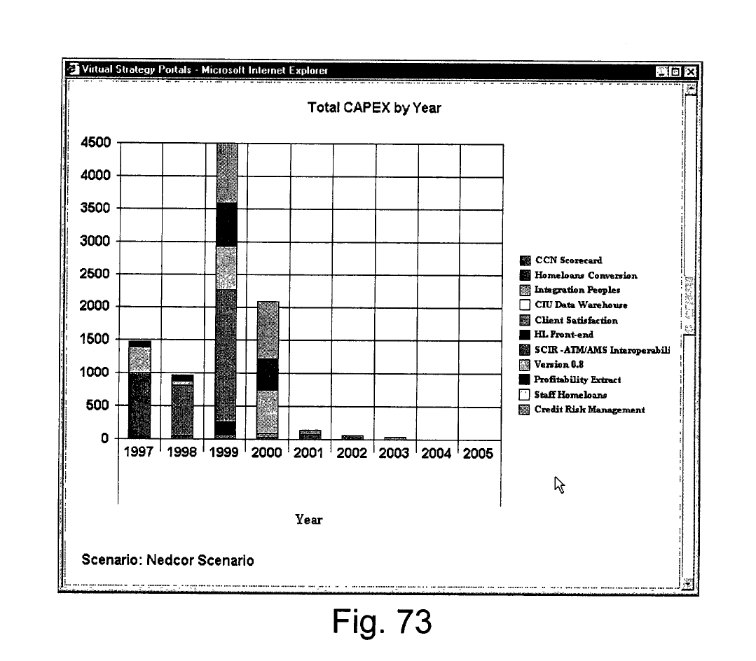

The scorecards scoreboard displays illustrated in FIG. 73 displays any data from any of the scorecards associated with the projects in the user's current scenario. The user can use the scorecards scoreboard to plot specific rows of data from any of the user's customized spreadsheets whether they are based on a time series or not. By default, the scoreboard will display the scorecard data associated with the current scenario in a bar graph. Like the resource demand scoreboard, the user can open an Options window (not shown) and customize how the graph looks.

Strategic Matrices Scoreboard

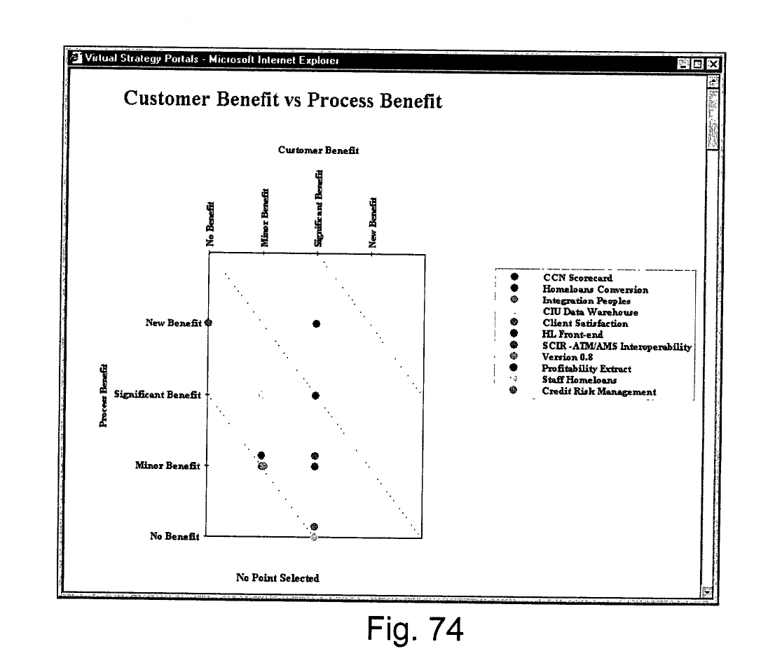

The strategic matrices illustrated in FIG. 74 allows the user to compare different indicators and risks for each project/initiative in a scenario. The user can select an indicator or risk on the horizontal axis and another on the vertical axis. The values for each project/initiative will be plotted on the graph. The user can see what project a dot on the map corresponds to if the user place the mouse over it. The name will appear below the graph. Using an options window (not shown) the user can customize the strategic matrices scoreboard by selecting what is plotted on each of the axes.

User Manager

The system's user manager seen at 175 in FIG. 1 is an administrative tool that allows the system administrator to administer users. The user manager 175 further allows an administrator to designate what applications a user in a group will have access to as well as providing a way for creating custom links that can be accessed. The administrator is given the same tools for managing users and groups—adding, removing, and editing properties.

To add a new user, the administrator is presented with a form that allows the administrator to enter the properties of the new user, including a user name and password, and a group assignment. The “User Name” and “Password” allow the user to log into the portal. User names must be unique, which is enforced in the User Manager. Whenever a password is set from the user manager, the user will be asked to change the password when they next log into the portal.

If given users can only access information for a certain area in the business unit structure, the user can assign their “Security Access” using the drop down list, if in fact, the hierarchy is loaded into the data model. A user will not be able to view any information above the unit they have been designated to see. The analysis workbook takes full advantage of this security feature, for viewing reports. The components a user will be allowed to use will depend on the group(s) they belong to.

The administrator can add or remove the user to one or more of the groups listed by clicking on the right arrow or double clicking on the group. The system presents an “Assigned Groups” list (not shown) listing the groups to which a given user has been assigned.

The system is provided with five default groups, each containing pre-assigned components as shown in the outline below. Note: Each of the following groups is assigned Company Discussion and My Ideas as well.

a) Administrators

i) Data model Manager

(1) Automated Data Load Manager

(2) Data Link Creator

(3) Data loader

(4) Data unloader

ii) Designer Tools

(1) Custom Layout Form Manager

(2) Project Configuration

(3) Report Generator

(4) Scorecard Designer

iii) Indicator Manager

iv) User Manager

v) Virtual Strategy Explorer

b) Employee (no unique components)

c) Executive

i) Analysis workbook

ii) Idea library

iii) Strategy View

iv) Strategy Centre

d) Program Management

i) Idea library

ii) My Projects

e) Project Team

i) My Projects

All of the groups are provided for the purpose of having a working shell when the data model is first created. The last three groups can be removed or modified depending on the user's organization's needs. The Administrators and Employee groups are special cases, though, that deserve special attention.

Administrators. This group is different from all of the other groups since it is the default administrative group. It cannot be deleted or renamed. The User Manager and Virtual Strategy Explorer cannot be removed from this group, and cannot be added to any of the others. They are special applications designated solely for Administrators. Access can be granted or denied for other components.

Employee. The Employee group has been designated as the default group, and its level of access to components is customizable. It cannot be deleted, but can be renamed. If, for any reason, a user is found to be a stray, not assigned to a group, they are assigned to this group. This will happen when a group is deleted and a user in that group has no other group memberships.

The administrator can add new groups and assign a group name and text description to each. Then administrator can then customize what applications the members of this group will have access to. “Custom Links” can also be assigned to groups. These links can be data entry pages or web pages that the user would like accessed from within the portal. The administrator can create, edit, and assign these links from the same area. The links that appear in the list are global to all user groups. The administrator can view and edit the properties of a group in the same fashion as viewing the properties of a user.

Conclusion

It is to be understood that the preferred embodiment of the invention that has been described is merely one illustrative application of the principles of the invention. Numerous modifications may be made to the methods and instrumentalities employed in the described system without departing from the true spirit of the invention.

What is claimed is:

1. A data storage and analysis system comprising, in combination,
means for storing data organized into a hierarchical structure establishing parent-child relationships between data objects,
one or more data storage servers for storing a plurality of data sources including relational database tables,
means responsive to inputs from a user for establishing relationships between selected ones of said data objects in said hierarchical structure and corresponding data in one or more of said relational data tables,
a data loader responsive to user inputs for transferring data from specified ones of said sources of data to specified ones of said data objects,
means responsive to inputs for establishing one or more sets of links to selected objects in said hierarchical model,
means responsive to user inputs for establishing one or more stored scenarios which define outcome results dependent upon current data values identified by specified ones of said sets of links, and
means for deriving an alternate scenarios from a specified one of said stored scenarios by altering said specified ones of said links, and
a strategy view tool for accepting inputs from a user for concurrently reviewing outcome results produced by multiple scenarios.
